(19) United States
(12) Patent Application Publication
(10) Pub. No.: US 2020/0319430 A1
(43) Pub. Date: Oct. 8, 2020

(54) IMAGING LENS AND IMAGING APPARATUS

(71) Applicant: SONY CORPORATION, TOKYO (JP)

(72) Inventors: YOSHIO HOSONO, TOKYO (JP); YASUHIDE NIHEI, KANAGAWA (JP); DAIGO KATSURAGI, KANAGAWA (JP)

(21) Appl. No.: 16/956,852

(22) PCT Filed: Dec. 14, 2018
(86) PCT No.: PCT/JP2018/046052

§ 371 Date: Jun. 22, 2020

(30) Foreign Application Priority Data
Dec. 28, 2017 (JP) 2017-253638
Sep. 20, 2018 (JP) 2018-175584

(51) Int. Cl. G02B 13/00; G02B 9/62

(52) U.S. Cl. CPC G02B 13/0045; G02B 9/62

(57) ABSTRACT

An imaging lens according to the present disclosure includes, in order from an object side toward an image plane side: a first lens having positive refractive power near an optical axis; a second lens having positive refractive power near the optical axis; a third lens having negative refractive power near the optical axis; a fourth lens whose lens surface on the image plane side has a concave shape toward the image plane side near the optical axis; a fifth lens whose lens surface on the image plane side has a concave shape toward the image plane side near the optical axis; and a sixth lens having negative refractive power near the optical axis. The fourth lens has negative refractive power. The fifth lens has positive refractive power.

### TECHNICAL FIELD

The present disclosure relates to an imaging lens that forms an optical image of an object on an imaging device such as CCD (Charge Coupled Device) or CMOS (Complementary Metal Oxide Semiconductor), and to an imaging apparatus mounted with the imaging lens to perform photography for a digital still camera, a mobile phone with a camera, an information mobile terminal with a camera, and the like.

### BACKGROUND ART

Thinner digital still cameras such as card type cameras are fabricated year after year, and imaging apparatuses are requested to be miniaturized. In addition, with respect to mobile phones, to reduce the terminals themselves in thickness and secure space for more functions to be mounted, imaging apparatuses are also requested to be miniaturized. Demands are thus increasing for further miniaturized imaging lenses mounted on imaging apparatuses.

In addition, while an imaging device such as CCD or CMOS is miniaturized, the number of pixels is greatly increased by microfabricating the pixel pitch of the imaging device. This also requests high performance from imaging lenses used for each of these imaging apparatuses.

### CITATION LIST

### Patent Literature

PTL 1: Japanese Unexamined Patent Application Publication No. 2014-44372

PTL 2: International Publication No. WO 2015/060166

PTL 3: Specification of U.S. Pat. No. 9,395,519

### SUMMARY OF THE INVENTION

Further, a fast lens having a large aperture is requested that allows for high-sensitive photography while preventing noise caused by photography in a dark place from deteriorating image quality.

It is desirable to provide a high-performance imaging lens subjected to miniaturization and aperture enlargement, and an imaging apparatus mounted with such an imaging lens.

### Means for Solving the Problems

An imaging lens according to an embodiment of the present disclosure includes, in order from an object side toward an image plane side: a first lens having positive refractive power near an optical axis; a second lens having positive refractive power near the optical axis; a third lens having negative refractive power near the optical axis; a fourth lens whose lens surface on the image plane side has a concave shape toward the image plane side near the optical axis; a fifth lens whose lens surface on the image plane side has a concave shape toward the image plane side near the optical axis; and a sixth lens having negative refractive power near the optical axis. The fourth lens has negative refractive power. The fifth lens has positive refractive power.

An imaging apparatus according to an embodiment of the present disclosure includes an imaging lens; and an imaging device. The imaging device outputs an imaging signal corresponding to an optical image formed by the imaging lens. The imaging lens includes the imaging lens according to the above-described embodiment of the present disclosure.

The imaging lens or imaging apparatus according to the respective embodiments of the present disclosure includes six lenses as a whole, and the configuration of each lens is optimized.

### BRIEF DESCRIPTION OF DRAWING

FIG. 1 is a cross-sectional lens view of a first configuration example of an imaging lens according to an embodiment of the disclosure.

FIG. 2 is a cross-sectional lens view of a second configuration example of the imaging lens.

FIG. 3 is a cross-sectional lens view of a third configuration example of the imaging lens.

FIG. 4 is a cross-sectional lens view of a fourth configuration example of the imaging lens.

FIG. 5 is a cross-sectional lens view of a fifth configuration example of the imaging lens.

FIG. 6 is a cross-sectional lens view of a sixth configuration example of the imaging lens.

FIG. 7 is a cross-sectional lens view of a seventh configuration example of the imaging lens.

FIG. 8 is a cross-sectional lens view of an eighth configuration example of the imaging lens.

FIG. 9 is a cross-sectional lens view of a ninth configuration example of the imaging lens.

FIG. 10 is a cross-sectional lens view of a tenth configuration example of the imaging lens.

FIG. 11 is an aberration diagram illustrating various aberrations in Numerical Working Example 1 in which specific numerical values are applied to the imaging lens illustrated in FIG. 1.

FIG. 12 is an aberration diagram illustrating various aberrations in Numerical Working Example 2 in which specific numerical values are applied to the imaging lens illustrated in FIG. 2.

FIG. 13 is an aberration diagram illustrating various aberrations in Numerical Working Example 3 in which specific numerical values are applied to the imaging lens illustrated in FIG. 3.

FIG. 14 is an aberration diagram illustrating various aberrations in Numerical Working Example 4 in which specific numerical values are applied to the imaging lens illustrated in FIG. 4.

FIG. 15 is an aberration diagram illustrating various aberrations in Numerical Working Example 5 in which specific numerical values are applied to the imaging lens illustrated in FIG. 5.

FIG. 16 is an aberration diagram illustrating various aberrations in Numerical Working Example 6 in which specific numerical values are applied to the imaging lens illustrated in FIG. 6.

FIG. 17 is an aberration diagram illustrating various aberrations in Numerical Working Example 7 in which specific numerical values are applied to the imaging lens illustrated in FIG. 7.

FIG. 18 is an aberration diagram illustrating various aberrations in Numerical Working Example 8 in which specific numerical values are applied to the imaging lens illustrated in FIG. 8.

FIG. 19 is an aberration diagram illustrating various aberrations in Numerical Working Example 9 in which specific numerical values are applied to the imaging lens illustrated in FIG. 9.

FIG. 20 is an aberration diagram illustrating various aberrations in Numerical Working Example 10 in which specific numerical values are applied to the imaging lens illustrated in FIG. 10.

FIG. 21 is an aberration diagram illustrating lateral aberration in Numerical Working Example 1 in which specific numerical values are applied to the imaging lens illustrated in FIG. 1.

FIG. 22 is an aberration diagram illustrating lateral aberration in Numerical Working Example 2 in which specific numerical values are applied to the imaging lens illustrated in FIG. 2.

FIG. 23 is an aberration diagram illustrating lateral aberration in Numerical Working Example 3 in which specific numerical values are applied to the imaging lens illustrated in FIG. 3.

FIG. 24 is an aberration diagram illustrating lateral aberration in Numerical Working Example 4 in which specific numerical values are applied to the imaging lens illustrated in FIG. 4.

FIG. 25 is an aberration diagram illustrating lateral aberration in Numerical Working Example 5 in which specific numerical values are applied to the imaging lens illustrated in FIG. 5.

FIG. 26 is an aberration diagram illustrating lateral aberration in Numerical Working Example 6 in which specific numerical values are applied to the imaging lens illustrated in FIG. 6.

FIG. 27 is an aberration diagram illustrating lateral aberration in Numerical Working Example 7 in which specific numerical values are applied to the imaging lens illustrated in FIG. 7.

FIG. 28 is an aberration diagram illustrating lateral aberration in Numerical Working Example 8 in which specific numerical values are applied to the imaging lens illustrated in FIG. 8.

FIG. 29 is an aberration diagram illustrating lateral aberration in Numerical Working Example 9 in which specific numerical values are applied to the imaging lens illustrated in FIG. 9.

FIG. 30 is an aberration diagram illustrating lateral aberration in Numerical Working Example 10 in which specific numerical values are applied to the imaging lens illustrated in FIG. 10.

FIG. 31 is an explanatory diagram illustrating an overview of a sag amount of a lens surface of a first lens on an object side in the imaging lens according to the embodiment.

FIG. 32 is an explanatory diagram illustrating an overview of a sag amount of a lens surface of a second lens on an object side in the imaging lens according to the embodiment.

FIG. 33 is a cross-sectional view of an example of a generation path of flare generated by reflection between surfaces of a first lens in an imaging lens according to an embodiment.

FIG. 34 is a diagram illustrating an example of a shape of the flare generated by the reflection between the surfaces of the first lens in the imaging lens according to the embodiment.

FIG. 35 is a cross-sectional view of an example of a generation path of flare generated by reflection between surfaces of a second lens in the imaging lens according to the embodiment.

FIG. 36 is a diagram illustrating an example of a shape of the flare generated by the reflection between the surfaces of the second lens in the imaging lens according to the embodiment.

FIG. 37 is a cross-sectional view of an example of a generation path of flare generated by reflection between the surfaces of the first lens and the second lens in the imaging lens according to the embodiment.

FIG. 38 is a diagram illustrating an example of a shape of the flare generated by the reflection between the surfaces of the first lens and the second lens in the imaging lens according to the embodiment.

FIG. 39 is a front view of a configuration example of an imaging apparatus.

FIG. 40 is a rear view of the configuration example of the imaging apparatus.

FIG. 41 is a block diagram depicting an example of a schematic configuration of a vehicle control system.

FIG. 42 is a diagram of assistance in explaining an example of installation positions of an outside-vehicle information detecting section and an imaging section.

FIG. 43 is a view depicting an example of a schematic configuration of an endoscopic surgery system.

FIG. 44 is a block diagram depicting an example of a functional configuration of a camera head and a camera control unit (CCU) depicted in FIG. 43.

### MODES FOR CARRYING OUT THE INVENTION

In the following, embodiments of the disclosure are described in detail with reference to the drawings. It is to be noted that description is given in the following order.

### 0. Comparative Examples

### 1. Basic Configuration of Lens

### 2. Workings and Effects

### 3. Examples of Application to Imaging Apparatus

### 4. Numerical Working Examples of Lens

### 5. Application Examples

### 5.1 First Application Example

### 5.2 Second Application Example

### 6. Other Embodiments

### 0. COMPARATIVE EXAMPLES

To improve lens performance along with miniaturization and aperture enlargement, it is desirable to include six or more lenses. For example, PTL 1 (Japanese Unexamined Patent Application Publication No. 2014-44372), PTL 2 (International Publication No. WO 2015/060166), and PTL 3 (Specification of U.S. Pat. No. 9,395,519) each disclose an imaging lens including six lenses.

At least one of the lens surface of the fourth lens on the image plane side or the lens surface of the fifth lens on the image plane side has a convex shape in the imaging lens described in PTL 1. This may lead to insufficient correction of spherical aberration generated at a lens on the front side at the time of aperture enlargement and miniaturization. This sometimes makes it difficult to suppress various aberrations while satisfying predetermined optical performance. In addition, the imaging lens described in PTL 1 has flare in a wide range because of light reflection between the surfaces of each of the first lens and the second lens and light reflection between the surfaces of the combination of the first lens and the second lens, which may lead to image quality deterioration.

It is to be noted that flare is image quality deterioration caused by stray light, and includes, for example, a ghost or the like.

The satisfaction of the following conditional expression is proposed for the imaging lens described in PTL 2. However, if this conditional expression has a larger value, the light ray refracting power for an incident light ray coming from the first lens on the object surface side is weakened and the overall lens length is increased. It is not therefore suitable for miniaturization. In addition, when the aperture is enlarged, the correction of spherical aberration is not sufficient for a marginal light ray, and this makes it difficult to secure the predetermined optical performance.

0.84<|r1/f|

r1: paraxial radius of curvature of the lens surface of the first lens on the object side

f: focal length of the overall lens system

The satisfaction of the following conditional expression is proposed for the imaging lens described in PTL 3. However, if this conditional expression has a larger value, the light ray refracting power for a light ray incident on the fifth lens is weakened and the overall lens length is increased. It is therefore difficult to achieve miniaturization. In addition, when the aperture is enlarged, the correction of spherical aberration is not sufficient for a marginal light ray, and this makes it difficult to secure the predetermined optical performance.

1.35<CT5/(T56+CT6)

CT5: central thickness of the fifth lens

T56: air space between the fifth lens and the sixth lens

CT6: central thickness of the sixth lens

Accordingly, it is desirable to provide a high-performance imaging lens including six lenses and subjected to miniaturization and aperture enlargement, and an imaging apparatus mounted with such an imaging lens including six lenses.

### 1. Basic Configuration of Lens

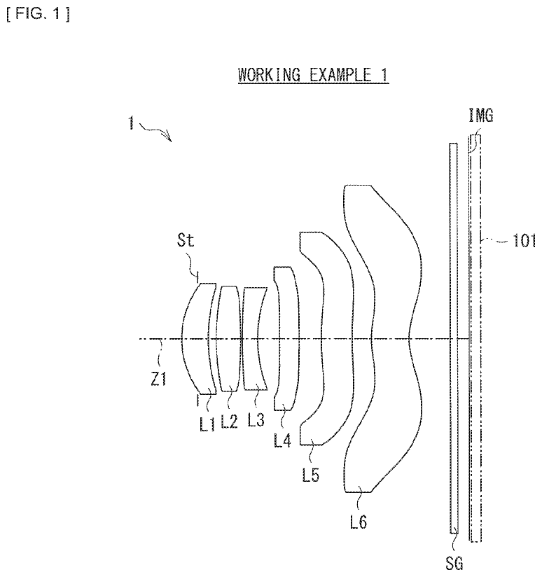

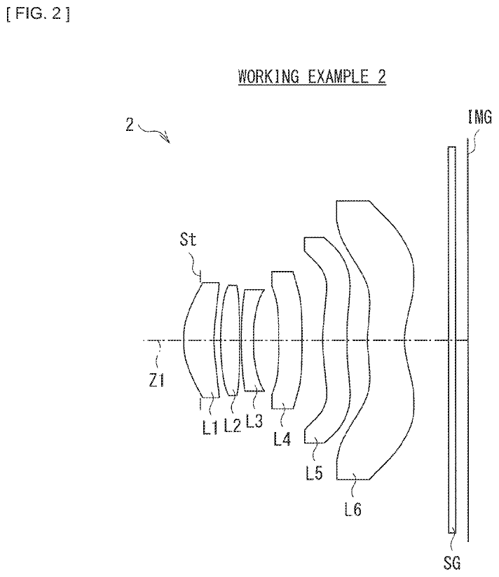

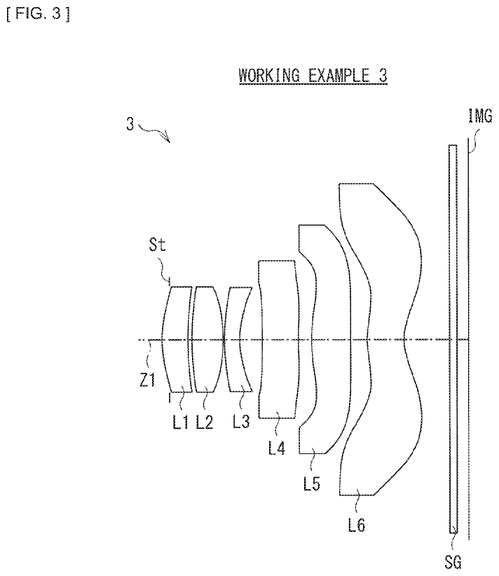

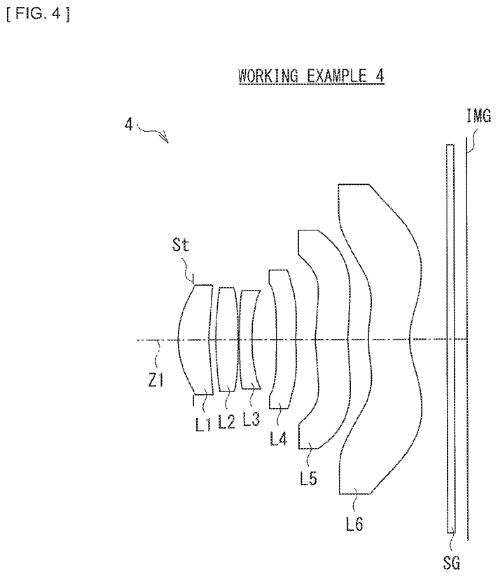

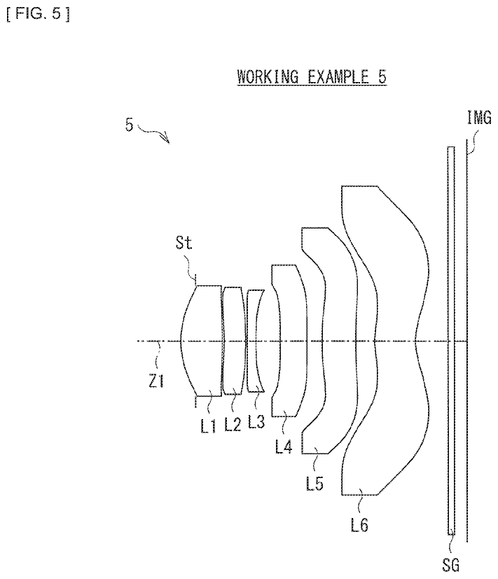

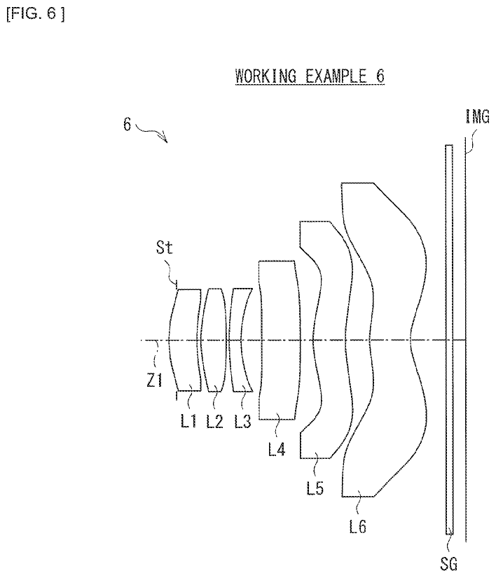

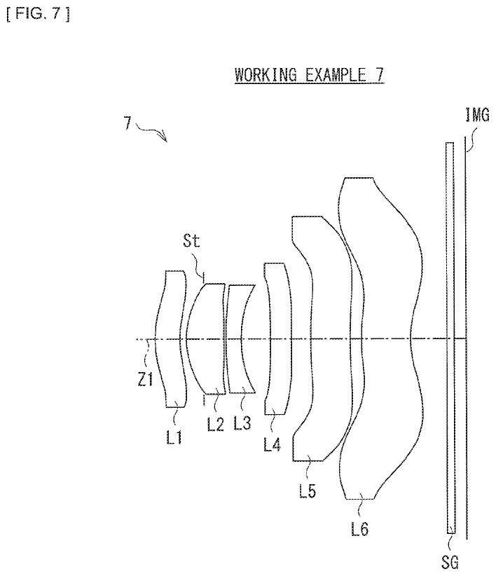

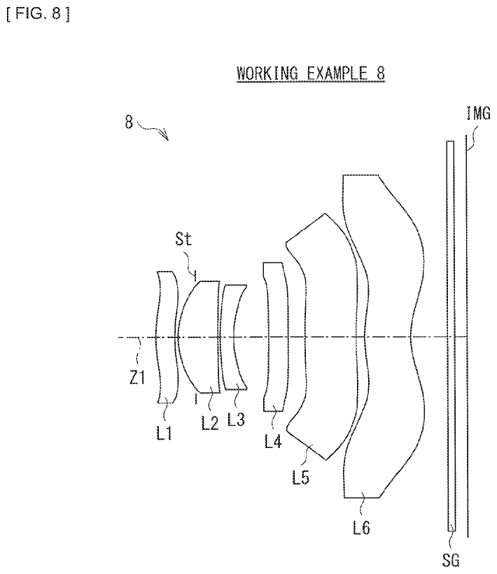

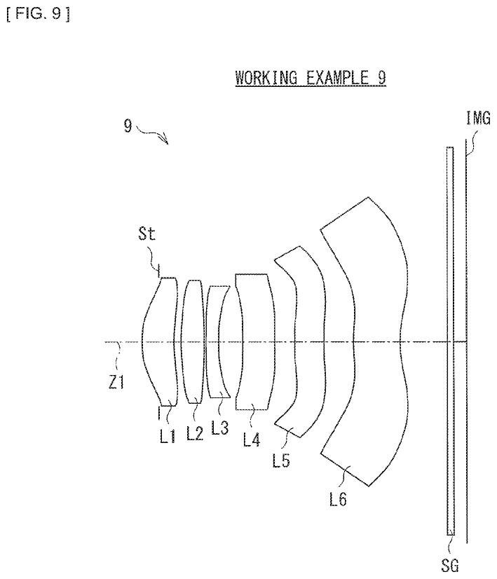

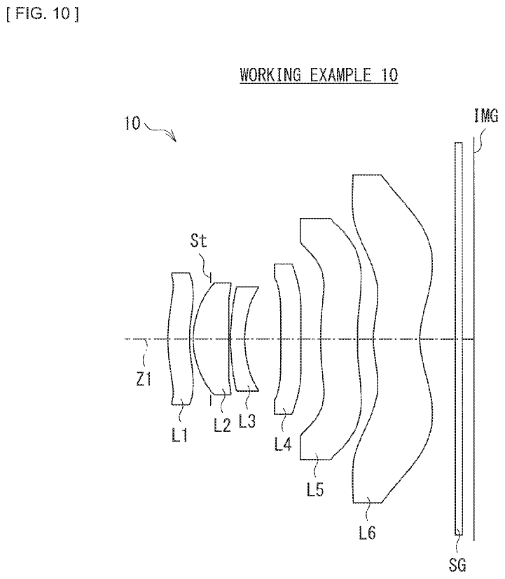

FIG. 1 illustrates a first configuration example of an imaging lens according to an embodiment of the present disclosure. FIG. 2 illustrates a second configuration example of the imaging lens. FIG. 3 illustrates a third configuration example of the imaging lens. FIG. 4 illustrates a fourth configuration example of the imaging lens. FIG. 5 illustrates a fifth configuration example of the imaging lens. FIG. 6 illustrates a sixth configuration example of the imaging lens. FIG. 7 illustrates a seventh configuration example of the imaging lens. FIG. 8 illustrates an eighth configuration example of the imaging lens. FIG. 9 illustrates a ninth configuration example of the imaging lens. FIG. 10 illustrates a tenth configuration example of the imaging lens. Numerical working examples in which specific numerical values are applied to these configuration examples are described below.

In FIG. 1 or the like, a reference sign IMG refers to an image plane, and Z1 refers to an optical axis. St refers to an aperture stop. An imaging device 101 such as CCD or CMOS may be disposed near the image plane IMG. A seal glass SG for protecting an imaging device and optical members such as various optical filters may be disposed between the imaging lens and the image plane IMG.

The following describes the configuration of the imaging lens according to the present embodiment in association with the configuration example illustrated in FIG. 1 or the like as appropriate. However, the technology of the present disclosure is not limited to the illustrated configuration example.

The imaging lens according to the present embodiment includes substantially the six lenses of a first lens L1, a second lens L2, a third lens L3, a fourth lens L4, a fifth lens L5, and a sixth lens L6 disposed along the optical axis Z1 in order from the object side toward the image plane side.

The first lens L1 has positive refractive power near the optical axis.

The second lens L2 has positive refractive power near the optical axis.

The third lens L3 has negative refractive power near the optical axis.

The fourth lens L4 has negative refractive power near the optical axis. The lens surface of the fourth lens L4 on the image plane side is shaped to have a concave shape toward the image plane side near the optical axis.

The fifth lens L5 has positive refractive power near the optical axis. The lens surface of the fifth lens L5 on the image plane side is shaped to have a concave shape toward the image plane side near the optical axis.

The sixth lens L6 has negative refractive power near the optical axis.

Additionally, it is desirable that the imaging lens according to the present embodiment satisfy a predetermined conditional expression or the like described below.

### 2. Workings and Effects

Next, the workings and effects of the imaging lens according to the present embodiment are described. A more desirable configuration of the imaging lens according to the present embodiment is described together.

It is to be noted that the effects described in this specification are merely illustrative and non-limiting. In addition, there may be any other effect as well.

The imaging lens according to the present embodiment includes six lenses as a whole, and the configuration of each lens is optimized. This makes it possible to favorably correct various aberrations in spite of smallness and a large aperture, and reduce image quality deterioration caused by stray light such as flare.

It is desirable that the optimization of refractive power arrangement, the optimization of a lens shape effectively using an aspheric surface, the optimization of a lens material, and the like be performed in the imaging lens according to the present embodiment as described below.

It is desirable that the respective lens surfaces of the fourth lens L4 and the fifth lens L5 on the image plane side each have an aspherical shape with an inflection point in the imaging lens according to the present embodiment. That is, it is desirable that the respective lens surfaces of the fourth lens L4 and the fifth lens L5 on the image plane side each have an aspherical shape with an inflection point in which the concave-convex shape changes in the middle from the central part toward the peripheral part. More specifically, it is desirable that the respective lens surfaces of the fourth lens L4 and the fifth lens L5 on the image plane side each have an aspherical shape in which the lens surface has a concave shape near the optical axis and a convex shape at the peripheral part. The concave shapes of the respective lens surfaces of the fourth lens L4 and the fifth lens L5 on the image plane side near the optical axis, and the convex shapes thereof at the peripheral parts allow for aberration correction effects different between the part near the optical axis and the parts other than the part near the optical axis. This makes it possible to secure smallness and favorable performance.

In addition, it is desirable that the sixth lens L6 have an aspherical shape with an inflection point on the lens surface on the image plane side in the imaging lens according to the present embodiment. That is, it is desirable that the lens surface of the sixth lens L6 on the image plane side have an aspherical shape with an inflection point in which the concave-convex shape changes in the middle from the central part toward the peripheral part. The concave shape of the lens surface of the sixth lens L6 on the image plane side near the optical axis, and the convex shape thereof at the peripheral part make it possible to suppress the angle of light incident on the image plane IMG after emitted from the sixth lens L6.

It is desirable that the imaging lens according to the present embodiment satisfy the following conditional expression (1).

0.6<f12/f<1.0 (1)

where f12 represents the composite focal length of the first lens L1 and the second lens L2, and f represents the focal length of the overall lens system.

The above-described conditional expression (1) defines the ratio of the composite focal length of the first lens L1 and the second lens L2 to the focal length of the overall lens system. Satisfying the conditional expression (1) makes it possible to secure smallness and favorable performance. If the upper limit of the conditional expression (1) is exceeded, the composite focal length of the first lens L1 and the second lens L2 is increased and the overall lens length is increased. This makes it difficult to achieve miniaturization. If the lower limit of the conditional expression (1) is exceeded, the proportion of the composite focal length of the first lens L1 and the second lens L2 to the focal length of the overall lens system is increased. This generates high-order spherical aberration or comatic aberration, and makes it difficult to secure optical performance.

In addition, it is desirable that the imaging lens according to the present embodiment further satisfy the following conditional expression (2).

0.0<f3/f4<0.7 (2)

where f3 represents the focal length of the third lens L3, and f4 represents the focal length of the fourth lens L4.

The above-described conditional expression (2) defines the ratio of the focal length of the third lens L3 to the focal length of the fourth lens L4. Satisfying the conditional expression (2) makes it possible to secure smallness and favorable performance. If the upper limit of the conditional expression (2) is exceeded, the focal length of the third lens L3 is increased to weaken the refractive power of the third lens L3 too much to sufficiently obtain the lens aberration correction effects. Alternatively, the refractive power of the fourth lens L4 is strengthened too much, resulting in excessive correction. If the lower limit of the conditional expression (2) is exceeded, the focal length of the third lens L3 is shortened to sharpen the angle for the third lens L3 to raise an upper light ray and make it difficult to correct comatic aberration and field curvature. This is also disadvantageous to reduce the height. Alternatively, the refractive power of the fourth lens L4 is weakened too much to obtain sufficient aberration correction effects.

In addition, it is desirable that the imaging lens according to the present embodiment satisfy the following conditional expression (3).

f1/L1R1sag>10.0 (3)

where f1 represents the focal length of the first lens L1, and L1R1sag represents the maximum value of the sag amount of the lens surface of the first lens L1 on the object side at the effective diameter (the inclination of the lens surface toward the image plane side is set as positive, and the unit is “mm”).

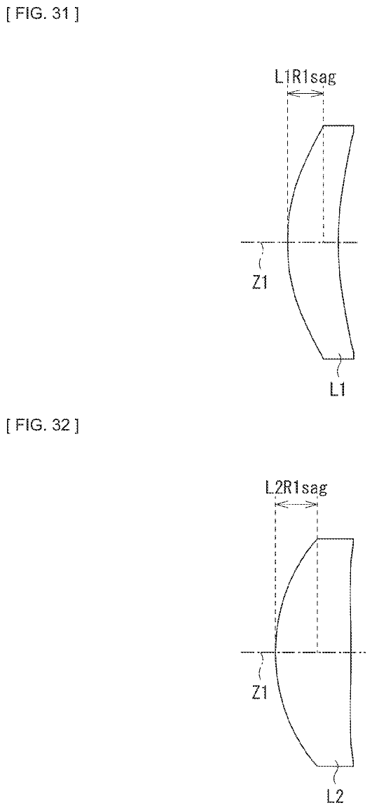

FIG. 31 illustrates an example of the sag amount L1R1sag of the lens surface of the first lens L1 on the object side at the effective diameter. The sag amount L1R1sag is positive in a case where the lens surface is inclined toward the image plane side, and the sag amount L1R1sag is negative in a case where the lens surface is inclined toward the object side. The unit is “mm”. The same applies to the sag amounts of other lens surfaces in other conditional expressions described below.

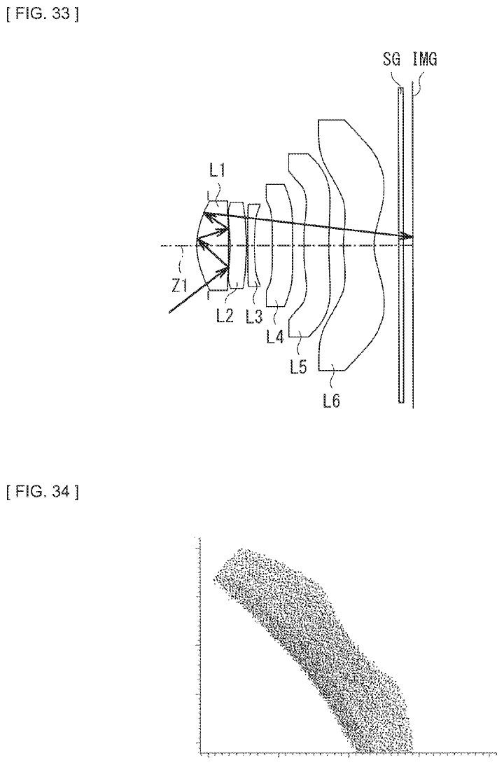

FIG. 33 illustrates an example of a generation path of flare generated by reflection between the surfaces of the first lens L1. FIG. 34 illustrates an example of the shape of flare generated by reflection between the surfaces of the first lens L1. The above-described conditional expression (3) defines the ratio of the focal length of the first lens L1 to the maximum value of the sag amount of the lens surface of the first lens L1 on the object side. Satisfying the conditional expression (3) makes it possible to reduce or eliminate flare in spite of a large aperture, and secure favorable resolution performance. If the lower limit of the conditional expression (3) is exceeded, the positive refractive power of the first lens L1 is strengthened. As illustrated in FIG. 33, the total reflection and reflection of stray light on the lens surface of the first lens L1 on the object side and the lens surface thereof on the image plane side generate strong flare on the image plane IMG. The strong flare concentrates on the arc as illustrated in FIG. 34. It is to be noted that FIGS. 33 and 34 each illustrate flare by using, as an example, a working example (Numerical Working Example 5) in which the value of f1/L1R1sag is the closest to the lower limit among Numerical Working Examples 1 to 10 described below.

It is to be noted that, to more favorably achieve the effects of the above-described conditional expression (3), it is more desirable that the numerical range of the conditional expression (3) be set as expressed by the following conditional expression (3)′.

10.0<f1/L1R1sag<100.0 (3)′

To still more favorably achieve the effects of the above-described conditional expression (3), it is more desirable that the numerical range of the conditional expression (3) be set as expressed by the following conditional expression (3)″.

10.0<f1/L1R1sag<25.0 (3)″

In addition, it is desirable that the imaging lens according to the present embodiment satisfy the following conditional expression (4).

f2/L2R1sag>7.0 (4)

where f2 represents the focal length of the second lens L2, and L2R1sag represents the maximum value of the sag amount of the lens surface of the second lens L2 on the object side at the effective diameter (the inclination of the lens surface toward the image plane side is set as positive, and the unit is “mm”).

FIG. 32 illustrates an example of the sag amount L2R1sag of the lens surface of the second lens L2 on the object side at the effective diameter. The sag amount L2R1sag is positive in a case where the lens surface is inclined toward the image plane side, and the sag amount L2R1sag is negative in a case where the lens surface is inclined toward the object side. The unit is “mm”.

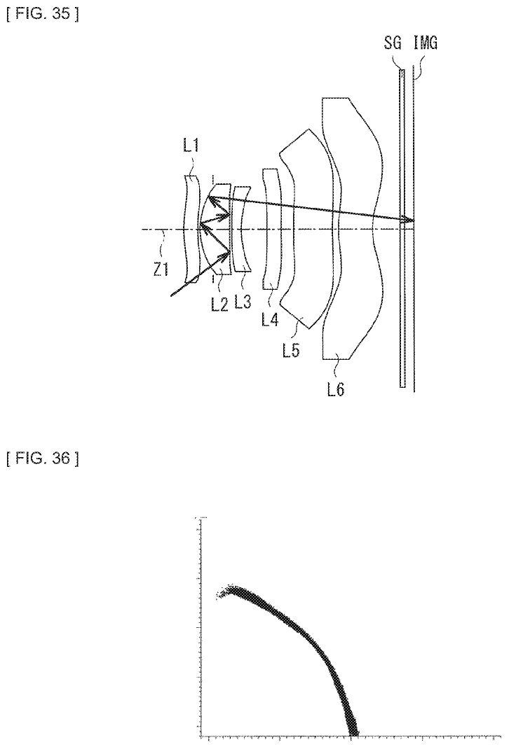

FIG. 35 illustrates an example of a generation path of flare generated by reflection between the surfaces of the second lens L2. FIG. 36 illustrates an example of the shape of flare generated by reflection between the surfaces of the second lens L2. The above-described conditional expression (4) defines the ratio of the focal length of the second lens L2 to the maximum value of the sag amount of the lens surface of the second lens L2 on the object side. Satisfying the conditional expression (4) makes it possible to reduce or eliminate flare in spite of a large aperture, and secure favorable resolution performance. If the lower limit of the conditional expression (4) is exceeded, the positive refractive power of the second lens L2 is strengthened. As illustrated in FIG. 35, the total reflection and reflection of stray light on the lens surface of the second lens L2 on the object side and the lens surface thereof on the image plane side generate strong flare on the image plane IMG. The strong flare concentrates on the arc as illustrated in FIG. 36. It is to be noted that FIGS. 35 and 36 each illustrate flare by using, as an example, a working example (Numerical Working Example 8) in which the value of f2/L2R1sag is the closest to the lower limit among Numerical Working Examples 1 to 10 described below.

It is to be noted that, to more favorably achieve the effects of the above-described conditional expression (4), it is more desirable that the numerical range of the conditional expression (4) be set as expressed by the following conditional expression (4)′.

7.0<f2/L2R1sag<200.0 (4)′

To still more favorably achieve the effects of the above-described conditional expression (4), it is more desirable that the numerical range of the conditional expression (4) be set as expressed by the following conditional expression (4)″.

7.0<f2/L2R1sag<100.0(4)″

In addition, it is desirable that the imaging lens according to the present embodiment satisfy the following conditional expression (5).

2.65<(D(L1)+D(L12)+D(L2))/L1R1sag<55.0 (5)

where D(L1) represents the central thickness of the first lens L1, D(L12) represents the air space between the first lens L1 and the second lens L2, D(L2) represents the central thickness of the second lens L2, and L1R1 sag represents the maximum value of the sag amount of the lens surface of the first lens L1 on the object side at the effective diameter (the inclination of the lens surface toward the image plane side is set as positive, and the unit is “mm”).

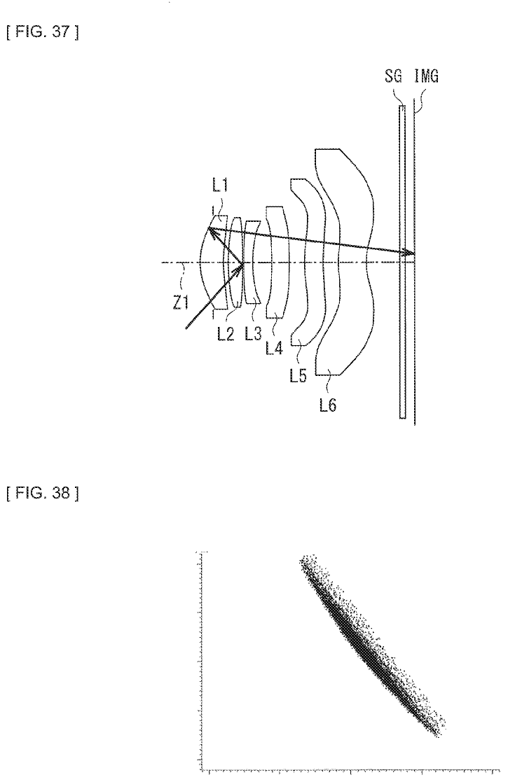

FIG. 37 illustrates an example of a generation path of flare generated by reflection between the surfaces of the first lens L1 and the second lens L2. FIG. 38 illustrates an example of the shape of flare generated by reflection between the surfaces of the second lens L2. The above-described conditional expression (5) defines the central thickness of the first lens L1, the air space between the first lens L1 and the second lens L2, and the ratio of the composite length of the central thickness of the second lens L2 to the maximum value of the sag amount of the lens surface of the first lens L1 on the object side. Satisfying the conditional expression (5) makes it possible to reduce or eliminate flare in spite of a large aperture, and secure favorable resolution performance. If the lower limit of the conditional expression (5) is exceeded, the central thickness of the first lens L1, the air space between the first lens L1 and the second lens L2, and the composite length of the central thickness of the second lens L2 are shortened. In addition, if the lower limit of the conditional expression (5) is exceeded, the lens surface of the first lens L1 on the object side is steeply inclined toward the image plane side. As illustrated in FIG. 37, the reflection of stray light on the lens surface of the first lens L1 on the object side and the lens surface of the second lens L2 on the image plane side generates strong flare on the image plane IMG. The strong flare concentrates on the arc as illustrated in FIG. 38. In addition, if the upper limit value of the conditional expression (5) is exceeded, the central thickness of the first lens L1, the air space between the first lens L1 and the second lens L2, and the composite length of the central thickness of the second lens L2 are increased. This makes it difficult to shorten the overall length of the optical system. It is to be noted that FIGS. 37 and 38 each illustrate flare by using, as an example, a working example (Numerical Working Example 2) in which the value of (D(L1)+D(L12)+D(L2))/L1R1sag is the closest to the lower limit among Numerical Working Examples 1 to 10 described below.

It is to be noted that, to more favorably achieve the effects of the above-described conditional expression (5), it is more desirable that the numerical range of the conditional expression (5) be set as expressed by the following conditional expression (5)′.

2.65<(D(L1)+D(L12)+D(L2))/L1R1sag<15.0 (5)′

To still more favorably achieve the effects of the above-described conditional expression (5), it is more desirable that the numerical range of the conditional expression (5) be set as expressed by the following conditional expression (5)″.

2.65<(D(L1)+D(L12)+D(L2))/L1R1sag<8.0 (5)″

In addition, it is desirable that the imaging lens according to the present embodiment further satisfy the following conditional expressions (6A) and (6B).

15.0<νd(L4)<35.0 (6A)

15.0<νd(L5)<35.0 (6B)

where νd(L4) represents the Abbe number of the fourth lens L4 for the d line, and νd(L5) represents the Abbe number of the fifth lens L5 for the d line.

The above-described conditional expressions (6A) and (6B) respectively define the Abbe number of the fourth lens L4 and the Abbe number of the fifth lens L5. Satisfying the conditional expressions (6A) and (6B) makes it possible to secure favorable performance. If the upper limits of the conditional expressions (6A) and (6B) are exceeded, it is not possible to sufficiently obtain the off-axis refractive index of the F line or the g line. It is thus not possible to suppress the chromatic aberration of magnification. If the lower limits of the conditional expressions (6A) and (6B) are exceeded, the off-axis refractive index of the F line or the g line is too excessive. It is thus not possible to suppress the chromatic aberration of magnification.

In addition, it is desirable that the imaging lens according to the present embodiment further satisfy the following conditional expression (7).

0.35<D(L5)/(D(L56)+D(L6))<1.05 (7)

where D(L5) represents the central thickness of the fifth lens L5, D(L56) represents the air space between the fifth lens L5 and the sixth lens L6, and D(L6) represents the central thickness of the sixth lens L6.

The above-described conditional expression (7) defines the ratio of the central thickness of the fifth lens L5 to the air space between the fifth lens L5 and the sixth lens L6 and the composite length of the central thickness of the sixth lens L6. Satisfying the conditional expression (7) makes it possible to secure smallness and favorable performance. If the upper limit of the conditional expression (7) is exceeded, the light ray refracting power for a light ray incident on the fifth lens L5 is weakened and the overall lens length is increased. This makes it difficult to achieve miniaturization. If the lower limit of the conditional expression (7) is exceeded, the light ray refracting power for a light ray incident on the fifth lens L5 is strengthened and the overall thickness is reduced. This makes it easy to correct comatic aberration, but results in reduced lens moldability.

In addition, it is desirable that the imaging lens according to the present embodiment further satisfy the following conditional expression (8).

−11.5<f4/R(L4R2)<0.0 (8)

where f4 represents the focal length of the fourth lens L4, and R(L4R2) represents the paraxial radius of curvature of the lens surface of the fourth lens L4 on the image plane side.

The above-described conditional expression (8) defines the ratio of the focal length of the fourth lens L4 to the paraxial radius of curvature of the lens surface of the fourth lens L4 on the image plane side. Satisfying the conditional expression (8) makes it possible to secure smallness and favorable performance. If the upper limit of the conditional expression (8) is exceeded, it is necessary to make the refractive power of the fourth lens L4 positive near the optical axis. This causes the Petzval image plane to fall on the over side and makes it difficult to correct aberration. If the lower limit of the conditional expression (8) is exceeded, the focal length of the fourth lens L4 is increased to weaken the refractive power. The overall lens length is increased to make it difficult to achieve miniaturization.

In addition, it is desirable that the imaging lens according to the present embodiment further satisfy the following conditional expression (9).

0.0<f5/R(L5R2)<145.0 (9)

where f5 represents the focal length of the fifth lens L5, and R(L5R2) represents the paraxial radius of curvature of the lens surface of the fifth lens L5 on the image plane side.

The above-described conditional expression (9) defines the ratio of the focal length of the fifth lens L5 to the paraxial radius of curvature of the lens surface of the fifth lens L5 on the image plane side. Satisfying the conditional expression (9) makes it possible to secure smallness and favorable performance. If the upper limit of the conditional expression (9) is exceeded, the focal length of the fifth lens L5 is increased to weaken the refractive power. The overall lens length is increased to make it difficult to achieve miniaturization. If the lower limit of the conditional expression (9) is exceeded, it is necessary to make the refractive index of the fifth lens L5 negative. This makes it possible to correct the Petzval image plane toward the under side, but makes it difficult to correct spherical aberration.

It is to be noted that, to more favorably achieve the effects of the above-described conditional expression (9), it is more desirable that the numerical range of the conditional expression (9) be set as expressed by the following conditional expression (9)′.

0.0<f5/R(L5R2)<30.0(9)′

In addition, it is desirable that the imaging lens according to the present embodiment further satisfy the following conditional expression (10).

2.3<(R(L6R1)+R(L6R2))/(R(L6R1)−R(L6R2))<9.1 (10)

where R(L6R1) represents the paraxial radius of curvature of the lens surface of the sixth lens L6 on the object side, and R(L6R2) represents the paraxial radius of curvature of the lens surface of the sixth lens L6 on the image plane side.

The above-described conditional expression (10) defines the respective shapes of the lens surface of the sixth lens L6 on the object side and the lens surface thereof on the image plane side at the paraxial radii of curvature. Satisfying the conditional expression (10) makes it possible to secure favorable performance. If the upper limit or lower limit of the conditional expression (10) is exceeded, it is difficult to correct spherical aberration and high-order aberration of an off-axis light ray.

In addition, it is desirable that the imaging lens according to the present embodiment further satisfy the following conditional expression (11).

0.33<|R(L1R1)/f|<0.78 (11)

where R(L1R1) represents the paraxial radius of curvature of the lens surface of the first lens L1 on the object side, and f represents the focal length of the overall lens system.

The above-described conditional expression (11) defines the ratio of the paraxial radius of curvature of the first lens L1 on the object side to the focal length of the overall lens system. Satisfying the conditional expression (11) makes it possible to secure smallness and favorable performance. If the upper limit of the conditional expression (11) is exceeded, the lens surface of the first lens L1 on the object side has a larger paraxial radius of curvature. The light ray refracting power for an incident light ray coming from the first lens L1 is weakened and the overall lens length is increased. This makes it difficult to achieve miniaturization. If the lower limit of the conditional expression (11) is exceeded, the lens surface of the first lens L1 on the object side has a smaller paraxial radius of curvature and high-order spherical aberration or comatic aberration is generated to make it difficult to secure optical performance.

In addition, it is desirable that an aperture stop St be disposed between the lens surface of the first lens L1 on the object side and the lens surface of the first lens L1 on the image plane side in the imaging lens according to the present embodiment (see the configuration examples in FIGS. 1 to 6 and 9). Alternatively, it is desirable that the aperture stop St be disposed between the lens surface of the first lens L1 on the image plane side and the lens surface of the second lens L2 on the image plane side (see the configuration examples in FIGS. 7 to 8 and 10). In a case where the aperture stop St is disposed between the lens surface of the first lens L1 on the object side and the lens surface of the first lens L1 on the image plane side, it is possible to suppress the dispersion of a light ray incident on the first lens L1. This makes it possible to achieve both aberration correction and improvement of flare caused by the first lens L1. In addition, in a case where the aperture stop St is disposed between the lens surface of the first lens L1 on the image side and the lens surface of the second lens L2 on the image plane side, it is possible to suppress the dispersion of a light ray incident on the second lens L2. This makes it possible to achieve both aberration correction and improvement of flare caused by the second lens L2.

### 3. Examples of Application to Imaging Apparatus

Next, examples of the application of the imaging lens according to the present embodiment to an imaging apparatus are described.

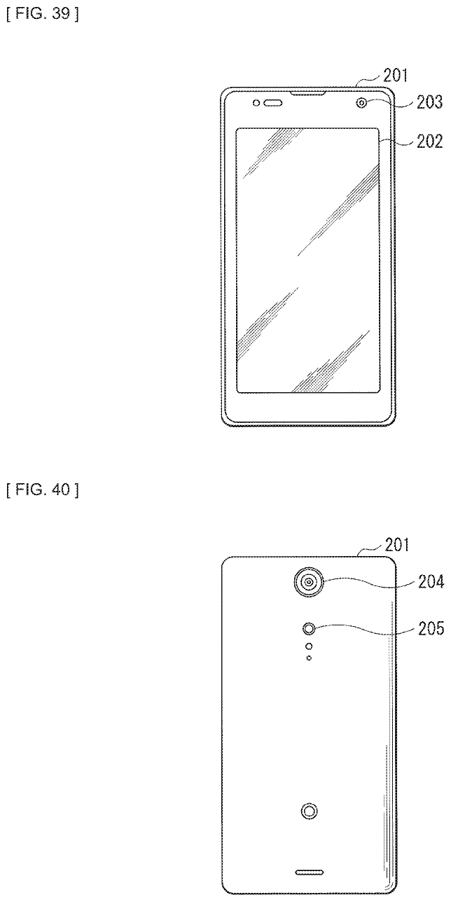

FIGS. 39 and 40 each illustrate a configuration example of an imaging apparatus to which the imaging lens according to the present embodiment is applied. This configuration example is an example of a mobile terminal apparatus (e.g., mobile information terminal and mobile phone terminal) including the imaging apparatus. This mobile terminal apparatus includes a substantially rectangular housing 201. A display section 202 and a front camera section 203 are provided on the front surface side of the housing 201 (FIG. 39). A main camera section 204 and a camera flash 205 are provided on the rear surface side of the housing 201 (FIG. 40).

For example, the display section 202 is a touch panel that senses the state of contact with the surface to allow for various operations. This causes the display section 202 to have a display function of displaying various kinds of information and an input function of allowing a user to perform an input operation. The display section 202 displays an operation state and various kinds of data such as an image taken by the front camera section 203 or the main camera section 204.

For example, the imaging lens according to the present embodiment is applicable as a camera module lens of the imaging apparatus (front camera section 203 or main camera section 204) in the mobile terminal apparatus as illustrated in FIGS. 39 and 40. In a case where the imaging lens according to the present embodiment is used as such a camera module lens, an imaging device 101 such as CCD or CMOS is disposed near the image plane IMG of the imaging lens as illustrated in FIG. 1. The imaging device 101 outputs an imaging signal (image signal) corresponding to an optical image formed by the imaging lens. In this case, as illustrated in FIG. 1 or the like, the seal glass SG for protecting an imaging device and optical members such as various optical filters may be disposed between the final lens and the image plane IMG. In addition, the seal glass SG and the optical members such as various optical filters may be disposed at any position as long as they are disposed between the final lens and the image plane IMG.

It is noted that the imaging lens according to the present embodiment is not limited to the above-described mobile terminal apparatus, but is also applicable as an imaging lens for other electronic apparatuses, for example, a digital still camera and a digital video camera. Additionally, the imaging lens according to the present embodiment is applicable to general small imaging apparatuses each including a solid-state imaging device such as CCD and CMOS. The small imaging apparatuses include, for example, an optical sensor, a mobile module camera, a WEB camera, and the like. In addition, the imaging lens according to the present embodiment is also applicable to a monitoring camera or the like.

### WORKING EXAMPLES

### 4. Numerical Working Examples of Lens

Next, specific numerical working examples of the imaging lens according to the present embodiment are described.

Here, numerical working examples are described in which specific numerical values are applied to the imaging lenses 1 to 10 of the respective configuration examples illustrated in FIGS. 1 to 10.

It is to be noted that the meanings and the like of the respective symbols indicated in the following tables and description are as follows. “Si” represents the number of the i-th surface that is counted from the side closest to the object side. “Ri” represents the value (mm) of the paraxial radius of curvature of the i-th surface. “Di” represents the value (mm) of the interval between the i-th surface and (i+1)-th surface on the optical axis. “Ndi” represents the value of the refractive index of a material of an optical element having the i-th surface in the d line (wavelength of 587.6 nm). “νdi” represents the value of the Abbe number of a material of an optical element having the i-th surface in the d line. A portion at which the value of “Ri” is “∞” indicates a flat surface or a virtual surface. “Li” represents an attribute of a surface. In “Li”, for example, “L1R1” represents the lens surface of the first lens L1 on the object side, and “L1R2” represents the lens surface of the first lens L1 on the image plane side. Similarly, in “Li”, “L2R1” represents the lens surface of the second lens L2 on the object side, and “L2R2” represents the lens surface of the second lens L2 on the image plane side. The same applies to other lens surfaces as well.

In addition, some of the lenses used in the respective numerical working examples have aspherical lens surfaces. The aspherical shape is defined by the following expression. It is to be noted that, in the respective tables illustrating aspherical surface coefficients described below, “E-i” represents an exponential expression having 10 as a base, that is, “10⁻ⁱ”. For example, “0.12345E-05” represents “0.12345×10⁻⁵”.

Z=C·h²/{1+(1−(1+K)·C²·h²)^{1/2}}+ΣAn·hⁿ (Aspherical Surface Expression)

(n=an integer greater than or equal to three)

where Z represents the depth of an aspherical surface, C represents the paraxial curvature equal to 1/R, h represents the length from the optical axis to a lens surface, K represents an eccentricity (second-order aspherical surface coefficient), and An represents an n-th order aspherical surface coefficient.

### (Configuration Common to Respective Numerical Working Examples)

The imaging lenses 1 to 10 to which the following respective numerical working examples are applied each have a configuration that satisfies the above-described basic configuration of the lens. That is, the imaging lenses 1 to 10 each includes substantially the six lenses of the first lens L1, the second lens L2, the third lens L3, the fourth lens L4, the fifth lens L5, and the sixth lens L6 disposed in order from the object side toward the image plane side.

The first lens L1 has positive refractive power near the optical axis. The second lens L2 has positive refractive power near the optical axis. The third lens L3 has negative refractive power near the optical axis. The fourth lens L4 has negative refractive power near the optical axis. The lens surface of the fourth lens L4 on the image plane side is shaped to have a concave shape toward the image plane side near the optical axis. The fifth lens L5 has positive refractive power near the optical axis. The lens surface of the fifth lens L5 on the image plane side is shaped to have a concave shape toward the image plane side near the optical axis. The sixth lens L6 has negative refractive power near the optical axis.

The aperture stop St is disposed between the lens surface of the first lens L1 on the object side and the lens surface of the first lens L1 on the image plane side or between the lens surface of the first lens L1 on the image plane side and the lens surface of the second lens L2 on the image plane side.

The seal glass SG is disposed between the sixth lens L6 and the image plane IMG.

### Numerical Working Example 1

[Table 1] illustrates basic lens data of Numerical Working Example 1 in which specific numerical values are applied to the imaging lens 1 illustrated in FIG. 1. In the imaging lens 1 according to Numerical Working Example 1, the aperture stop St is disposed between the lens surface of the first lens L1 on the object side and the lens surface of the first lens L1 on the image plane side.

In the imaging lens 1 according to Numerical Working Example 1, both surfaces of each of the first lens L1 to the sixth lens L6 have aspherical shapes. [Table 2] and [Table 3] illustrate the values of coefficients representing these aspherical shapes.

In addition, [Table 4] illustrates the respective values of the focal length f, F-number, overall length, and half angle ω of view of the overall lens system in the imaging lens 1 according to Numerical Working Example 1. [Table 5] illustrates the values of the respective focal lengths of the first lens L1, the second lens L2, the third lens L3, the fourth lens L4, the fifth lens L5, and the sixth lens L6.

TABLE 1
Working Example 1

| Si | Li | Ri | Di | Ndi | ν di |
|---|---|---|---|---|---|
| 1 | | | 0.260 | | |
| 2 | St | ∞ | −0.260 | | |
| 3 | L1R1 | 1.616 | 0.433 | 1.544 | 56.1 |
| 4 | L1R2 | 2.716 | 0.131 | | |
| 5 | L2R1 | 3.412 | 0.405 | 1.544 | 56.1 |
| 6 | L2R2 | −17.873 | 0.026 | | |
| 7 | L3R1 | 12.265 | 0.250 | 1.671 | 19.2 |
| 8 | L3R2 | 3.447 | 0.355 | | |
| 9 | L4R1 | 12.006 | 0.307 | 1.650 | 21.5 |
| 10 | L4R2 | 10.113 | 0.369 | | |
| 11 | L5R1 | 5.003 | 0.498 | 1.635 | 24.0 |
| 12 | L5R2 | 6.120 | 0.322 | | |
| 13 | L6R1 | 1.862 | 0.616 | 1.535 | 55.7 |
| 14 | L6R2 | 1.376 | 0.667 | | |
| 15 | SGR1 | ∞ | 0.110 | 1.517 | 64.2 |
| 16 | SGR2 | ∞ | 0.200 | | |
| 17 | IMG | | | | |

TABLE 2
Working Example 1

| | Si | | | |
|---|---|---|---|---|
| | 3 | 4 | 5 | 6 |
| R | 1.616 | 2.716 | 3.412 | −17.873 |
| K | −2.4475E−01 | 1.2790E+00 | −5.7216E+00 | 9.9825E+00 |
| A3 | 0.0000E+00 | 0.0000E+00 | 0.0000E+00 | 0.0000E+00 |
| A4 | −1.1300E−02 | −6.7660E−02 | −5.0999E−02 | −9.6365E−02 |
| A5 | 0.0000E+00 | 0.0000E+00 | 0.0000E+00 | 0.0000E+00 |
| A6 | −1.1189E−02 | −6.2665E−03 | −1.9812E−02 | 2.4566E−01 |
| A7 | 0.0000E+00 | 0.0000E+00 | 0.0000E+00 | 0.0000E+00 |
| A8 | −1.0509E−03 | −7.0083E−02 | 3.4573E−03 | −5.3263E−01 |
| A9 | 0.0000E+00 | 0.0000E+00 | 0.0000E+00 | 0.0000E+00 |
| A10 | −1.0066E−02 | 1.6119E−01 | 9.0210E−02 | 5.6211E−01 |
| A11 | 0.0000E+00 | 0.0000E+00 | 0.0000E+00 | 0.0000E+00 |
| A12 | 3.6100E−03 | −1.0835E−01 | −5.5861E−02 | −2.7669E−01 |
| A13 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 12.265 | 3.447 | 12.006 | 10.113 |
| K | −9.9807E+00 | −2.9773E+00 | 2.6941E+00 | −9.5511E+00 |
| A3 | 0.0000E+00 | 0.0000E+00 | 0.0000E+00 | 0.0000E+00 |
| A4 | −5.8646E−02 | −7.9792E−03 | 6.4252E−03 | −9.0173E−02 |
| A5 | 0.0000E+00 | 0.0000E+00 | 0.0000E+00 | 0.0000E+00 |
| A6 | 3.0079E−01 | 1.5226E−01 | 3.4996E−02 | −6.9934E−02 |
| A7 | 0.0000E+00 | 0.0000E+00 | 0.0000E+00 | 0.0000E+00 |
| A8 | −6.1129E−01 | −2.7439E−01 | 2.2083E−02 | 2.0139E−01 |
| A9 | 0.0000E+00 | 0.0000E+00 | 0.0000E+00 | 0.0000E+00 |
| A10 | 5.3759E−01 | 2.7582E−01 | 8.2369E−02 | −2.1628E−01 |
| A11 | 0.0000E+00 | 0.0000E+00 | 0.0000E+00 | 0.0000E+00 |
| A12 | −1.6108E−01 | −1.5736E−01 | −2.7771E−01 | 1.3396E−01 |
| A13 | 0.0000E+00 | 0.0000E+00 | 0.0000E+00 | 0.0000E+00 |
| A14 | 1.6222E−03 | 6.8078E−02 | 2.6345E−01 | −4.4181E−02 |
| A15 | 0.0000E+00 | 0.0000E+00 | 0.0000E+00 | 0.0000E+00 |
| A16 | 2.1773E−04 | 9.4969E−04 | −1.0107E−01 | 5.3719E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 3
Working example 1

| | Si | | | |
|---|---|---|---|---|
| | 11 | 12 | 13 | 14 |
| R | 5.003 | 6.120 | 1.862 | 1.376 |
| K | 5.7806E+00 | 8.5185E+00 | −5.7907E−01 | −2.2959E+00 |
| A3 | −2.1271E−02 | −5.1003E−02 | −2.8365E−02 | 6.7602E−02 |
| A4 | 8.2601E−03 | −4.2909E−02 | −3.7204E−01 | −4.4510E−01 |
| A5 | −2.3564E−02 | 5.4139E−02 | 1.1799E−01 | 3.1053E−01 |
| A6 | −6.0109E−02 | −2.6561E−02 | 5.0110E−02 | −2.4773E−02 |
| A7 | −2.8919E−02 | −9.4214E−03 | −6.7723E−03 | −5.5602E−02 |
| A8 | 8.5084E−02 | −9.7901E−03 | −1.1336E−02 | 1.6166E−02 |
| A9 | 4.5918E−03 | 9.7221E−04 | 1.2722E−03 | 2.3247E−03 |
| A10 | −6.1966E−02 | 5.6030E−03 | 1.0650E−03 | −3.3917E−04 |
| A11 | 3.7962E−03 | −1.0315E−04 | −4.3532E−05 | −2.3288E−04 |
| A12 | 2.5190E−02 | −1.2465E−03 | −1.1773E−04 | −1.3692E−04 |
| A13 | −2.1919E−03 | −2.3424E−05 | 3.7421E−06 | 3.4019E−05 |
| A14 | −5.8897E−03 | 1.2934E−04 | 7.7963E−06 | 1.1367E−05 |
| A15 | 4.3267E−04 | −1.5251E−06 | 1.0816E−06 | −4.0121E−09 |
| A16 | 6.5514E−04 | −3.7933E−06 | −6.3568E−07 | −7.1151E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 4
Working Example 1

| | |
|---|---|
| f | 3.95 |
| F-number | 2.0 |
| Overall Length | 4.690 |
| ω | 41.9 |

TABLE 5
Working Example 1

| | Focal Length |
|---|---|
| L1 | 6.44 |
| L2 | 5.30 |
| L3 | −7.23 |
| L4 | −105.41 |
| L5 | 36.80 |
| L6 | −17.65 |

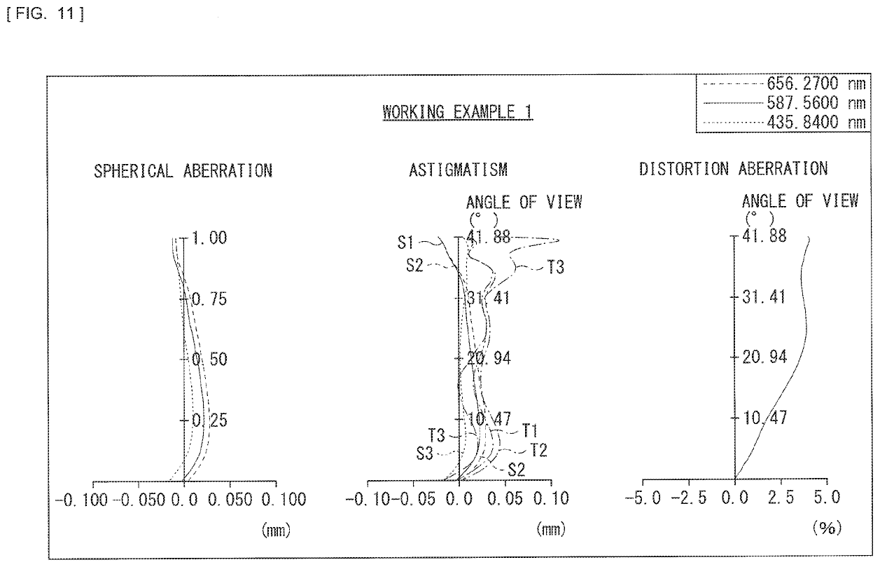

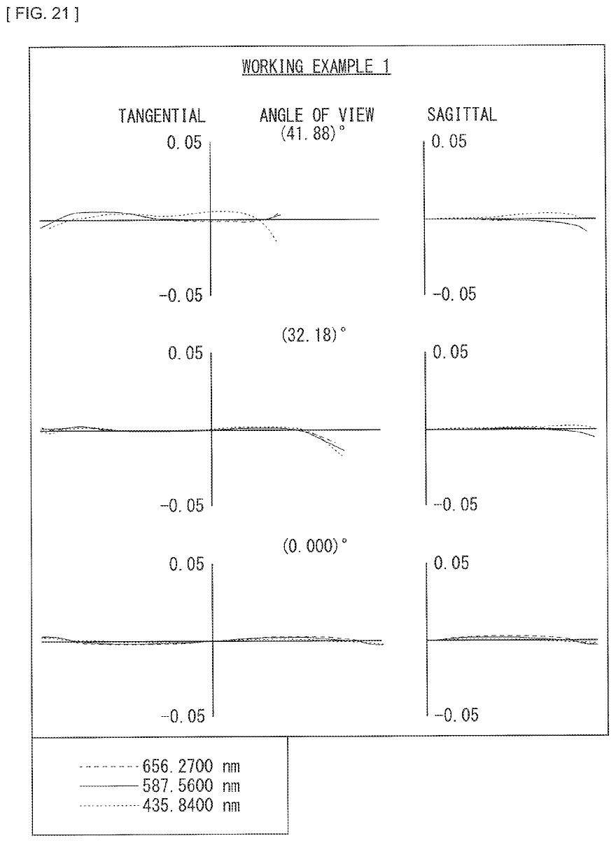

The various aberrations in Numerical Working Example 1 above are illustrated in FIG. 11. In addition, FIG. 21 illustrates lateral aberration. FIG. 11 illustrates, as the various aberrations, spherical aberration, astigmatism (field curvature), and distortion aberration. In each of the aberration diagrams, aberration with the d line (587.56 nm) as a reference wavelength is illustrated. In the spherical aberration diagram, aberration for the g line (435.84 nm) and aberration for the C line (656.27 nm) are also illustrated. In the astigmatism diagram, “S” represents a value on a sagittal image plane, and “T” represents a value on a tangential image plane. The same applies to the aberration diagrams in the subsequent other numeral working examples.

As can be seen from the respective aberration diagrams, it is clear that the imaging lens 1 according to Numerical Working Example 1 has the various aberrations favorably corrected in spite of smallness and a large aperture, and has excellent optical performance. [Numerical Working Example 2]

[Table 6] illustrates basic lens data of Numerical Working Example 2 in which specific numerical values are applied to the imaging lens 2 illustrated in FIG. 2. In the imaging lens 2 according to Numerical Working Example 2, the aperture stop St is disposed between the lens surface of the first lens L1 on the object side and the lens surface of the first lens L1 on the image plane side.

In the imaging lens 2 according to Numerical Working Example 2, both surfaces of each of the first lens L1 to the sixth lens L6 have aspherical shapes. [Table 7] and [Table 8] illustrate the values of coefficients representing these aspherical shapes.

In addition, [Table 9] illustrates the respective values of the focal length f, F-number, overall length, and half angle ω of view of the overall lens system in the imaging lens 2 according to Numerical Working Example 2. [Table 10] illustrates the values of the respective focal lengths of the first lens L1, the second lens L2, the third lens L3, the fourth lens L4, the fifth lens L5, and the sixth lens L6.

TABLE 6
Working Example 2

| Si | Li | Ri | Di | Ndi | ν di |
|---|---|---|---|---|---|
| 1 | | | 0.280 | | |
| 2 | St | ∞ | −0.280 | | |
| 3 | L1R1 | 1.615 | 0.506 | 1.544 | 56.1 |
| 4 | L1R2 | 3.134 | 0.108 | | |
| 5 | L2R1 | 3.623 | 0.312 | 1.544 | 56.1 |
| 6 | L2R2 | −500.000 | 0.031 | | |
| 7 | L3R1 | 7.291 | 0.200 | 1.671 | 19.2 |
| 8 | L3R2 | 3.243 | 0.416 | | |
| 9 | L4R1 | −21.749 | 0.384 | 1.671 | 19.2 |
| 10 | L4R2 | 500.000 | 0.347 | | |
| 11 | L5R1 | 4.386 | 0.404 | 1.616 | 25.8 |
| 12 | L5R2 | 5.552 | 0.336 | | |
| 13 | L6R1 | 2.098 | 0.606 | 1.535 | 55.7 |
| 14 | L6R2 | 1.390 | 0.735 | | |
| 15 | SGR1 | ∞ | 0.110 | 1.517 | 64.2 |
| 16 | SGR2 | ∞ | 0.200 | | |
| 17 | IMG | | | | |

TABLE 7
Working Example 2

| | Si | | | |
|---|---|---|---|---|
| | 3 | 4 | 5 | 6 |
| R | 1.615 | 3.134 | 3.623 | −500.00 |
| K | −2.9641E−0.1 | −2.8230E−01 | −4.7028E−01 | 4.3779E+00 |
| A3 | 0.0000E+00 | 0.0000E+00 | 0.0000E+00 | 0.0000E+00 |
| A4 | −1.2200E−02 | −7.8367E−02 | −7.6456E−02 | −1.0203E−01 |
| A5 | 0.0000E+00 | 0.0000E+00 | 0.0000E+00 | 0.0000E+00 |
| A6 | −1.7547E−02 | −3.1672E−02 | −2.0413E−02 | 2.3563E−01 |
| A7 | 0.0000E+00 | 0.0000E+00 | 0.0000E+00 | 0.0000E+00 |
| A8 | 2.9251E−03 | −5.2941E−02 | 2.8415E−02 | −4.8428E−01 |
| A9 | 0.0000E+00 | 0.0000E+00 | 0.0000E+00 | 0.0000E+00 |
| A10 | −3.1345E−02 | 1.7846E−01 | 1.3344E−01 | 5.3379E−01 |
| A11 | 0.0000E+00 | 0.0000E+00 | 0.0000E+00 | 0.0000E+00 |
| A12 | 1.3653E−02 | −1.1353E−01 | −8.2282E−02 | −2.5970E−01 |
| A13 | 0.0000E+00 | 0.0000E+00 | 0.0000E+00 | 0.0000E+00 |
| A14 | 0.0000E+00 | 2.0437E−02 | 0.0000E+00 | 3.8124E+00 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 7.291 | 3.243 | −21.749 | 500.00 |
| K | −1.0000E+01 | 3.8529E−01 | 1.0000E+01 | 3.9913E+00 |
| A3 | 0.0000E+00 | 0.0000E+00 | −1.4839E−02 | 1.5875E−02 |
| A4 | −6.4575E−02 | −4.8742E−03 | −6.9333E−03 | −1.3572E−01 |
| A5 | 0.0000E+00 | 0.0000E+00 | −1.7706E−01 | 4.2017E−02 |
| A6 | 2.9540E−01 | 1.2880E−01 | 5.2562E−02 | −7.2063E−02 |
| A7 | 0.0000E+00 | 0.0000E+00 | 1.2486E−01 | −2.0708E−02 |
| A8 | −6.3275E−01 | −2.3099E−01 | 3.1327E−02 | 1.9673E−01 |
| A9 | 0.0000E+00 | 0.0000E+00 | −1.0263E−01 | 4.4650E−03 |
| A10 | 6.0265E−01 | 2.5479E−01 | 5.7435E−02 | −2.1013E−01 |
| A11 | 0.0000E+00 | 0.0000E+00 | −1.0639E−02 | 5.0147E−03 |
| A12 | −1.8290E−01 | −1.2768E−01 | −2.4790E−01 | 1.3144E−01 |
| A13 | 0.0000E+00 | 0.0000E+00 | 5.3264E−02 | 7.4909E−04 |
| A14 | −8.9843E−03 | 6.7959E−02 | 2.7670E−01 | −4.4534E−02 |
| A15 | 0.0000E+00 | 0.0000E+00 | −2.4482E−03 | −5.7983E−04 |
| A16 | 2.9074E−04 | 7.9622E−04 | −1.2590E−01 | 5.4334E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 8
Working Example 2

| | Si | | | |
|---|---|---|---|---|
| | 11 | 12 | 13 | 14 |
| R | 4.386 | 5.552 | 2.098 | 1.390 |
| K | −3.9982E+00 | 7.0838E+00 | −5.7282E−01 | −1.3894E+00 |
| A3 | 4.2211E−02 | −3.6075E−02 | −3.3261E−02 | 1.4708E−02 |
| A4 | −4.9847E−02 | −3.5342E−04 | −3.6991E−01 | −4.4504E−01 |
| A5 | 6.7890E−03 | 1.7003E−02 | 1.2074E−01 | 3.1053E−01 |
| A6 | −5.4588E−02 | −3.2707E−02 | 5.0633E−02 | −2.4149E−02 |
| A7 | −3.2642E−02 | 2.1154E−03 | −6.7588E−03 | −5.5320E−02 |
| A8 | 8.0404E−02 | −7.7592E−03 | −1.1363E−02 | 1.6228E−02 |
| A9 | 3.1173E−03 | 1.4265E−03 | 1.2602E−03 | 2.3247E−03 |
| A10 | −6.1458E−02 | 5.5350E−03 | 1.0617E−03 | −3.4612E−04 |
| A11 | 4.7307E−03 | −1.9321E−04 | −4.4125E−05 | −2.3666E−04 |
| A12 | 2.5854E−02 | −1.2957E−03 | −1.1777E−04 | −1.3823E−04 |
| A13 | −1.8325E−03 | −3.5242E−05 | 3.8400E−06 | 3.3729E−05 |
| A14 | −5.8762E−03 | 1.3032E−04 | 7.8787E−06 | 1.1368E−05 |
| A15 | 3.6778E−04 | 1.3830E−06 | 1.1295E−06 | 4.1795E−08 |
| A16 | 5.1999E−04 | −3.3004E−06 | −6.1018E−07 | −6.7828E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 9
Working Example 2

| | |
|---|---|
| f | 4.25 |
| F−number | 2.0 |
| Overall Length | 4.695 |
| ω | 40.6 |

TABLE 10
Working Example 2

| | Focal Length |
|---|---|
| L1 | 5.48 |
| L2 | 6.61 |
| L3 | −8.88 |
| L4 | −31.05 |
| L5 | 29.95 |
| L6 | −10.97 |

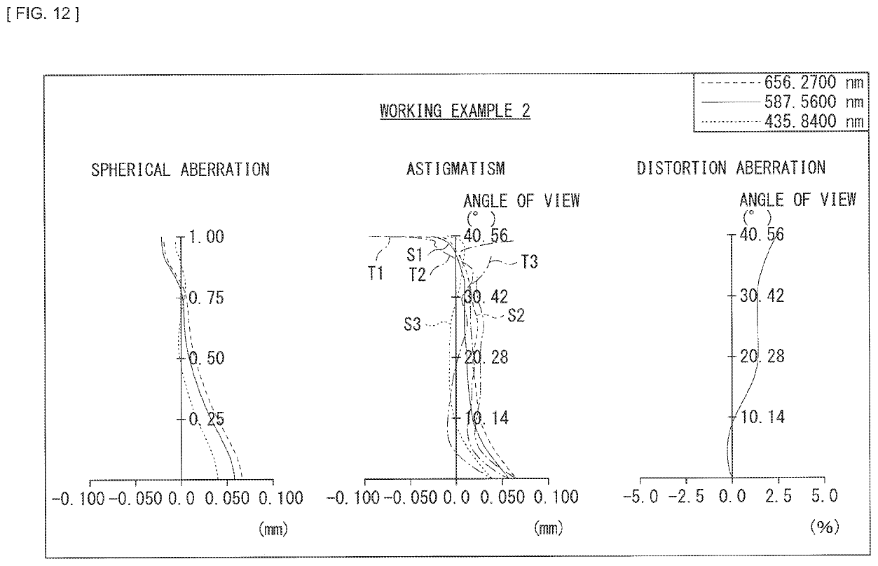

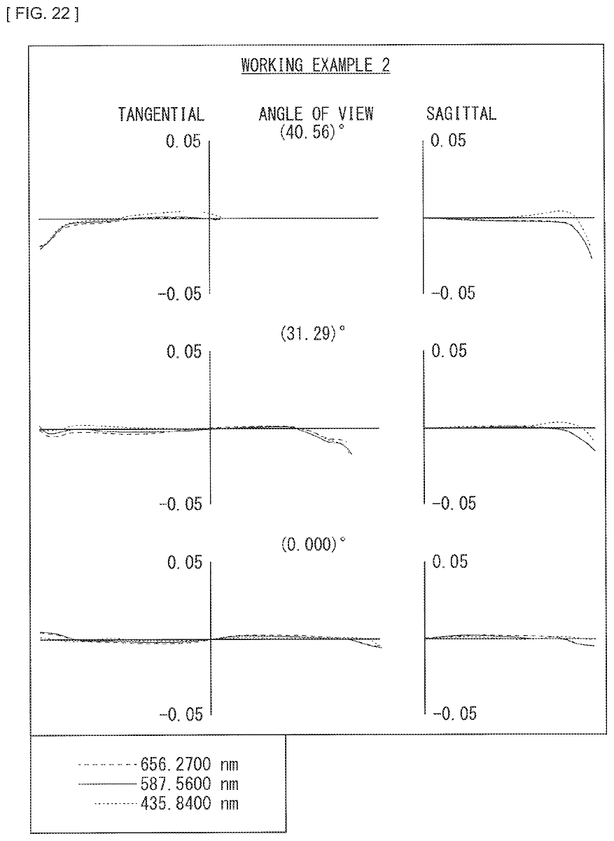

The various aberrations in Numerical Working Example 2 above are illustrated in FIG. 12. In addition, FIG. 22 illustrates lateral aberration.

As can be seen from the respective aberration diagrams, it is clear that the imaging lens 2 according to Numerical Working Example 2 has the various aberrations favorably corrected in spite of smallness and a large aperture, and has excellent optical performance. [Numerical Working Example 3]

[Table 11] illustrates basic lens data of Numerical Working Example 3 in which specific numerical values are applied to the imaging lens 3 illustrated in FIG. 3. In the imaging lens 3 according to Numerical Working Example 3, the aperture stop St is disposed between the lens surface of the first lens L1 on the object side and the lens surface of the first lens L1 on the image plane side.

In the imaging lens 3 according to Numerical Working Example 3, both surfaces of each of the first lens L1 to the sixth lens L6 have aspherical shapes. [Table 12] and [Table 13] illustrate the values of coefficients representing these aspherical shapes.

In addition, [Table 14] illustrates the respective values of the focal length f, F-number, overall length, and half angle ω of view of the overall lens system in the imaging lens 3 according to Numerical Working Example 3. [Table 15] illustrates the values of the respective focal lengths of the first lens L1, the second lens L2, the third lens L3, the fourth lens L4, the fifth lens L5, and the sixth lens L6.

TABLE 11
Working Example 3

| Si | Li | Ri | Di | Ndi | ν di |
|---|---|---|---|---|---|
| 1 | | | 0.120 | | |
| 2 | St | ∞ | −0.120 | | |
| 3 | L1R1 | 2.361 | 0.414 | 1.544 | 56.1 |
| 4 | L1R2 | 3.471 | 0.066 | | |
| 5 | L2R1 | 3.829 | 0.502 | 1.544 | 56.1 |
| 6 | L2R2 | −4.193 | 0.026 | | |
| 7 | L3R1 | 3.533 | 0.242 | 1.671 | 19.2 |
| 8 | L3R2 | 1.980 | 0.367 | | |
| 9 | L4R1 | 100.00 | 0.596 | 1.572 | 33.6 |
| 10 | L4R2 | 6.324 | 0.220 | | |
| 11 | L5R1 | 3.849 | 0.638 | 1.572 | 33.6 |
| 12 | L5R2 | 100.00 | 0.260 | | |
| 13 | L6R1 | 1.801 | 0.600 | 1.535 | 55.7 |
| 14 | L6R2 | 1.190 | 0.738 | | |
| 15 | SGR1 | ∞ | 0.110 | 1.517 | 64.2 |
| 16 | SGR2 | ∞ | 0.200 | | |
| 17 | IMG | | | | |

TABLE 12
Working Example 3

| | Si | | | |
|---|---|---|---|---|
| | 3 | 4 | 5 | 6 |
| R | 2.361 | 3.471 | 3.829 | −4.193 |
| K | −1.8321E+00 | −9.7709E+00 | −9.2586E+00 | −8.7935E−01 |
| A3 | 0.0000E+00 | 0.0000E+00 | 0.0000E+00 | 0.0000E+00 |
| A4 | −3.3516E−02 | −1.2132E−01 | −1.0315E−01 | −1.1433E−01 |
| A5 | 0.0000E+00 | 0.0000E+00 | 0.0000E+00 | 0.0000E+00 |
| A6 | −1.7658E−02 | 3.1523E−02 | 2.7408E−02 | −4.9747E−01 |
| A7 | 0.0000E+00 | 0.0000E+00 | 0.0000E+00 | 0.0000E+00 |
| A8 | −1.7540E−02 | 3.3633E−03 | 5.8267E−02 | −4.9747E−01 |
| A9 | 0.0000E+00 | 0.0000E+00 | 0.0000E+00 | 0.0000E+00 |
| A10 | 2.1471E−02 | 1.6935E−01 | 9.5969E−02 | 5.3156E−01 |
| A11 | 0.0000E+00 | 0.0000E+00 | 0.0000E+00 | 0.0000E+00 |
| A12 | −1.0153E−02 | −1.5583E−01 | −1.1951E−01 | −2.8226E−01 |
| A13 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 3.533 | 1.980 | 100.000 | 6.324 |
| K | −7.2885E+00 | −5.1884E+00 | 1.0000E+01 | 8.8009E+00 |
| A3 | 0.0000E+00 | 0.0000E+00 | −4.6010E−02 | 1.9003E−02 |
| A4 | −1.1621E−01 | −1.7156E−02 | 5.8413E−02 | −1.8653E−01 |
| A5 | 0.0000E+00 | 0.0000E+00 | −1.6896E−01 | 5.4736E−02 |
| A6 | 2.9434E−01 | 1.2732E−01 | 7.0440E−02 | −5.2036E−02 |
| A7 | 0.0000E+00 | 0.0000E+00 | 1.0070E−01 | −1.1365E−02 |
| A8 | −5.4594E−01 | −2.6631E−01 | 1.0635E−02 | 1.9365E−01 |
| A9 | 0.0000E+00 | 0.0000E+00 | −6.3576E−02 | −3.1394E−03 |
| A10 | 5.7002E−01 | 3.2728E−01 | 7.3720E−02 | −2.1583E−01 |
| A11 | 0.0000E+00 | 0.0000E+00 | −1.0142E−02 | 3.0717E−03 |
| A12 | −2.9649E−01 | −2.1897E−01 | −2.6391E−01 | 1.3489E−01 |
| A13 | 0.0000E+00 | 0.0000E+00 | 3.3738E−02 | 6.2117E−04 |
| A14 | 6.6559E−02 | 6.7798E−02 | 2.6516E−01 | −4.4393E−02 |
| A15 | 0.0000E+00 | 0.0000E+00 | 1.2618E−06 | −3.2207E−04 |
| A16 | 4.0386E−04 | 1.3424E−04 | −1.0534E−01 | 5.7811E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 13
Working Example 3

| | Si | | | |
|---|---|---|---|---|
| | 11 | 12 | 13 | 14 |
| R | 3.849 | 100.00 | 1.801 | 1.190 |
| K | −4.0845E+00 | 1.0000E+01 | −5.9721E−01 | −2.9664E+00 |
| A3 | 2.1937E−02 | −5.4726E−02 | −2.1469E−02 | 9.2643E−02 |
| A4 | −2.7933E−02 | 2.7875E−02 | −3.7765E−01 | −4.3469E−01 |
| A5 | −2.5648E−02 | 4.4872E−02 | 1.1772E−01 | 3.0609E−01 |
| A6 | −3.1230E−02 | −3.2960E−02 | 5.0233E−02 | −2.5464E−02 |
| A7 | −2.1382E−02 | −6.2395E−04 | −6.7331E−02 | −5.5490E−02 |
| A8 | 7.9556E−02 | −8.7492E−03 | −1.1325E−02 | 1.6238E−02 |
| A9 | −1.6147E−04 | 1.2152E−03 | 1.2757E−03 | 2.3385E−03 |
| A10 | −6.2857E−02 | 5.5620E−03 | 1.0664E−03 | −3.4050E−04 |
| A11 | 4.2500E−03 | −1.4102E−04 | −4.3122E−05 | −2.3505E−04 |
| A12 | 2.5971E−02 | −1.2619E−03 | −1.1769E−04 | −1.3792E−04 |
| A13 | −1.5820E−03 | −2.1794E−05 | 3.6992E−06 | 3.3723E−05 |
| A14 | −5.7425E−03 | 1.3420E−04 | 7.7547E−06 | 1.1326E−05 |
| A15 | 3.7944E−04 | 1.4541E−06 | 1.0586E−06 | 1.4199E−08 |
| A16 | 4.5381E−04 | −4.5425E−06 | −6.4143E−07 | −6.9105E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 14
Working Example 3

| | |
|---|---|
| f | 3.84 |
| F−number | 2.0 |
| Overall Length | 4.979 |
| ω | 42.8 |

TABLE 15
Working Example 3

| | Focal Length |
|---|---|
| L1 | 12.00 |
| L2 | 3.76 |
| L3 | −7.16 |
| L4 | −11.83 |
| L5 | 6.98 |
| L6 | −9.97 |

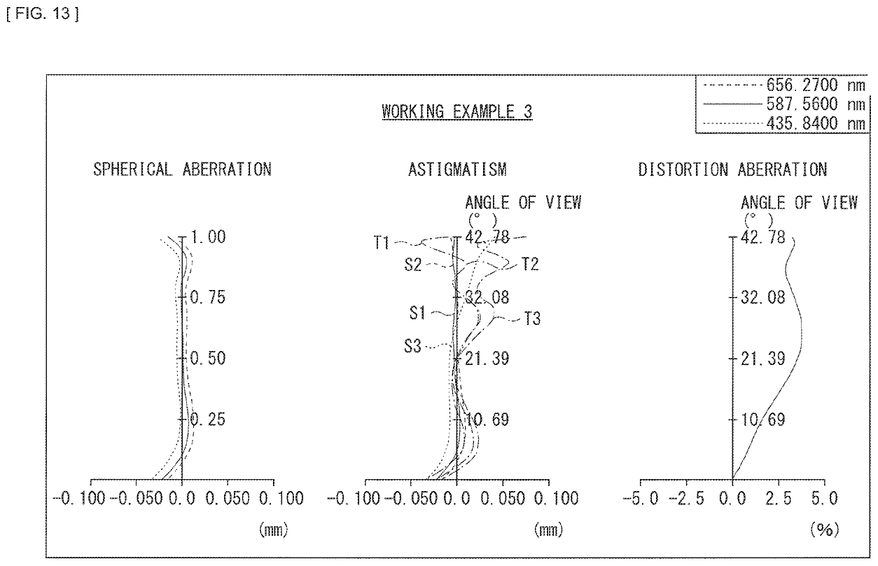

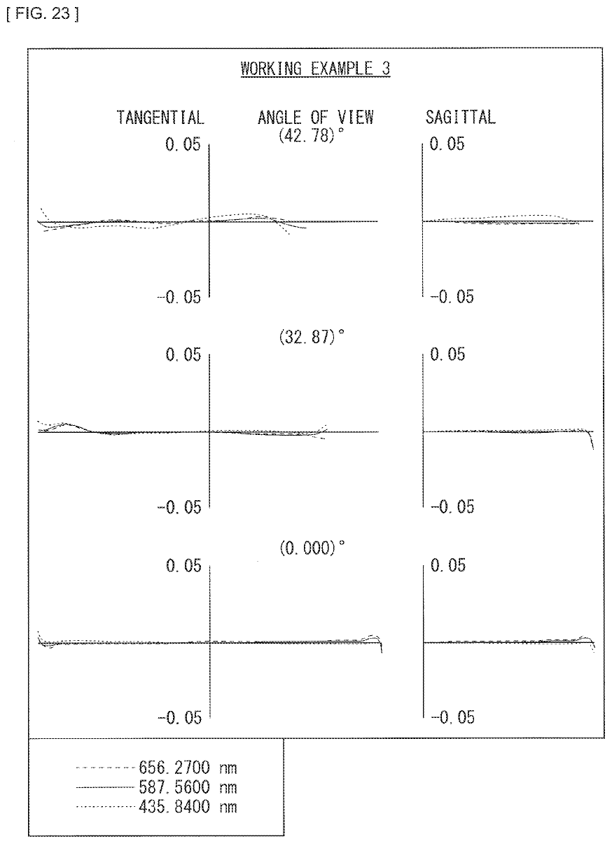

The various aberrations in Numerical Working Example 3 above are illustrated in FIG. 13. In addition, FIG. 23 illustrates lateral aberration.

As can be seen from the respective aberration diagrams, it is clear that the imaging lens 3 according to Numerical Working Example 3 has the various aberrations favorably corrected in spite of smallness and a large aperture, and has excellent optical performance. [Numerical Working Example 4]

[Table 16] illustrates basic lens data of Numerical Working Example 4 in which specific numerical values are applied to the imaging lens 4 illustrated in FIG. 4. In the imaging lens 4 according to Numerical Working Example 4, the aperture stop St is disposed between the lens surface of the first lens L1 on the object side and the lens surface of the first lens L1 on the image plane side.

In the imaging lens 4 according to Numerical Working Example 4, both surfaces of each of the first lens L1 to the sixth lens L6 have aspherical shapes. [Table 17] and [Table 18] illustrate the values of coefficients representing these aspherical shapes.

In addition, [Table 19] illustrates the respective values of the focal length f, F-number, overall length, and half angle ω of view of the overall lens system in the imaging lens 4 according to Numerical Working Example 4. [Table 20] illustrates the values of the respective focal lengths of the first lens L1, the second lens L2, the third lens L3, the fourth lens L4, the fifth lens L5, and the sixth lens L6.

TABLE 16
Working Example 4

| Si | Li | Ri | Di | Ndi | ν di |
|---|---|---|---|---|---|
| 1 | | | 0.250 | | |
| 2 | St | ∞ | −0.250 | | |
| 3 | L1R1 | 1.693 | 0.498 | 1.544 | 56.1 |
| 4 | L1R2 | 3.536 | 0.110 | | |
| 5 | L2R1 | 4.201 | 0.365 | 1.544 | 56.1 |
| 6 | L2R2 | −20.000 | 0.025 | | |
| 7 | L3R1 | 9.499 | 0.200 | 1.680 | 16.3 |
| 8 | L3R2 | 3.597 | 0.401 | | |
| 9 | L4R1 | 28.190 | 0.322 | 1.680 | 16.3 |
| 10 | L4R2 | 10.688 | 0.319 | | |
| 11 | L5R1 | 4.442 | 0.532 | 1.680 | 16.3 |
| 12 | L5R2 | 6.588 | 0.323 | | |
| 13 | L6R1 | 2.005 | 0.670 | 1.536 | 55.7 |
| 14 | L6R2 | 1.307 | 0.625 | | |
| 15 | SGR1 | ∞ | 0.110 | 1.517 | 64.2 |
| 16 | SGR2 | ∞ | 0.200 | | |
| 17 | IMG | | | | |

TABLE 17
Working Example 4

| | Si | | | |
|---|---|---|---|---|
| | 3 | 4 | 5 | 6 |
| R | 1.693 | 3.536 | 4.201 | −20.000 |
| K | −2.8278E−01 | −7.7299E−02 | −1.5504E+00 | −5.7929E+00 |
| A3 | 0.0000E+00 | 0.0000E+00 | 0.0000E+00 | 0.0000E+00 |
| A4 | −1.2332E−02 | −7.7707E−02 | −7.9045E−02 | −1.0107E−01 |
| A5 | 0.0000E+00 | 0.0000E+00 | 0.0000E+00 | 0.0000E+00 |
| A6 | −2.2095E−02 | −3.1315E−02 | −1.9687E−02 | 2.3645E−01 |
| A7 | 0.0000E+00 | 0.0000E+00 | 0.0000E+00 | 0.0000E+00 |
| A8 | 6.5050E−03 | 1.7241E−01 | 2.7557E−02 | −4.8125E−01 |
| A9 | 0.0000E+00 | 0.0000E+00 | 0.0000E+00 | 0.0000E+00 |
| A10 | −2.7847E−02 | 1.7241E−01 | 1.3317E−01 | 5.2451E−01 |
| A11 | 0.0000E+00 | 0.0000E+00 | 0.0000E+00 | 0.0000E+00 |
| A12 | 1.2026E−02 | −1.2743E−02 | −1.0055E−01 | −2.7713E−01 |
| A13 | 0.0000E+00 | 0.0000E+00 | 0.0000E+00 | 0.0000E+00 |
| A14 | 0.0000E+00 | 2.8529E−02 | 0.0000E+00 | 4.5369E−02 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 9.499 | 3.597 | 28.190 | 10.688 |
| K | −3.7049E+00 | 5.5724E−01 | 5.4101E−01 | −1.0000E+01 |
| A3 | 0.0000E+00 | 0.0000E+00 | −5.7254E−02 | −1.7827E−02 |
| A4 | −7.0567E−02 | −1.5565E−02 | 2.6526E−02 | −1.5682E−01 |
| A5 | 0.0000E+00 | 0.0000E+00 | −2.1254E−01 | 5.0987E−02 |
| A6 | 3.1065E−01 | 1.3021E−01 | 6.8219E−02 | −6.2207E−02 |
| A7 | 0.0000E+00 | 0.0000E+00 | 1.3018E−01 | −1.6049E−02 |
| A8 | −6.4721E−01 | −2.5671E−01 | 2.9821E−02 | 1.9598E−01 |
| A9 | 0.0000E+00 | 0.0000E+00 | −6.8967E−02 | 2.6278E−03 |
| A10 | 5.8748E−01 | 2.7941E−01 | 5.3265E−02 | −2.1103E−01 |
| A11 | 0.0000E+00 | 0.0000E+00 | −2.7583E−02 | 4.2018E−03 |
| A12 | −1.8445E−01 | −1.5532E−01 | −2.6495E−01 | 1.3202E−01 |
| A13 | 0.0000E+00 | 0.0000E+00 | 4.3253E−02 | 7.1674E−04 |
| A14 | 1.0275E−02 | 5.8688E−02 | 2.7908E−01 | −4.4511E−02 |
| A15 | 0.0000E+00 | 0.0000E+00 | 5.9024E−03 | −5.1947E−04 |
| A16 | −3.7267E−03 | 1.1170E−02 | −1.1824E−01 | 5.4907E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 18
Working Example 4

| | Si | | | |
|---|---|---|---|---|
| | 11 | 12 | 13 | 14 |
| R | 4.442 | 6.588 | 2.005 | 1.307 |
| K | −6.0743E+00 | 7.0387E+00 | −5.8754E−01 | −1.4016E+00 |
| A3 | 6.5235E−03 | −9.3805E−03 | −2.8814E−02 | 1.7700E−02 |
| A4 | −1.1242E−02 | −4.5151E−02 | −3.6878E−01 | −4.4346E−01 |
| A5 | −3.0899E−02 | 2.2028E−02 | 1.1944E−01 | 3.1145E−01 |
| A6 | −5.4534E−02 | −2.1612E−02 | 5.0306E−02 | −2.4360E−02 |
| A7 | −2.6999E−02 | 5.5485E−03 | −6.7947E−03 | −5.5443E−02 |
| A8 | 8.3780E−02 | −8.1941E−03 | −1.1358E−02 | 1.6204E−02 |
| A9 | 5.2433E−03 | 6.1348E−04 | 1.2654E−03 | 2.3271E−03 |
| A10 | −6.0734E−02 | 5.1649E−03 | 1.9639E−03 | −3.4211E−04 |
| A11 | 4.3232E−03 | −2.2737E−04 | −4.3401E−05 | −2.3482E−04 |
| A12 | 2.4977E−02 | −1.2044E−03 | −1.1755E−04 | −1.3763E−04 |
| A13 | −1.8349E−03 | −2.9777E−05 | 3.8407E−06 | 3.3835E−05 |
| A14 | −5.8629E−03 | 1.3218E−04 | 7.8289E−06 | 1.1345E−05 |
| A15 | 3.7467E−04 | 1.9676E−06 | 1.0877E−06 | 7.2328E−09 |
| A16 | 5.3144E−04 | −3.3867E−06 | −6.3230E−07 | −7.0014E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 19
Working Example 4

| | |
|---|---|
| f | 3.90 |
| F−number | 1.9 |
| Overall Length | 4.700 |
| ω | 42.1 |

TABLE 20
Working Example 4

| | Focal Length |
|---|---|
| L1 | 5.45 |
| L2 | 6.42 |
| L3 | −8.63 |
| L4 | −25.51 |
| L5 | 18.22 |
| L6 | −10.55 |

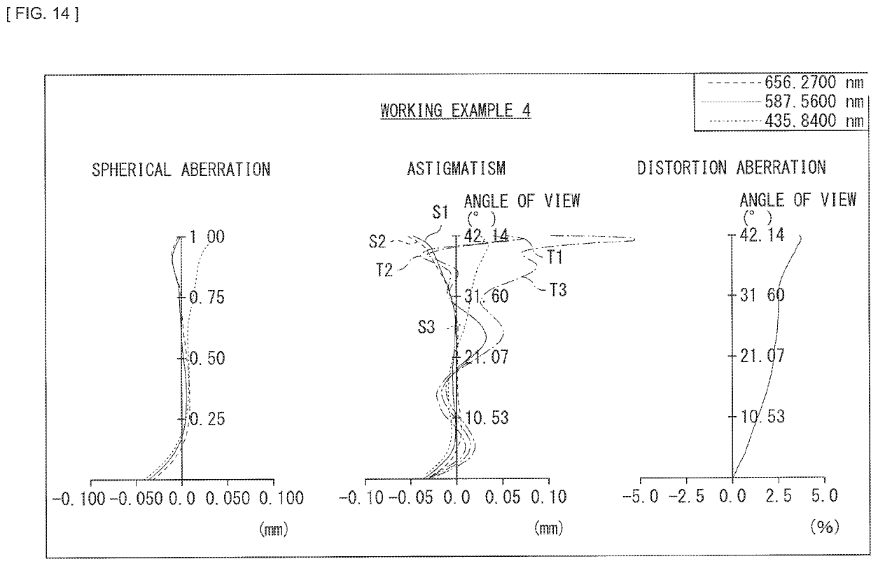

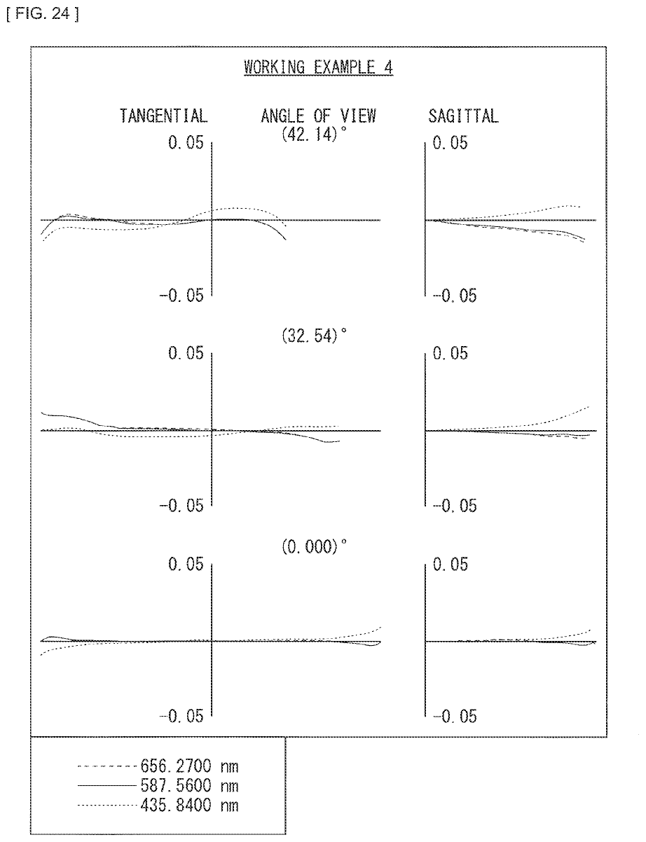

The various aberrations in Numerical Working Example 4 above are illustrated in FIG. 14. In addition, FIG. 24 illustrates lateral aberration.

As can be seen from the respective aberration diagrams, it is clear that the imaging lens 4 according to Numerical Working Example 4 has the various aberrations favorably corrected in spite of smallness and a large aperture, and has excellent optical performance. [Numerical Working Example 5]

[Table 21] illustrates basic lens data of Numerical Working Example 5 in which specific numerical values are applied to the imaging lens 5 illustrated in FIG. 5. In the imaging lens 5 according to Numerical Working Example 5, the aperture stop St is disposed between the lens surface of the first lens L1 on the object side and the lens surface of the first lens L1 on the image plane side.

In the imaging lens 5 according to Numerical Working Example 5, both surfaces of each of the first lens L1 to the sixth lens L6 have aspherical shapes. [Table 22] and [Table 23] illustrate the values of coefficients representing these aspherical shapes.

In addition, [Table 24] illustrates the respective values of the focal length f, F-number, overall length, and half angle ω of view of the overall lens system in the imaging lens 5 according to Numerical Working Example 5. [Table 25] illustrates the values of the respective focal lengths of the first lens L1, the second lens L2, the third lens L3, the fourth lens L4, the fifth lens L5, and the sixth lens L6.

TABLE 21
Working Example 5

| Si | Li | Ri | Di | Ndi | ν di |
|---|---|---|---|---|---|
| 1 | | | 0.250 | | |
| 2 | St | ∞ | −0.250 | | |
| 3 | L1R1 | 1.735 | 0.697 | 1.544 | 56.1 |
| 4 | L1R2 | −24.616 | 0.025 | | |
| 5 | L2R1 | −9.302 | 0.365 | 1.544 | 56.1 |
| 6 | L2R2 | −9.273 | 0.023 | | |
| 7 | L3R1 | 144.888 | 0.150 | 1.671 | 19.2 |
| 8 | L3R2 | 6.164 | 0.405 | | |
| 9 | L4R1 | −34.956 | 0.440 | 1.671 | 19.2 |
| 10 | L4R2 | 14.565 | 0.244 | | |
| 11 | L5R1 | 4.258 | 0.561 | 1.616 | 25.8 |
| 12 | L5R2 | 6.228 | 0.323 | | |
| 13 | L6R1 | 2.092 | 0.681 | 1.535 | 55.7 |
| 14 | L6R2 | 1.301 | 0.539 | | |
| 15 | SGR1 | ∞ | 0.110 | 1.517 | 64.2 |
| 16 | SGR2 | ∞ | 0.200 | | |
| 17 | IMG | | | | |

TABLE 22
Working Example 5

| | Si | | | |
|---|---|---|---|---|
| | 3 | 4 | 5 | 6 |
| R | 1.735 | −24.616 | −9.302 | −9.273 |
| K | −2.4064E−01 | −1.0000E+01 | −1.0000E+01 | −1.0000E+01 |
| A3 | 0.0000E+00 | 0.0000E+00 | 0.0000E+00 | 0.0000E+00 |
| A4 | −1.2375E−02 | −4.4960E−02 | 2.6000E−04 | −7.8270E−02 |
| A5 | 0.0000E+00 | 0.0000E+00 | 0.0000E+00 | 0.0000E+00 |
| A6 | −1.4810E−02 | 7.9200E−03 | 1.3420E−02 | 2.1863E−01 |
| A7 | 0.0000E+00 | 0.0000E+00 | 0.0000E+00 | 0.0000E+00 |
| A8 | 3.7100E−03 | −1.6310E−02 | 2.3710E−02 | −4.9539E−01 |
| A9 | 0.0000E+00 | 0.0000E+00 | 0.0000E+00 | 0.0000E+00 |
| A10 | −3.2670E−02 | 1.7557E−01 | 1.2572E−01 | 5.4346E−01 |
| A11 | 0.0000E+00 | 0.0000E+00 | 0.0000E+00 | 0.0000E+00 |
| A12 | 1.3300E−02 | −1.3508E−01 | −8.2940E−02 | −2.5144E−01 |
| A13 | 0.0000E+00 | 0.0000E+00 | 0.0000E+00 | 0.0000E+00 |
| A14 | 0.0000E+00 | 2.0120E−02 | 0.0000E+00 | 3.6680E−02 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 144.888 | 6.164 | −34.956 | 14.565 |
| K | 1.0000E+01 | 6.6383E+00 | 3.1777E+00 | 1.0000E+01 |
| A3 | 0.0000E+00 | 0.0000E+00 | −2.8750E−02 | 3.0810E−02 |
| A4 | −6.8450E−02 | 1.1600E−02 | 2.2300E−02 | −1.5574E−01 |
| A5 | 0.0000E+00 | 0.0000E+00 | −1.9573E−01 | 4.0800E−02 |
| A6 | 3.1874E−01 | 1.6653E−01 | 7.2300E−02 | −6.3170E−02 |
| A7 | 0.0000E+00 | 0.0000E+00 | 1.1306E−01 | −1.6700E−02 |
| A8 | −6.0375E−01 | −2.4013E−01 | 5.9400E−03 | 1.9237E−01 |
| A9 | 0.0000E+00 | 0.0000E+00 | −8.3390E−02 | −2.9700E−03 |
| A10 | 5.9895E−01 | 2.5738E−01 | 5.2230E−02 | −2.1542E−01 |
| A11 | 0.0000E+00 | 0.0000E+00 | −1.7140E−02 | 3.5300E−03 |
| A12 | −2.0518E−01 | −1.5228E−01 | −2.5174E−01 | 1.3525E−01 |
| A13 | 0.0000E+00 | 0.0000E+00 | 5.7450E−02 | 1.0100E−03 |
| A14 | −2.6200E−03 | 6.7950E−02 | 2.8589E−01 | −4.4190E−02 |
| A15 | 0.0000E+00 | 0.0000E+00 | 2.0000E−03 | −3.2000E−04 |
| A16 | 2.9000E−04 | 7.9000E−04 | −1.3634E−01 | 5.5500E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 23
Working Example 5

| | Si | | | |
|---|---|---|---|---|
| | 11 | 12 | 13 | 14 |
| R | 4.258 | 6.228 | 2.092 | 1.301 |
| K | −3.9468E−01 | 7.4121E+00 | −5.3128E−01 | −1.3107E+00 |
| A3 | 1.2186E−02 | −5.9719E−02 | −3.1227E−02 | 1.5632E−02 |
| A4 | −1.8114E−02 | 2.3955E−03 | −3.6949E−01 | −4.4151E−01 |
| A5 | −1.6795E−02 | 3.5721E−02 | 1.1942E−01 | 3.1176E−01 |
| A6 | −4.9335E−02 | −3.1003E−02 | 5.0379E−02 | −2.4429E−02 |
| A7 | −2.7543E−02 | 5.5978E−04 | −6.7577E−03 | −5.5505E−02 |
| A8 | 8.0665E−02 | −8.5183E−03 | −1.1343E−02 | 1.6176E−02 |
| A9 | 2.6115E−03 | 1.2711E−03 | 1.2686E−03 | 2.3183E−03 |
| A10 | −6.1925E−02 | 5.5525E−03 | 1.0639E−03 | −3.4430E−04 |
| A11 | 4.4190E−03 | −1.6019E−04 | −4.3743E−05 | −2.3511E−04 |
| A12 | 2.5794E−02 | −1.2745E−03 | −1.1772E−04 | −1.3763E−04 |
| A13 | −1.8403E−03 | −2.8194E−05 | 3.7978E−06 | 3.3866E−05 |
| A14 | −5.8525E−03 | 1.3225E−04 | 7.8420E−06 | 1.1365E−05 |
| A15 | 3.7790E−04 | 1.5790E−06 | 1.0730E−06 | 1.6581E−08 |
| A16 | 5.2940E−04 | −3.7923E−06 | −6.3148E−07 | −6.9640E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 24
Working Example 5

| | |
|---|---|
| f | 3.95 |
| F-number | 1.9 |
| Overall Length | 4.763 |
| ω | 42.1 |

TABLE 25
Working Example 5

| | Focal Length |
|---|---|
| L1 | 3.007 |
| L2 | 1006.094 |
| L3 | −9.599 |
| L4 | −15.268 |
| L5 | 19.713 |
| L6 | −9.189 |

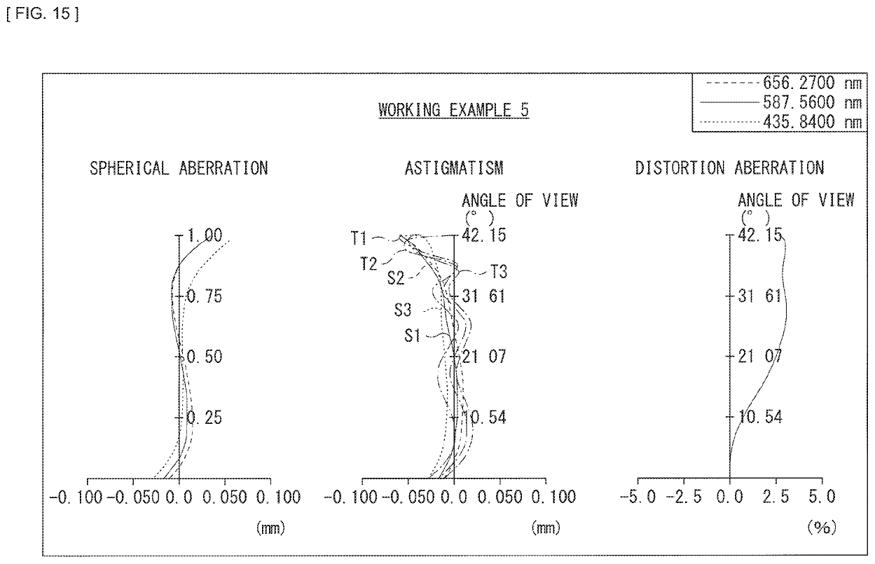

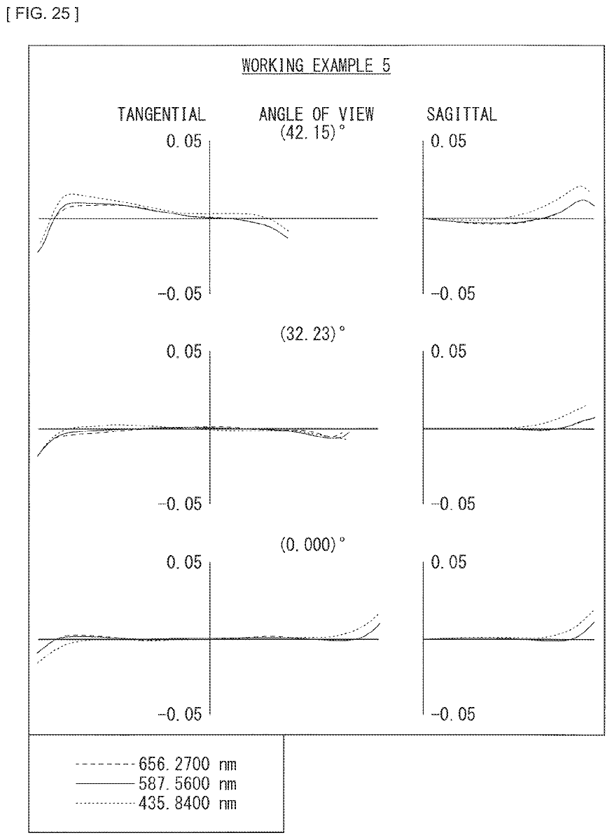

The various aberrations in Numerical Working Example 5 above are illustrated in FIG. 15. In addition, FIG. 25 illustrates lateral aberration.

As can be seen from the respective aberration diagrams, it is clear that the imaging lens 5 according to Numerical Working Example 5 has the various aberrations favorably corrected in spite of smallness and a large aperture, and has excellent optical performance. [Numerical Working Example 6]

[Table 26] illustrates basic lens data of Numerical Working Example 6 in which specific numerical values are applied to the imaging lens 6 illustrated in FIG. 6. In the imaging lens 6 according to Numerical Working Example 6, the aperture stop St is disposed between the lens surface of the first lens L1 on the object side and the lens surface of the first lens L1 on the image plane side.

In the imaging lens 6 according to Numerical Working Example 6, both surfaces of each of the first lens L1 to the sixth lens L6 have aspherical shapes. [Table 27] and [Table 28] illustrate the values of coefficients representing these aspherical shapes.

In addition, [Table 29] illustrates the respective values of the focal length f, F-number, overall length, and half angle ω of view of the overall lens system in the imaging lens 6 according to Numerical Working Example 6. [Table 30] illustrates the values of the respective focal lengths of the first lens L1, the second lens L2, the third lens L3, the fourth lens L4, the fifth lens L5, and the sixth lens L6.

TABLE 26
Working Example 6

| Si | Li | Ri | Di | Ndi | ν di |
|---|---|---|---|---|---|
| 1 | | | 0.120 | | |
| 2 | St | ∞ | −0.120 | | |
| 3 | L1R1 | 2.248 | 0.450 | 1.544 | 56.1 |
| 4 | L1R2 | 2.620 | 0.060 | | |
| 5 | L2R1 | 2.301 | 0.415 | 1.544 | 56.1 |
| 6 | L2R2 | −19.578 | 0.045 | | |
| 7 | L3R1 | 3.727 | 0.202 | 1.671 | 19.2 |
| 8 | L3R2 | 2.341 | 0.340 | | |
| 9 | L4R1 | 68.698 | 0.619 | 1.572 | 33.6 |
| 10 | L4R2 | 13.481 | 0.212 | | |
| 11 | L5R1 | 2.580 | 0.522 | 1.572 | 33.6 |
| 12 | L5R2 | 3.508 | 0.390 | | |
| 13 | L6R1 | 1.802 | 0.667 | 1.535 | 55.7 |
| 14 | L6R2 | 1.247 | 0.575 | | |
| 15 | SGR1 | ∞ | 0.110 | 1.517 | 64.2 |
| 16 | SGR2 | ∞ | 0.200 | | |
| 17 | IMG | | | | |

TABLE 27
Working Example 6

| | Si | | | |
|---|---|---|---|---|
| | 3 | 4 | 5 | 6 |
| R | 2.248 | 2.620 | 2.301 | −19.578 |
| K | −2.1257E+00 | −6.9001E+00 | −4.3227E+00 | −5.6023E+00 |
| A3 | 0.0000E+00 | 0.0000E+00 | 0.0000E+00 | 0.0000E+00 |
| A4 | −3.3500E−02 | −1.5834E−01 | −9.6901E−02 | −1.1783E−01 |
| A5 | 0.0000E+00 | 0.0000E+00 | 0.0000E+00 | 0.0000E+00 |
| A6 | −8.6300E−03 | 1.8657E−02 | 6.0811E−03 | 2.3216E−01 |
| A7 | 0.0000E+00 | 0.0000E+00 | 0.0000E+00 | 0.0000E+00 |
| A8 | −3.3176E−02 | 4.0206E−03 | 3.4386E−02 | −4.8314E−01 |
| A9 | 0.0000E+00 | 0.0000E+00 | 0.0000E+00 | 0.0000E+00 |
| A10 | 2.4645E−02 | 1.2355E−01 | 1.0730E−01 | 5.3722E−01 |
| A11 | 0.0000E+00 | 0.0000E+00 | 0.0000E+00 | 0.0000E+00 |
| A12 | −4.5303E−03 | −1.0794E−01 | −1.0876E−01 | −2.9224E−01 |
| A13 | 0.0000E+00 | 0.0000E+00 | 0.0000E+00 | 0.0000E+00 |
| A14 | 0.0000E+00 | 1.3948E−02 | 0.0000E+00 | 4.8758E−02 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 3.727 | 2.341 | 68.698 | 13.481 |
| K | −1.0000E+01 | −6.7371E+00 | −1.0000E+01 | 1.0000E+01 |
| A3 | 0.0000E+00 | 0.0000E+00 | −3.6686E−02 | 3.7088E−02 |
| A4 | −1.2656E−01 | −1.0356E−02 | 6.4130E−02 | −1.6296E−01 |
| A5 | 0.0000E+00 | 0.0000E+00 | −1.4376E−01 | 4.6391E−02 |
| A6 | 2.9884E−01 | 1.3782E−01 | 4.7670E−02 | −5.6272E−02 |
| A7 | 0.0000E+00 | 0.0000E+00 | 6.7360E−02 | −1.1438E−02 |
| A8 | −5.4247E−01 | −2.7111E−01 | 3.0769E−03 | 1.9443E−01 |
| A9 | 0.0000E+00 | 0.0000E+00 | −4.6754E−02 | −2.8583E−03 |
| A10 | 5.6761E−01 | 3.2223E−01 | 9.5162E−02 | −2.1565E−01 |
| A11 | 0.0000E+00 | 0.0000E+00 | 6.2494E−04 | 3.0959E−03 |
| A12 | −2.9048E−01 | −2.0447E−01 | −2.6728E−01 | 1.3480E−01 |
| A13 | 0.0000E+00 | 0.0000E+00 | 2.0579E−02 | 5.7368E−04 |
| A14 | 6.6559E−02 | 6.7798E−02 | 2.5140E−01 | −4.4447E−02 |
| A15 | 0.0000E+00 | 0.0000E+00 | −4.1542E−03 | −3.3437E−04 |
| A16 | 4.0386E−04 | 1.3424E−04 | −9.1191E−02 | 5.8077E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 28
Working Example 6

| | Si | | | |
|---|---|---|---|---|
| | 11 | 12 | 13 | 14 |
| R | 2.580 | 3.508 | 1.802 | 1.247 |
| K | −3.4680E+00 | −2.6415E−01 | −5.9967E−01 | −2.6724E+00 |
| A3 | 1.9397E−02 | −5.6963E−02 | −1.6568E−02 | 6.8518E−02 |
| A4 | −3.1879E−02 | −2.7258E−03 | −3.8123E−01 | −4.2206E−01 |
| A5 | −2.6222E−02 | 4.2333E−02 | 1.1742E−01 | 3.0442E−01 |
| A6 | −2.9357E−02 | −3.1628E−02 | 5.0364E−02 | −2.6301E−02 |
| A7 | −1.9679E−02 | 1.4012E−04 | −6.6559E−03 | −5.5597E−02 |
| A8 | 7.8681E−02 | −8.5769E−03 | −1.1300E−02 | 1.6258E−02 |
| A9 | −9.2037E−04 | 1.2203E−03 | 1.2815E−03 | 2.3551E−03 |
| A10 | −6.3446E−02 | 5.5427E−03 | 1.0669E−03 | −3.3464E−04 |
| A11 | 4.2336E−03 | −1.4998E−04 | −4.3552E−05 | −2.3363E−04 |
| A12 | 2.6026E−02 | −1.2637E−03 | −1.1802E−04 | −1.3771E−04 |
| A13 | −1.4786E−03 | −2.1454E−05 | 3.5460E−06 | 3.3710E−05 |
| A14 | −5.7202E−03 | 1.3462E−04 | 7.7099E−06 | 1.1300E−05 |
| A15 | 3.8491E−04 | 1.7010E−06 | 1.0592E−06 | 2.1985E−09 |
| A16 | 4.4795E−04 | −4.4972E−06 | −6.3048E−07 | −6.9451E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 29
Working Example 6

| | |
|---|---|
| f | 3.76 |
| F-number | 2.0 |
| Overall Length | 4.807 |
| ω | 43.6 |

TABLE 30
Working Example 6

| | Focal Length |
|---|---|
| L1 | 20.41 |
| L2 | 3.81 |
| L3 | −9.96 |
| L4 | −29.44 |
| L5 | 14.15 |
| L6 | −13.02 |

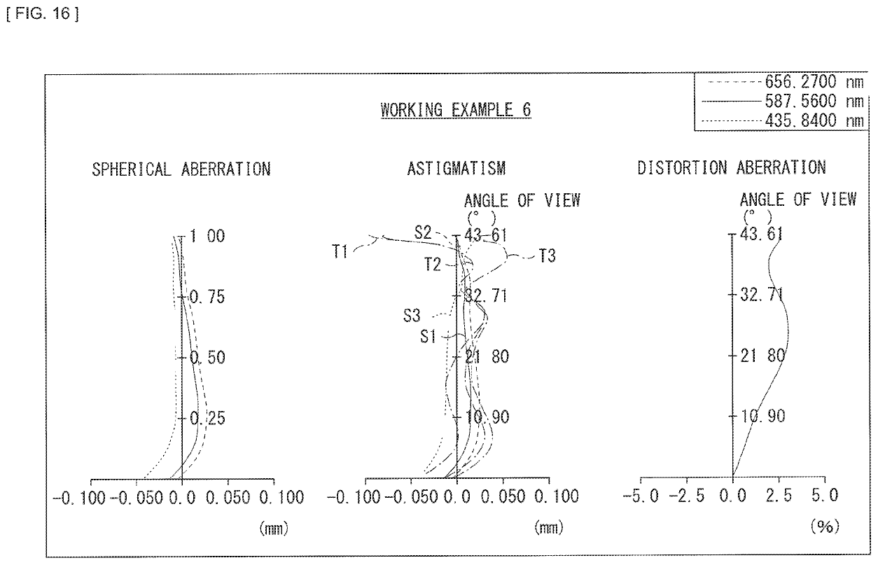

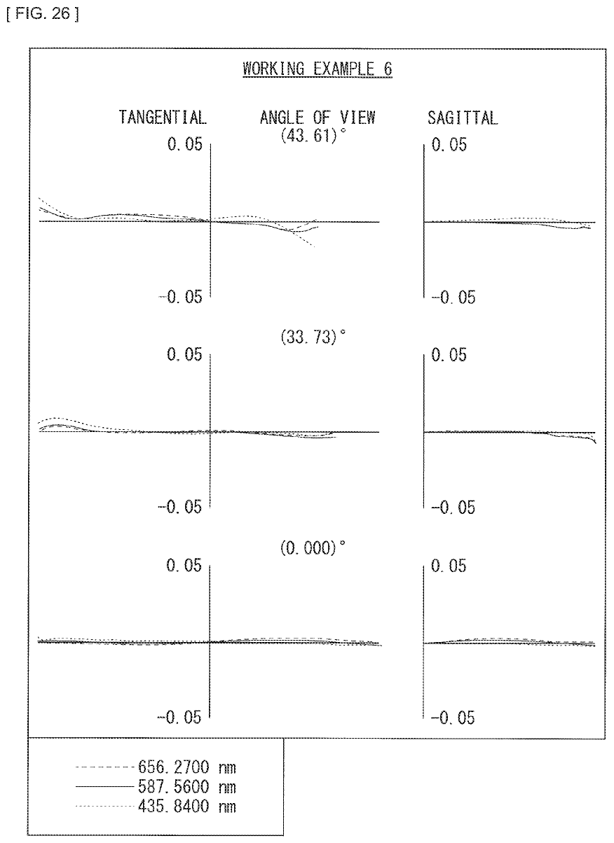

The various aberrations in Numerical Working Example 6 above are illustrated in FIG. 16. In addition, FIG. 26 illustrates lateral aberration.

As can be seen from the respective aberration diagrams, it is clear that the imaging lens 6 according to Numerical Working Example 6 has the various aberrations favorably corrected in spite of smallness and a large aperture, and has excellent optical performance. [Numerical Working Example 7]

[Table 31] illustrates basic lens data of Numerical Working Example 7 in which specific numerical values are applied to the imaging lens 7 illustrated in FIG. 7. In the imaging lens 7 according to Numerical Working Example 7, the aperture stop St is disposed between the lens surface of the first lens L1 on the image plane side and the lens surface of the second lens L2 on the image plane side.

In the imaging lens 7 according to Numerical Working Example 7, both surfaces of each of the first lens L1 to the sixth lens L6 have aspherical shapes. [Table 32] and [Table 33] illustrate the values of coefficients representing these aspherical shapes.

In addition, [Table 34] illustrates the respective values of the focal length f, F-number, overall length, and half angle ω of view of the overall lens system in the imaging lens 7 according to Numerical Working Example 7. [Table 35] illustrates the values of the respective focal lengths of the first lens L1, the second lens L2, the third lens L3, the fourth lens L4, the fifth lens L5, and the sixth lens L6.

TABLE 31
Working Example 7

| Si | Li | Ri | Di | Ndi | ν di |
|---|---|---|---|---|---|
| 1 | L1R1 | 2.128 | 0.400 | 1.544 | 56.1 |
| 2 | L1R2 | 2.110 | 0.110 | | |
| 3 | | | 0.280 | | |
| 4 | St | ∞ | −0.280 | | |
| 5 | L2R1 | 1.697 | 0.612 | 1.544 | 56.1 |
| 6 | L2R2 | −17.598 | 0.03 | | |
| 7 | L3R1 | 5.679 | 0.250 | 1.661 | 20.4 |
| 8 | L3R2 | 2.346 | 0.465 | | |
| 9 | L4R1 | 29.828 | 0.345 | 1.661 | 20.4 |
| 10 | L4R2 | 19.528 | 0.315 | | |
| 11 | L5R1 | 7.879 | 0.650 | 1.635 | 24.0 |
| 12 | L5R2 | 7.719 | 0.180 | | |
| 13 | L6R1 | 2.409 | 0.797 | 1.535 | 55.7 |
| 14 | L6R2 | 1.772 | 0.594 | | |
| 15 | SGR1 | ∞ | 0.110 | 1.517 | 64.2 |
| 16 | SGR2 | ∞ | 0.200 | | |
| 17 | IMG | | | | |

TABLE 32
Working Example 7

| | Si | | | |
|---|---|---|---|---|
| | 1 | 2 | 5 | 6 |
| R | 2.128 | 2.110 | 1.697 | −17.598 |
| K | −1.4905E+00 | 0.0000E+00 | −6.9811E−01 | 1.0000E+01 |
| A3 | 0.0000E+00 | 0.0000E+00 | 0.0000E+00 | 0.0000E+00 |
| A4 | −3.0860E−02 | −7.9255E−02 | 1.9474E−02 | 3.5337E−02 |
| A5 | 0.0000E+00 | 0.0000E+00 | 0.0000E+00 | 0.0000E+00 |
| A6 | −2.7810E−02 | −2.1610E−01 | −1.4771E−01 | −9.9243E−02 |
| A7 | 0.0000E+00 | 0.0000E+00 | 0.0000E+00 | 0.0000E+00 |
| A8 | −1.6712E−02 | 2.5180E−01 | 1.9372E−01 | 3.3100E−01 |
| A9 | 0.0000E+00 | 0.0000E+00 | 0.0000E+00 | 0.0000E+00 |
| A10 | 1.8000E−02 | −1.2281E−01 | −7.0713E−02 | −4.9267E−01 |
| A11 | 0.0000E+00 | 0.0000E+00 | 0.0000E+00 | 0.0000E+00 |
| A12 | −4.3700E−03 | 2.2312E−02 | 1.3007E−02 | 4.7617E−01 |
| A13 | 0.0000E+00 | 0.0000E+00 | 0.0000E+00 | 0.0000E+00 |
| A14 | 0.0000E+00 | 0.0000E+00 | 0.0000E+00 | −1.9709E−01 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 5.679 | 2.346 | 29.828 | 19.528 |
| K | 1.0000E+01 | −1.0000E+01 | 1.0000E+01 | 1.0000E+01 |
| A3 | 0.0000E+00 | 0.0000E+00 | −1.2772E−02 | 8.5341E−03 |
| A4 | −5.0363E−02 | 5.6790E−02 | −1.4975E−02 | −6.1420E−02 |
| A5 | 0.0000E+00 | 0.0000E+00 | −5.1218E−02 | 1.7065E−02 |
| A6 | −9.3371E−02 | −2.4842E−02 | −8.2216E−02 | −1.2804E−01 |
| A7 | 0.0000E+00 | 0.0000E+00 | 2.6854E−02 | 9.6752E−05 |
| A8 | 5.0884E−01 | 7.6636E−02 | 3.0151E−01 | 2.3427E−01 |
| A9 | 0.0000E+00 | 0.0000E+00 | −5.9159E−03 | 1.3122E−03 |
| A10 | −8.8497E−01 | 8.0129E−02 | −4.7314E−01 | −2.3202E−01 |
| A11 | 0.0000E+00 | 0.0000E+00 | −7.7844E−03 | −3.6018E−04 |
| A12 | 8.2108E−01 | −3.2795E−01 | 4.1289E−01 | 1.4142E−01 |
| A13 | 0.0000E+00 | 0.0000E+00 | 3.4711E−03 | −5.3456E−04 |
| A14 | −3.6692E−01 | 2.9553E−01 | −1.9096E−01 | −4.7217E−02 |
| A15 | 0.0000E+00 | 0.0000E+00 | 2.4501E−03 | −3.6502E−05 |
| A16 | 3.3616E−02 | −8.5401E−02 | 3.2005E−02 | 6.5573E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 33
Working Example 7

| | Si | | | |
|---|---|---|---|---|
| | 11 | 12 | 13 | 14 |
| R | 7.879 | 7.719 | 2.409 | 1.772 |
| K | 7.1614E+00 | 9.9930E+00 | −6.7681E−01 | −1.2333E+00 |
| A3 | −6.3032E−03 | −1.2990E−02 | 2.2137E−02 | 8.4199E−02 |
| A4 | 6.4164E−02 | −1.5862E−02 | −3.1994E−01 | −3.7581E−01 |
| A5 | −7.9591E−03 | −3.0884E−03 | 9.4331E−02 | 2.3228E−01 |
| A6 | −1.4528E−01 | 9.6244E−03 | 4.4706E−02 | −2.9895E−02 |
| A7 | −7.0860E−05 | 4.3900E−04 | −6.3610E−03 | −2.7370E−02 |
| A8 | 1.2529E−01 | −1.3386E−02 | −1.1030E−02 | 1.0308E−02 |
| A9 | −4.4539E−04 | −9.7777E−05 | 1.6253E−03 | −1.4129E−04 |
| A10 | −7.6217E−02 | 5.9567E−03 | 1.1755E−03 | −2.2937E−04 |
| A11 | 2.1202E−04 | −8.2984E−06 | −5.0562E−05 | 5.8515E−05 |
| A12 | 2.8510E−02 | −1.3202E−03 | −1.3625E−04 | −5.8003E−05 |
| A13 | 5.5097E−05 | 3.2998E−06 | 2.9887E−08 | 3.6808E−06 |
| A14 | −5.7906E−03 | 1.4673E−04 | 7.4015E−06 | 5.0428E−06 |
| A15 | −1.8341E−05 | 2.0480E−08 | 1.2966E−06 | −2.5662E−07 |
| A16 | 4.9632E−04 | −6.5991E−06 | −4.7480E−07 | −1.5340E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 34
Working Example 7

| | |
|---|---|
| f | 4.06 |
| F-number | 1.9 |
| Overall Length | 5.058 |
| ω | 41.1 |

Working Example 7

| | Focal Length |
|---|---|
| L1 | 67.14 |
| L2 | 2.88 |
| L3 | −6.23 |
| L4 | −86.71 |
| L5 | 1036.02 |
| L6 | −22.21 |

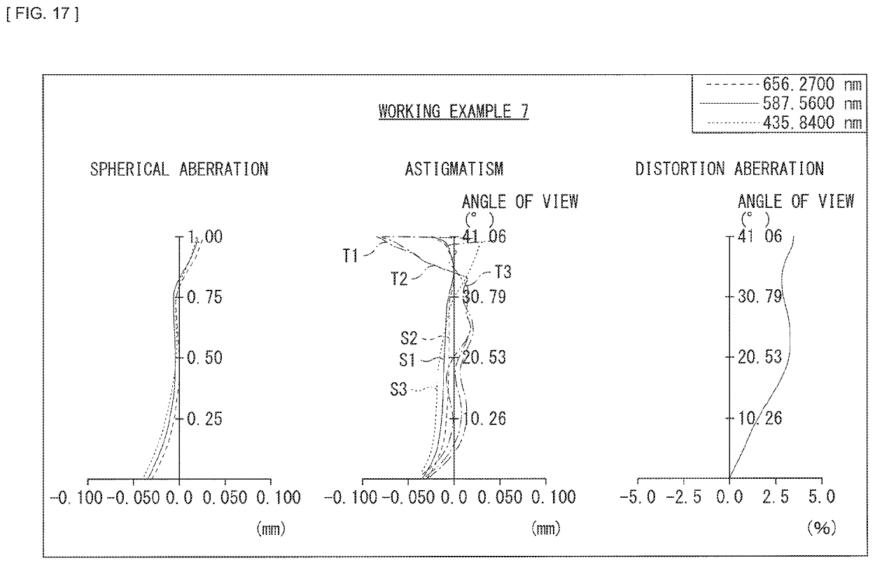

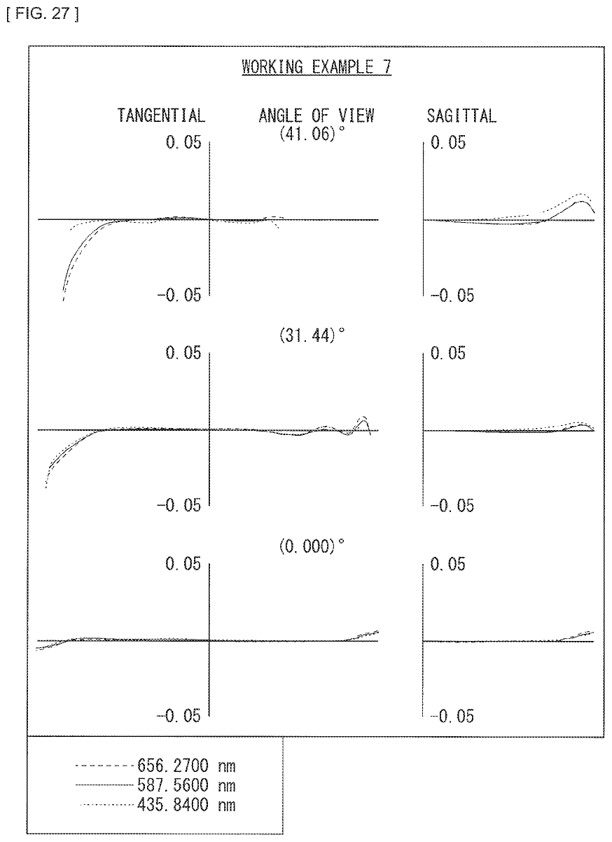

The various aberrations in Numerical Working Example 7 above are illustrated in FIG. 17. In addition, FIG. 27 illustrates lateral aberration.

As can be seen from the respective aberration diagrams, it is clear that the imaging lens 7 according to Numerical Working Example 7 has the various aberrations favorably corrected in spite of smallness and a large aperture, and has excellent optical performance. [Numerical Working Example 8]

[Table 36] illustrates basic lens data of Numerical Working Example 8 in which specific numerical values are applied to the imaging lens 8 illustrated in FIG. 8. In the imaging lens 8 according to Numerical Working Example 8, the aperture stop St is disposed between the lens surface of the first lens L1 on the image plane side and the lens surface of the second lens L2 on the image plane side.

In the imaging lens 8 according to Numerical Working Example 8, both surfaces of each of the first lens L1 to the sixth lens L6 have aspherical shapes. [Table 37] and [Table 38] illustrate the values of coefficients representing these aspherical shapes.

In addition, [Table 39] illustrates the respective values of the focal length f, F-number, overall length, and half angle ω of view of the overall lens system in the imaging lens 8 according to Numerical Working Example 8. [Table 40] illustrates the values of the respective focal lengths of the first lens L1, the second lens L2, the third lens L3, the fourth lens L4, the fifth lens L5, and the sixth lens L6.

TABLE 36
Working Example 8

| Si | Li | Ri | Di | Ndi | ν di |
|---|---|---|---|---|---|
| 1 | L1R1 | 2.908 | 0.301 | 1.544 | 56.1 |
| 2 | L1R2 | 2.816 | 0.059 | | |
| 3 | | | 0.280 | | |
| 4 | St | ∞ | −0.280 | | |
| 5 | L2R1 | 1.701 | 0.653 | 1.544 | 56.1 |
| 6 | L2R2 | −12.861 | 0.033 | | |
| 7 | L3R1 | 4.513 | 0.217 | 1.661 | 20.4 |
| 8 | L3R2 | 2.202 | 0.563 | | |
| 9 | L4R1 | 18.306 | 0.316 | 1.661 | 20.4 |
| 10 | L4R2 | 8.546 | 0.275 | | |
| 11 | L5R1 | 9.491 | 0.848 | 1.635 | 24.0 |
| 12 | L5R2 | 9.458 | 0.130 | | |
| 13 | L6R1 | 2.165 | 0.753 | 1.535 | 55.7 |
| 14 | L6R2 | 1.668 | 0.604 | | |
| 15 | SGR1 | ∞ | 0.110 | 1.517 | 64.2 |
| 16 | SGR2 | ∞ | 0.200 | | |
| 17 | IMG | | | | |

TABLE 37
Working Example 8

| | Si | | | |
|---|---|---|---|---|
| | 1 | 2 | 5 | 6 |
| R | 2.908 | 2.816 | 1.701 | −12.861 |
| K | −4.5907E+00 | 0.0000E+00 | −7.6857E−02 | 6.0552E+00 |
| A3 | 0.0000E+00 | 0.0000E+00 | 0.0000E+00 | 0.0000E+00 |
| A4 | −6.0800E−02 | −8.1773E−02 | 4.9917E−02 | 7.2989E−02 |
| A5 | 0.0000E+00 | 0.0000E+00 | 0.0000E+00 | 0.0000E+00 |
| A6 | −3.9550E−02 | −2.1864E−01 | −1.4764E−01 | −1.0171E−01 |
| A7 | 0.0000E+00 | 0.0000E+00 | 0.0000E+00 | 0.0000E+00 |
| A8 | −6.6000E−03 | 2.5089E−01 | 1.8118E−01 | 2.9283E−01 |
| A9 | 0.0000E+00 | 0.0000E+00 | 0.0000E+00 | 0.0000E+00 |
| A10 | 2.2400E−02 | −1.2046E−01 | −7.6671E−02 | −4.9064E−01 |
| A11 | 0.0000E+00 | 0.0000E+00 | 0.0000E+00 | 0.0000E+00 |
| A12 | −7.2000E−03 | 2.1857E−02 | 1.2663E−02 | 4.8127E−01 |
| A13 | 0.0000E+00 | 0.0000E+00 | 0.0000E+00 | 0.0000E+00 |
| A14 | 0.0000E+00 | 0.0000E+00 | 0.0000E+00 | −1.9709E−01 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 4.513 | 2.202 | 18.306 | 8.546 |
| K | 2.1642E−01 | −8.8149E+00 | −1.0000E+01 | −9.1144E+00 |
| A3 | 0.0000E+00 | 0.0000E+00 | −2.4745E−02 | 2.6595E−03 |
| A4 | −5.9176E−02 | 3.1209E−02 | −1.8551E−03 | −7.4820E−02 |
| A5 | 0.0000E+00 | 0.0000E+00 | −6.6387E−02 | 2.1517E−02 |
| A6 | −1.0644E−01 | −1.1904E−02 | −8.4702E−02 | −1.2631E−01 |
| A7 | 0.0000E+00 | 0.0000E+00 | 3.1595E−02 | −1.1201E−03 |
| A8 | 5.2212E−01 | 9.5197E−02 | 3.0548E−01 | 2.3258E−01 |
| A9 | 0.0000E+00 | 0.0000E+00 | −4.8893E−03 | 2.9867E−04 |
| A10 | −8.7559E−01 | 8.9591E−02 | −4.7435E−01 | −2.3220E−01 |
| A11 | 0.0000E+00 | 0.0000E+00 | −9.6643E−03 | −3.8109E−05 |
| A12 | 8.1849E−01 | −3.2795E−01 | 4.1143E−01 | 1.4190E−01 |
| A13 | 0.0000E+00 | 0.0000E+00 | 2.9268E−03 | −1.3414E−04 |
| A14 | −3.6692E−01 | 2.9553E−01 | −1.9057E−01 | −4.7044E−02 |
| A15 | 0.0000E+00 | 0.0000E+00 | 3.4838E−03 | −3.6286E−05 |
| A16 | 3.3616E−02 | −8.5401E−02 | 3.3031E−02 | 6.4152E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 38
Working Example 8

| | Si | | | |
|---|---|---|---|---|
| | 11 | 12 | 13 | 14 |
| R | 9.491 | 9.458 | 2.165 | 1.668 |
| K | 1.0628E+00 | −1.0000E+01 | −7.5517E−01 | −1.6908E+00 |
| A3 | −5.6759E−03 | −1.7264E−02 | 2.2168E−02 | 8.4279E−02 |
| A4 | 5.3629E−02 | −1.8141E−02 | −3.2205E−01 | −3.7177E−01 |
| A5 | −1.0137E−02 | 2.6691E−03 | 9.3488E−02 | 2.3417E−01 |
| A6 | −1.4338E−01 | 1.0177E−02 | 4.4574E−02 | −2.9813E−02 |
| A7 | −5.7035E−04 | 3.4966E−04 | −6.3601E−03 | −2.7434E−02 |
| A8 | 1.2446E−01 | −1.3463E−02 | −1.1019E−02 | 1.0285E−02 |
| A9 | −8.5161E−04 | −1.2827E−04 | 1.6313E−03 | −1.4630E−04 |
| A10 | −7.6309E−02 | 5.9507E−03 | 1.1755E−03 | −2.3021E−04 |
| A11 | 2.5018E−04 | −6.5874E−06 | −4.9698E−05 | 5.8399E−05 |
| A12 | 2.8554E−02 | −1.3180E−03 | −1.3600E−04 | −5.8017E−05 |
| A13 | 8.9181E−05 | 4.5966E−06 | 7.9454E−08 | 3.6776E−06 |
| A14 | −5.7688E−03 | 1.4719E−04 | 7.3991E−06 | 5.0412E−06 |
| A15 | −3.9863E−06 | 5.4926E−08 | 1.2864E−06 | −2.5744E−07 |
| A16 | 5.0874E−04 | −6.7060E−06 | −4.8227E−07 | −1.5359E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 39
Working Example 8

| | |
|---|---|
| f | 4.08 |
| F-number | 2.0 |
| Overall Length | 5.062 |
| ω | 41.0 |

TABLE 40
Working Example 8

| | Focal Length |
|---|---|
| L1 | 1071.26 |
| L2 | 2.81 |
| L3 | −6.76 |
| L4 | −24.57 |
| L5 | 477.02 |
| L6 | −28.78 |

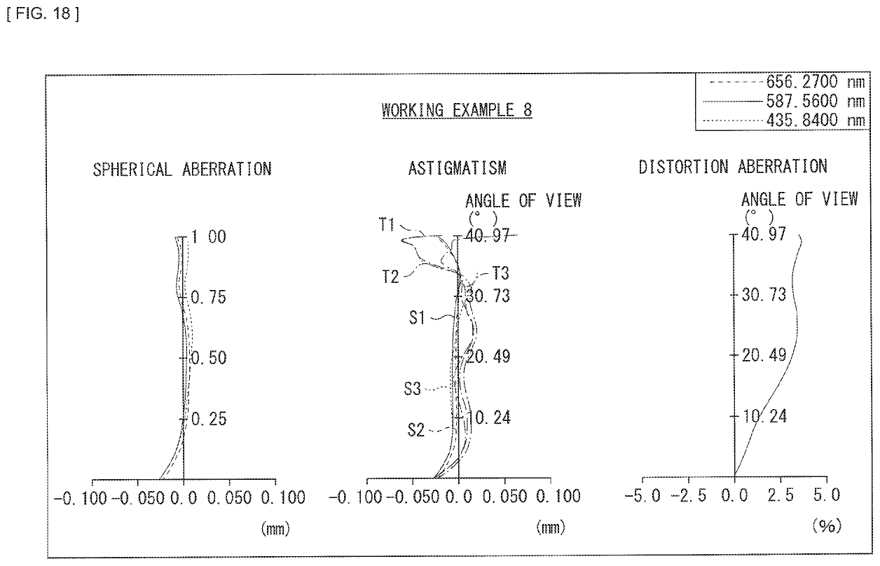

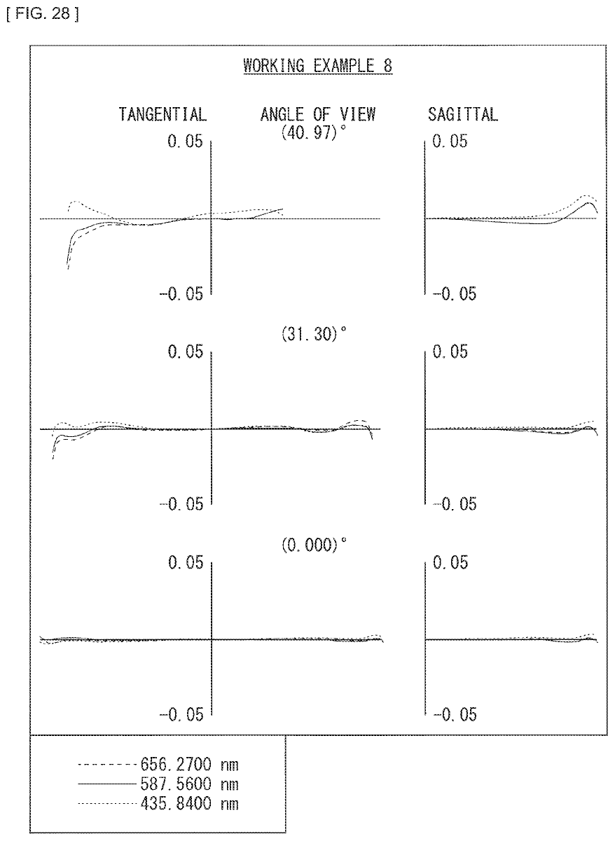

The various aberrations in Numerical Working Example 8 above are illustrated in FIG. 18. In addition, FIG. 28 illustrates lateral aberration.

As can be seen from the respective aberration diagrams, it is clear that the imaging lens 8 according to Numerical Working Example 8 has the various aberrations favorably corrected in spite of smallness and a large aperture, and has excellent optical performance. [Numerical Working Example 9]

[Table 41] illustrates basic lens data of Numerical Working Example 9 in which specific numerical values are applied to the imaging lens 9 illustrated in FIG. 9. In the imaging lens 9 according to Numerical Working Example 9, the aperture stop St is disposed between the lens surface of the first lens L1 on the object side and the lens surface of the first lens L1 on the image plane side.

In the imaging lens 9 according to Numerical Working Example 9, both surfaces of each of the first lens L1 to the sixth lens L6 have aspherical shapes. [Table 42] and [Table 43] illustrate the values of coefficients representing these aspherical shapes.

In addition, [Table 44] illustrates the respective values of the focal length f, F-number, overall length, and half angle ω of view of the overall lens system in the imaging lens 9 according to Numerical Working Example 9. [Table 45] illustrates the values of the respective focal lengths of the first lens L1, the second lens L2, the third lens L3, the fourth lens L4, the fifth lens L5, and the sixth lens L6.

TABLE 41
Working Example 9

| Si | Li | Ri | Di | Ndi | ν di |
|---|---|---|---|---|---|
| 1 | | | 0.280 | | |
| 2 | St | ∞ | −0.280 | | |
| 3 | L1R1 | 1.738 | 0.518 | 1.544 | 56.1 |
| 4 | L1R2 | 3.544 | 0.113 | | |
| 5 | L2R1 | 3.856 | 0.373 | 1.544 | 56.1 |
| 6 | L2R2 | −27.439 | 0.038 | | |
| 7 | L3R1 | 12.818 | 0.200 | 1.671 | 19.2 |
| 8 | L3R2 | 3.924 | 0.407 | | |
| 9 | L4R1 | −10.368 | 0.516 | 1.671 | 19.2 |
| 10 | L4R2 | 1000.000 | 0.316 | | |
| 11 | L5R1 | 3.889 | 0.477 | 1.616 | 25.8 |
| 12 | L5R2 | 6.215 | 0.485 | | |
| 13 | L6R1 | 4.775 | 0.755 | 1.535 | 55.7 |
| 14 | L6R2 | 2.109 | 0.774 | | |
| 15 | SGR1 | ∞ | 0.110 | 1.517 | 64.2 |
| 16 | SGR2 | ∞ | 0.200 | | |
| 17 | IMG | | | | |

TABLE 42
Working Example 9

| | Si | | | |
|---|---|---|---|---|
| | 3 | 4 | 5 | 6 |
| R | 1.738 | 3.544 | 3.856 | −27.439 |
| K | −2.8318E−01 | −6.1657E−01 | −3.9799E−01 | −1.0000E+01 |
| A3 | 0.0000E+00 | 0.0000E+00 | 0.0000E+00 | 0.0000E+00 |
| A4 | −1.3426E−02 | −7.9695E−02 | −8.3145E−02 | −9.8338E−02 |
| A5 | 0.0000E+00 | 0.0000E+00 | 0.0000E+00 | 0.0000E+00 |
| A6 | −1.4085E−02 | −3.0745E−02 | −2.0974E−02 | 2.3572E−01 |
| A7 | 0.0000E+00 | 0.0000E+00 | 0.0000E+00 | 0.0000E+00 |
| A8 | 6.6542E−04 | −4.4689E−02 | 2.8894E−02 | −4.2300E−01 |
| A9 | 0.0000E+00 | 0.0000E+00 | 0.0000E+00 | 0.0000E+00 |
| A10 | −2.6498E−02 | 1.2549E−01 | 7.5474E−02 | 4.5563E−01 |
| A11 | 0.0000E+00 | 0.0000E+00 | 0.0000E+00 | 0.0000E+00 |
| A12 | 1.0101E−02 | −8.1833E−02 | −4.4941E−02 | −2.3572E−01 |
| A13 | 0.0000E+00 | 0.0000E+00 | 0.0000E+00 | 0.0000E+00 |
| A14 | 0.0000E+00 | 1.6804E−02 | 0.0000E+00 | 4.2733E−02 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 12.818 | 3.924 | −10.368 | 1000.000 |
| K | −1.0000E+01 | −1.5927E−01 | 4.2043E+00 | 3.9913E+00 |
| A3 | 0.0000E+00 | 0.0000E+00 | −1.5386E−02 | 1.1265E−02 |
| A4 | −6.0486E−02 | −6.6912E−03 | 3.6774E−03 | −1.3804E−01 |
| A5 | 0.0000E+00 | 0.0000E+00 | −1.4803E−01 | 7.5232E−02 |
| A6 | 2.9451E−01 | 1.2884E−01 | 5.2016E−02 | −8.2439E−02 |
| A7 | 0.0000E+00 | 0.0000E+00 | 1.2341E−01 | −2.7499E−02 |
| A8 | −6.0535E−01 | −2.7737E−01 | 2.9156E−02 | 1.9588E−01 |
| A9 | 0.0000E+00 | 0.0000E+00 | −2.2605E−01 | 2.7571E−03 |
| A10 | 6.5089E−01 | 3.5806E−01 | 1.1350E−01 | −2.1402E−01 |
| A11 | 0.0000E+00 | 0.0000E+00 | 9.5463E−02 | 3.1083E−03 |
| A12 | −3.2150E−01 | −2.1264E−01 | −1.9332E−01 | 1.3687E−01 |
| A13 | 0.0000E+00 | 0.0000E+00 | 1.7456E−02 | 8.4626E−04 |
| A14 | 6.0411E−02 | 6.7959E−02 | 1.8223E−01 | −4.4304E−02 |
| A15 | 0.0000E+00 | 0.0000E+00 | −6.6855E−02 | −6.7109E−04 |
| A16 | 2.9074E−04 | 7.9622E−04 | −2.7426E−02 | 5.5278E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 43
Working Example 9

| | Si | | | |
|---|---|---|---|---|
| | 11 | 12 | 13 | 14 |
| R | 3.889 | 6.215 | 4.775 | 2.109 |
| K | −9.7044E+00 | 9.6553E+00 | 1.5025E+00 | −1.3002E+00 |
| A3 | 2.9403E−02 | 2.2543E−03 | 5.1508E−02 | 1.2236E−01 |
| A4 | −1.5450E−01 | −1.0067E−01 | −3.4454E−01 | −4.7697E−01 |
| A5 | 1.1116E−01 | 3.9183E−02 | 1.1407E−01 | 3.0553E−01 |
| A6 | −7.9849E−02 | −9.3331E−03 | 4.5265E−02 | −2.2548E−02 |
| A7 | −5.0438E−02 | 2.2659E−03 | −8.2013E−03 | −5.4506E−02 |
| A8 | 8.1991E−02 | −1.1928E−02 | −1.1427E−02 | 1.6323E−02 |
| A9 | 7.0185E−03 | −7.2008E−04 | 1.4197E−03 | 2.3094E−03 |
| A10 | −6.0103E−02 | 5.0970E−03 | 1.1610E−03 | −3.5704E−04 |
| A11 | 4.0288E−03 | 3.5640E−05 | −8.0248E−06 | −2.4025E−04 |
| A12 | 2.4595E−02 | −1.0315E−03 | −1.1052E−04 | −1.3925E−04 |
| A13 | −2.6131E−03 | 9.4348E−05 | 2.9635E−06 | 3.3394E−05 |
| A14 | −6.0027E−03 | 1.6497E−04 | 5.7426E−06 | 1.1249E−05 |
| A15 | 6.2766E−04 | −7.5392E−06 | 8.4418E−08 | 2.2320E−08 |
| A16 | 9.2279E−04 | −2.4936E−05 | −5.0347E−07 | −6.6213E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 44
Working Example 9

| | |
|---|---|
| f | 4.78 |
| F-number | 2.0 |
| Overall Length | 5.282 |
| ω | 37.2 |

TABLE 45
Working Example 9

| | Focal Length |
|---|---|
| L1 | 5.69 |
| L2 | 6.24 |
| L3 | −8.50 |
| L4 | −15.29 |
| L5 | 15.65 |
| L6 | −7.83 |

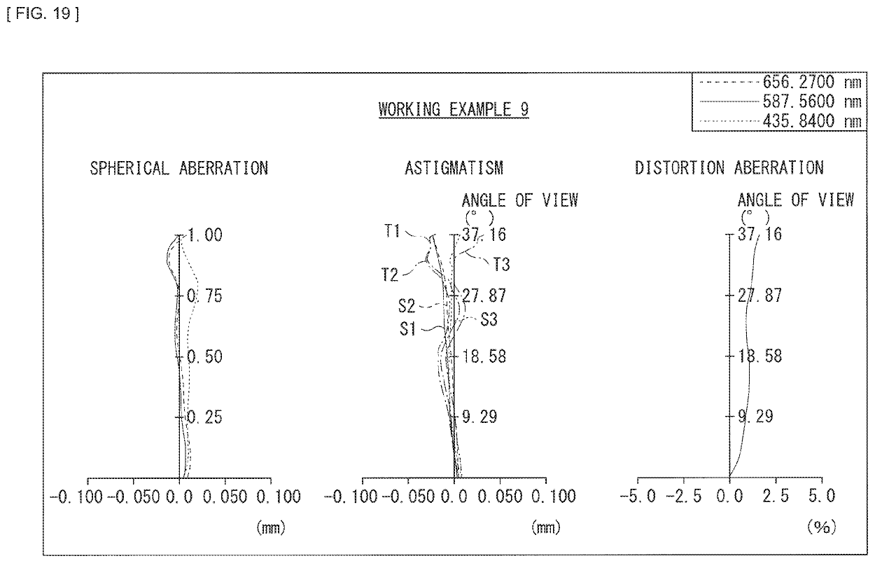

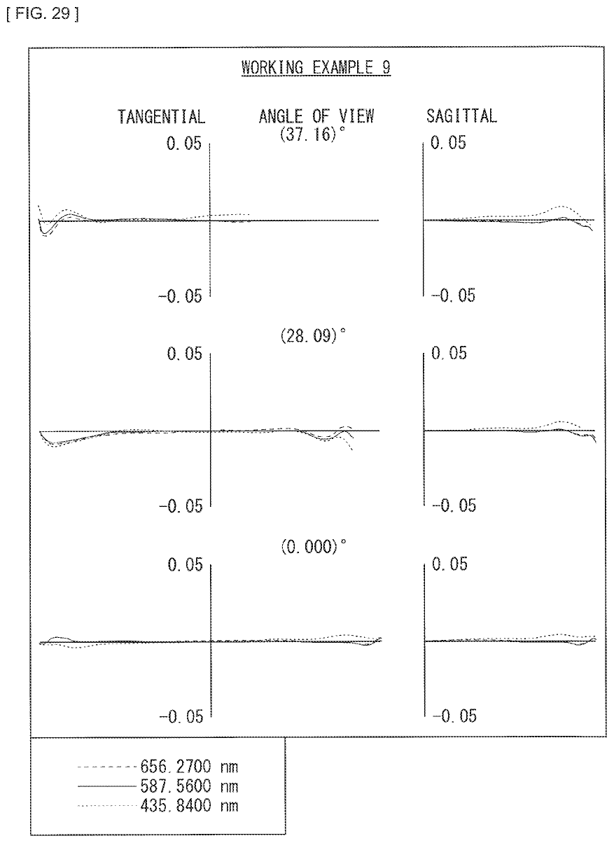

The various aberrations in Numerical Working Example 9 above are illustrated in FIG. 19. In addition, FIG. 29 illustrates lateral aberration.

As can be seen from the respective aberration diagrams, it is clear that the imaging lens 9 according to Numerical Working Example 9 has the various aberrations favorably corrected in spite of smallness and a large aperture, and has excellent optical performance. [Numerical Working Example 10]

[Table 46] illustrates basic lens data of Numerical Working Example 10 in which specific numerical values are applied to the imaging lens 10 illustrated in FIG. 10. In the imaging lens 10 according to Numerical Working Example 10, the aperture stop St is disposed between the lens surface of the first lens L1 on the image plane side and the lens surface of the second lens L2 on the image plane side.

In the imaging lens 10 according to Numerical Working Example 10, both surfaces of each of the first lens L1 to the sixth lens L6 have aspherical shapes. [Table 47] and [Table 48] illustrate the values of coefficients representing these aspherical shapes.

In addition, [Table 49] illustrates the respective values of the focal length f, F-number, overall length, and half angle ω of view of the overall lens system in the imaging lens 10 according to Numerical Working Example 10. [Table 50] illustrates the values of the respective focal lengths of the first lens L1, the second lens L2, the third lens L3, the fourth lens L4, the fifth lens L5, and the sixth lens L6.

TABLE 46
Working Example 10

| Si | Li | Ri | Di | Ndi | ν di |
|---|---|---|---|---|---|
| 1 | L1R1 | 2.719 | 0.350 | 1.544 | 56.1 |
| 2 | L1R2 | 2.781 | 0.063 | | |
| 3 | | | 0.280 | | |
| 4 | St | ∞ | −0.280 | | |
| 5 | L2R1 | 1.818 | 0.579 | 1.544 | 56.1 |
| 6 | L2R2 | −20.703 | 0.025 | | |
| 7 | L3R1 | 3.400 | 0.230 | 1.661 | 20.4 |
| 8 | L3R2 | 1.976 | 0.602 | | |
| 9 | L4R1 | 206.752 | 0.323 | 1.661 | 20.4 |
| 10 | L4R2 | 21.020 | 0.318 | | |
| 11 | L5R1 | 4.704 | 0.603 | 1.635 | 24.0 |
| 12 | L5R2 | 4.649 | 0.268 | | |
| 13 | L6R1 | 2.183 | 0.747 | 1.535 | 55.7 |
| 14 | L6R2 | 1.712 | 0.578 | | |
| 15 | SGR1 | ∞ | 0.110 | 1.517 | 64.2 |
| 16 | SGR2 | ∞ | 0.200 | | |
| 17 | IMG | | | | |

TABLE 47
Working Example 10

| | Si | | | |
|---|---|---|---|---|
| | 1 | 2 | 5 | 6 |
| R | 2.719 | 2.781 | 1.818 | −20.703 |
| K | −4.0432E+00 | 0.0000E+00 | 4.1590E−02 | 1.0000E+01 |
| A3 | 0.0000E+00 | 0.0000E+00 | 0.0000E+00 | 0.0000E+00 |
| A4 | −5.1500E−02 | −7.5953E−02 | 5.6538E−02 | 8.7346E−02 |
| A5 | 0.0000E+00 | 0.0000E+00 | 0.0000E+00 | 0.0000E+00 |
| A6 | −3.3237E−02 | −2.1422E−01 | −1.4857E−01 | −1.1086E−01 |
| A7 | 0.0000E+00 | 0.0000E+00 | 0.0000E+00 | 0.0000E+00 |
| A8 | −8.1431E−03 | 2.5150E−01 | 1.7894E−01 | 2.8129E−01 |
| A9 | 0.0000E+00 | 0.0000E+00 | 0.0000E+00 | 0.0000E+00 |
| A10 | 2.1018E−02 | −1.2095E−01 | −7.4728E−02 | −4.9321E−01 |
| A11 | 0.0000E+00 | 0.0000E+00 | 0.0000E+00 | 0.0000E+00 |
| A12 | −6.2914E−03 | 2.1984E−02 | 1.4054E−02 | 4.9376E−01 |
| A13 | 0.0000E+00 | 0.0000E+00 | 0.0000E+00 | 0.0000E+00 |
| A14 | 0.0000E+00 | 0.0000E+00 | 0.0000E+00 | −1.9709E−01 |
| A15 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |
| | 7 | 8 | 9 | 10 |
| R | 3.400 | 1.976 | 206.752 | 21.020 |
| K | 3.3277E−01 | −7.0344E+00 | 1.0000E+01 | 1.0000E+01 |
| A3 | 0.0000E+00 | 0.0000E+00 | −1.1592E−02 | 1.0275E−02 |
| A4 | −5.7567E−02 | 3.3497E−02 | 3.7494E−03 | −7.0901E−02 |
| A5 | 0.0000E+00 | 0.0000E+00 | −7.0042E−02 | 2.2136E−02 |
| A6 | −1.1531E−01 | −2.4694E−02 | −9.0240E−02 | −1.2726E−01 |
| A7 | 0.0000E+00 | 0.0000E+00 | 2.6948E−02 | −2.1226E−03 |
| A8 | 5.0787E−01 | 9.1634E−02 | 3.0306E−01 | 2.3191E−01 |
| A9 | 0.0000E+00 | 0.0000E+00 | −5.0316E−03 | −1.4299E−05 |
| A10 | −8.7943E−01 | 9.2969E−02 | −4.7302E−01 | −2.3227E−01 |
| A11 | 0.0000E+00 | 0.0000E+00 | −7.7066E−03 | 1.9202E−05 |
| A12 | 8.3294E−01 | −3.2795E−01 | 4.1324E−01 | 1.4198E−01 |
| A13 | 0.0000E+00 | 0.0000E+00 | 4.0362E−03 | −7.9659E−05 |
| A14 | −3.6692E−01 | 2.9553E−01 | −1.9041E−01 | −4.7032E−02 |
| A15 | 0.0000E+00 | 0.0000E+00 | 2.6327E−03 | −6.1773E−05 |
| A16 | 3.3616E−02 | −8.5401E−02 | 3.1248E−02 | 6.3635E−03 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 48
Working Example 10

| | Si | | | |
|---|---|---|---|---|
| | 11 | 12 | 13 | 14 |
| R | 4.704 | 4.649 | 2.183 | 1.712 |
| K | −9.6491E+00 | −9.0661E+00 | −7.4734E−01 | −1.8098E+00 |
| A3 | −2.0986E−02 | −2.4953E−02 | 2.1872E−02 | 8.7233E−02 |
| A4 | 5.2869E−02 | −2.0800E−02 | −3.2191E−01 | −3.7175E−01 |
| A5 | −1.2927E−03 | 1.7674E−03 | 9.3594E−02 | 2.3412E−01 |
| A6 | −1.3943E−01 | 1.0110E−02 | 4.4616E−02 | −2.9871E−02 |
| A7 | −2.1119E−04 | 4.7408E−04 | −6.3524E−03 | −2.7450E−02 |
| A8 | 1.2405E−01 | −1.3410E−02 | −1.1020E−02 | 1.0284E−02 |
| A9 | −1.1327E−03 | −1.2458E−04 | 1.6297E−03 | −1.4565E−04 |
| A10 | −7.6417E−02 | 5.9431E−03 | 1.1755E−03 | −2.2982E−04 |
| A11 | 2.2144E−04 | −1.2164E−05 | −5.0062E−05 | 5.8525E−05 |
| A12 | 2.8545E−02 | −1.3204E−03 | −1.3612E−04 | −5.7988E−05 |
| A13 | 7.9708E−05 | 3.9748E−06 | 4.9781E−08 | 3.6810E−06 |
| A14 | −5.7809E−03 | 1.4724E−04 | 7.3970E−06 | 5.0402E−06 |
| A15 | −1.7071E−05 | 2.5944E−07 | 1.2903E−06 | −2.5844E−07 |
| A16 | 4.9687E−04 | −6.5273E−06 | −4.7882E−07 | −1.5410E−07 |
| A17 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A19 | 0.0000E+00 | 0.0000E+00 | 0.0000E+00 | 0.0000E+00 |
| A20 | 0.0000E+00 | 0.0000E+00 | 0.0000E+00 | 0.0000E+00 |

TABLE 49
Working Example 10

| | |
|---|---|
| f | 4.06 |
| F-number | 2.0 |
| Overall Length | 4.996 |
| ω | 41.1 |

TABLE 50
Working Example 10

| | |
|---|---|
| L1 | 75.01 |
| L2 | 3.10 |
| L3 | −7.63 |
| L4 | −35.42 |
| L5 | 192.19 |
| L6 | −33.16 |

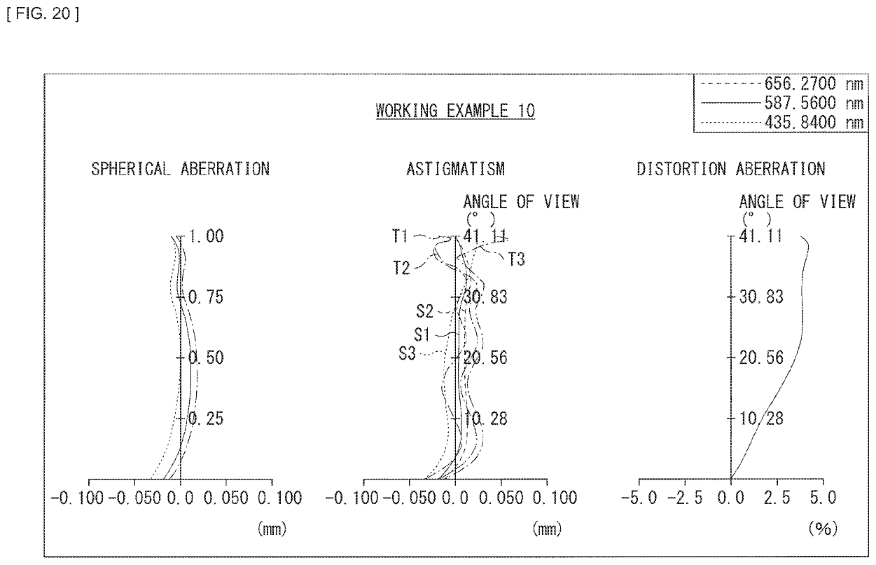

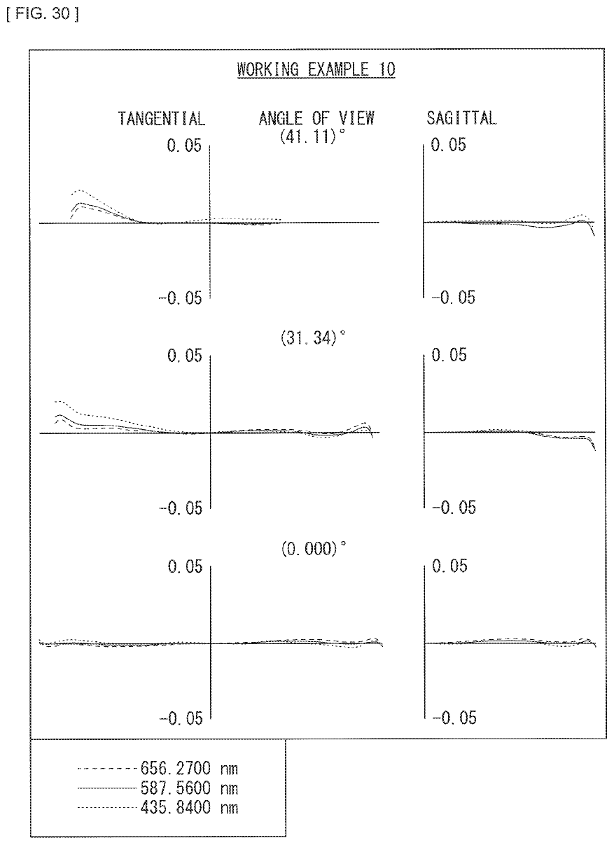

The various aberrations in Numerical Working Example 10 above are illustrated in FIG. 20. In addition, FIG. 30 illustrates lateral aberration.

As can be seen from the respective aberration diagrams, it is clear that the imaging lens 10 according to Numerical Working Example 10 has the various aberrations favorably corrected in spite of smallness and a large aperture, and has excellent optical performance. [Other Numerical Data of Each Working Example]

[Table 51] summarizes values related to each of the above-described conditional expressions for each numerical working example. As can be seen from [Table 51], a value of each numerical working example for each conditional expression falls within the numerical range.

TABLE 51

| | | Working | Working | Working | Working | Working |
|---|---|---|---|---|---|---|
| Conditional Expression | | Example 1 | Example 2 | Example 3 | Example 4 | Example 5 |
| (1) | f12/f | 0.79 | 0.75 | 0.79 | 0.80 | 0.77 |
| (2) | f3/f4 | 0.07 | 0.29 | 0.61 | 0.34 | 0.63 |
| (3) | f1/L1R1sag | 22.62 | 17.45 | 84.31 | 19.60 | 11.06 |
| (4) | f2/L2R1sag | 60.64 | 52.41 | 50.32 | 89.59 | 51687.60 |
| (5) | (D(L1) + D(L12) + | 3.40 | 2.95 | 6.90 | 3.50 | 4.00 |
| | D(L2)/L1R1sag | | | | | |
| (6A) | υ d(L4) | 21.5 | 19.2 | 33.6 | 16.3 | 19.2 |
| (6B) | υ d(L5) | 24 | 25.8 | 33.6 | 16.3 | 25.8 |
| (7) | D(L5)/D(L56) + | 0.53 | 0.43 | 0.74 | 0.54 | 0.56 |
| | D(L6)) | | | | | |
| (8) | f4/R(L4R2) | −10.42 | −0.06 | −1.87 | −2.39 | −1.05 |
| (9) | f5/R(L5R2) | 6.01 | 5.39 | 0.07 | 2.77 | 3.17 |
| (10) | (R(L6R1) + | 6.66 | 4.93 | 4.90 | 4.74 | 4.29 |
| | R(L6R2)/ | | | | | |
| | R(L6R1) − | | | | | |
| | R(L6R2)) | | | | | |
| (11) | \| R(L1R1)/f \| | 0.41 | 0.38 | 0.61 | 0.43 | 0.44 |
| | | Working | Working | Working | Working | Working |
| Conditional Expression | | Example 6 | Example 7 | Example 8 | Example 9 | Example 10 |
| (1) | f12/f | 0.91 | 0.73 | 0.71 | 0.66 | 0.77 |
| (2) | f3/f4 | 0.34 | 0.07 | 0.28 | 0.56 | 0.22 |
| (3) | f1/L1R1sag | 142.39 | 381.93 | 53168.54 | 18.22 | 1117.48 |
| (4) | f2/L2R1sag | 30.12 | 8.88 | 7.72 | 50.16 | 8.97 |
| (5) | (D(L1) + D(L12) + | 6.45 | 6.38 | 50.28 | 3.21 | 14.78 |
| | D(L2)/L1R1sag | | | | | |
| (6A) | υ d(L4) | 33.6 | 20.4 | 20.4 | 19.2 | 20.4 |
| (6B) | υ d(L5) | 33.6 | 24 | 24 | 25.8 | 24 |
| (7) | D(L5)/D(L56) + | 0.49 | 0.67 | 0.96 | 0.38 | 0.59 |
| | D(L6)) | | | | | |
| (8) | f4/R(L4R2) | −2.18 | −4.44 | −2.87 | −0.02 | −1.69 |
| (9) | f5/R(L5R2) | 4.03 | 134.22 | 50.44 | 2.52 | 41.34 |
| (10) | (R(L6R1) + | 5.49 | 6.56 | 7.71 | 2.58 | 8.27 |
| | R(L6R2)/ | | | | | |
| | R(L6R1) − | | | | | |
| | R(L6R2)) | | | | | |
| (11) | \| R(L1R1)/f \| | 0.60 | 0.52 | 0.71 | 0.36 | 0.67 |

### 5. Application Examples

### 5.1 First Application Example

The technology according to the present disclosure is applicable to various products. For example, the technology according to the present disclosure may be achieved as an apparatus mounted on any type of mobile body such as a vehicle, an electric vehicle, a hybrid electric vehicle, a motorcycle, a bicycle, a personal mobility, an airplane, a drone, a vessel, a robot, a construction machine, or an agricultural machine (tractor).

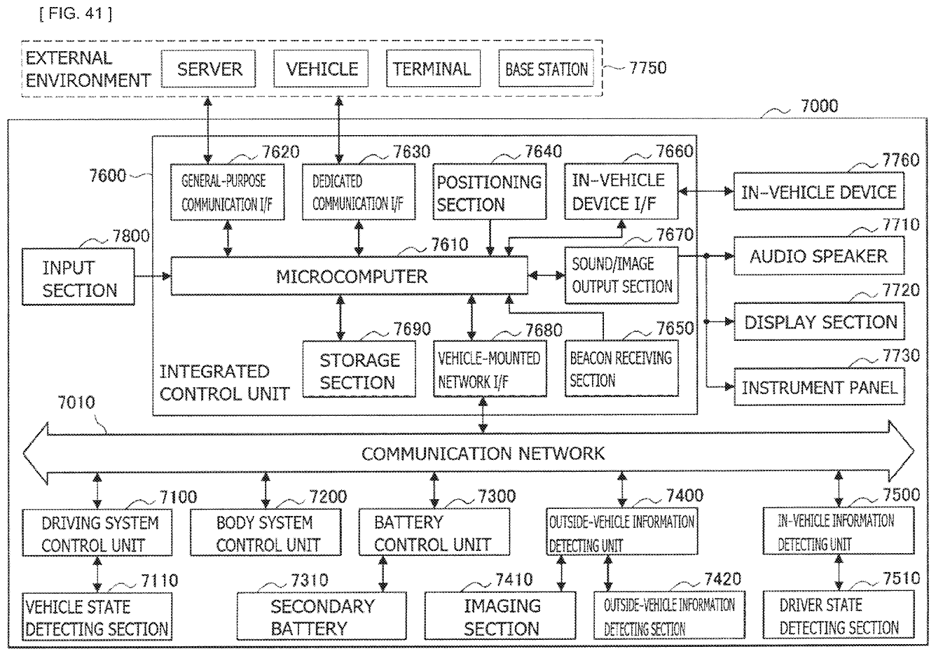

FIG. 41 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 41, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 41 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

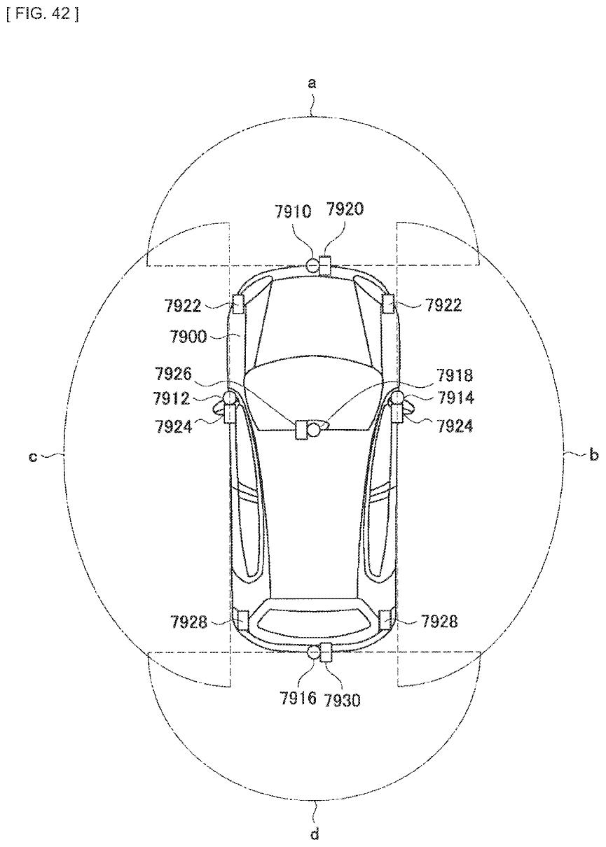

FIG. 42 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 42 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 41, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 41, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 41 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the imaging lens and imaging apparatus according to the present disclosure are applicable to the imaging section 7410 and the imaging sections 7910, 7912, 7914, 7916, and 7918.

### 5.2 Second Application Example

The technology according to the present disclosure may be applied to an endoscopic surgery system.

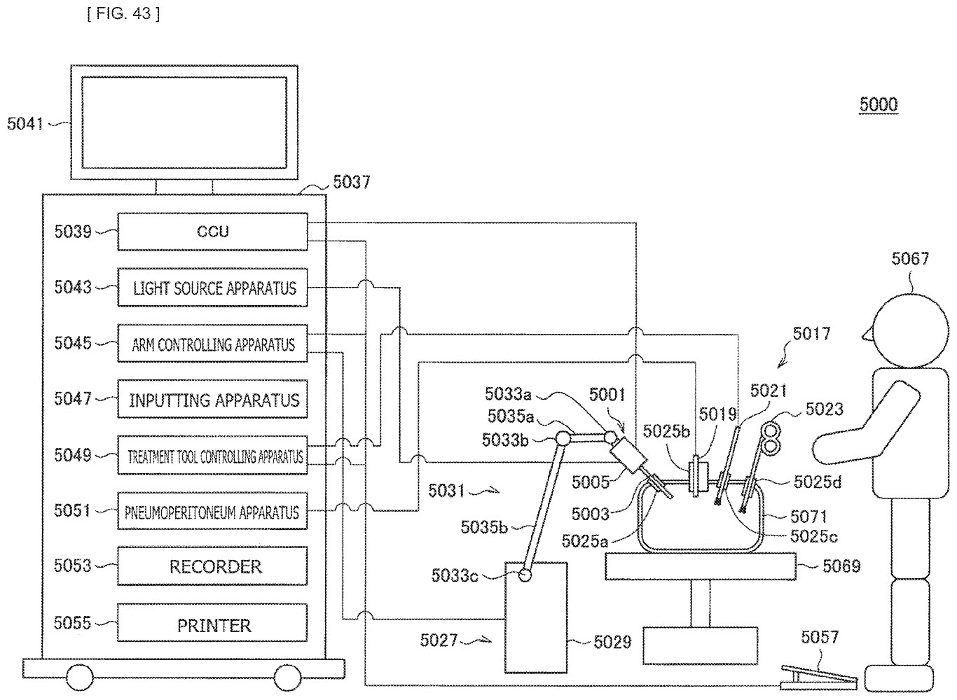

FIG. 43 is a view depicting an example of a schematic configuration of an endoscopic surgery system 5000 to which the technology according to an embodiment of the present disclosure can be applied. In FIG. 43, a state is illustrated in which a surgeon (medical doctor) 5067 is using the endoscopic surgery system 5000 to perform surgery for a patient 5071 on a patient bed 5069. As depicted, the endoscopic surgery system 5000 includes an endoscope 5001, other surgical tools 5017, a supporting arm apparatus 5027 which supports the endoscope 5001 thereon, and a cart 5037 on which various apparatus for endoscopic surgery are mounted.

In endoscopic surgery, in place of incision of the abdominal wall to perform laparotomy, a plurality of tubular aperture devices called trocars 5025a to 5025d are used to puncture the abdominal wall. Then, a lens barrel 5003 of the endoscope 5001 and the other surgical tools 5017 are inserted into body cavity of the patient 5071 through the trocars 5025a to 5025d. In the example depicted, as the other surgical tools 5017, a pneumoperitoneum tube 5019, an energy device 5021 and forceps 5023 are inserted into body cavity of the patient 5071. Further, the energy device 5021 is a treatment tool for performing incision and peeling of a tissue, sealing of a blood vessel or the like by high frequency current or ultrasonic vibration. However, the surgical tools 5017 depicted are mere examples at all, and as the surgical tools 5017, various surgical tools which are generally used in endoscopic surgery such as, for example, tweezers or a retractor may be used.

An image of a surgical region in a body cavity of the patient 5071 imaged by the endoscope 5001 is displayed on a display apparatus 5041. The surgeon 5067 would use the energy device 5021 or the forceps 5023 while watching the image of the surgical region displayed on the display apparatus 5041 on the real time basis to perform such treatment as, for example, resection of an affected area. It is to be noted that, though not depicted, the pneumoperitoneum tube 5019, the energy device 5021 and the forceps 5023 are supported by the surgeon 5067, an assistant or the like during surgery.

### (Supporting Arm Apparatus)

The supporting arm apparatus 5027 includes an arm unit 5031 extending from a base unit 5029. In the example depicted, the arm unit 5031 includes joint portions 5033a, 5033b and 5033c and links 5035a and 5035b and is driven under the control of an arm controlling apparatus 5045. The endoscope 5001 is supported by the arm unit 5031 such that the position and the posture of the endoscope 5001 are controlled. Consequently, stable fixation in position of the endoscope 5001 can be implemented.

### (Endoscope)

The endoscope 5001 includes the lens barrel 5003 which has a region of a predetermined length from a distal end thereof to be inserted into a body cavity of the patient 5071, and a camera head 5005 connected to a proximal end of the lens barrel 5003. In the example depicted, the endoscope 5001 is depicted as a rigid endoscope having the lens barrel 5003 of the hard type. However, the endoscope 5001 may otherwise be configured as a flexible endoscope having the lens barrel 5003 of the flexible type.

The lens barrel 5003 has, at a distal end thereof, an opening in which an objective lens is fitted. A light source apparatus 5043 is connected to the endoscope 5001 such that light generated by the light source apparatus 5043 is introduced to a distal end of the lens barrel by a light guide extending in the inside of the lens barrel 5003 and is irradiated toward an observation target in a body cavity of the patient 5071 through the objective lens. It is to be noted that the endoscope 5001 may be a forward-viewing endoscope or may be an oblique-viewing endoscope or a side-viewing endoscope.

An optical system and an image pickup element are provided in the inside of the camera head 5005 such that reflected light (observation light) from an observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 5039. It is to be noted that the camera head 5005 has a function incorporated therein for suitably driving the optical system of the camera head 5005 to adjust the magnification and the focal distance.

It is to be noted that, in order to establish compatibility with, for example, a stereoscopic vision (three dimensional (3D) display), a plurality of image pickup elements may be provided on the camera head 5005. In this case, a plurality of relay optical systems are provided in the inside of the lens barrel 5003 in order to guide observation light to each of the plurality of image pickup elements.

### (Various Apparatus Incorporated in Cart)

The CCU 5039 includes a central processing unit (CPU), a graphics processing unit (GPU) or the like and integrally controls operation of the endoscope 5001 and the display apparatus 5041. In particular, the CCU 5039 performs, for an image signal received from the camera head 5005, various image processes for displaying an image based on the image signal such as, for example, a development process (demosaic process). The CCU 5039 provides the image signal for which the image processes have been performed to the display apparatus 5041. Further, the CCU 5039 transmits a control signal to the camera head 5005 to control driving of the camera head 5005. The control signal may include information relating to an image pickup condition such as a magnification or a focal distance.

The display apparatus 5041 displays an image based on an image signal for which the image processes have been performed by the CCU 5039 under the control of the CCU 5039. If the endoscope 5001 is ready for imaging of a high resolution such as 4K (horizontal pixel number 3840×vertical pixel number 2160), 8K (horizontal pixel number 7680×vertical pixel number 4320) or the like and/or ready for 3D display, then a display apparatus by which corresponding display of the high resolution and/or 3D display are possible may be used as the display apparatus 5041. Where the apparatus is ready for imaging of a high resolution such as 4K or 8K, if the display apparatus used as the display apparatus 5041 has a size of equal to or not less than 55 inches, then a more immersive experience can be obtained. Further, a plurality of display apparatus 5041 having different resolutions and/or different sizes may be provided in accordance with purposes.

The light source apparatus 5043 includes a light source such as, for example, a light emitting diode (LED) and supplies irradiation light for imaging of a surgical region to the endoscope 5001.

The arm controlling apparatus 5045 includes a processor such as, for example, a CPU and operates in accordance with a predetermined program to control driving of the arm unit 5031 of the supporting arm apparatus 5027 in accordance with a predetermined controlling method.

An inputting apparatus 5047 is an input interface for the endoscopic surgery system 5000. A user can perform inputting of various kinds of information or instruction inputting to the endoscopic surgery system 5000 through the inputting apparatus 5047. For example, the user would input various kinds of information relating to surgery such as physical information of a patient, information regarding a surgical procedure of the surgery and so forth through the inputting apparatus 5047. Further, the user would input, for example, an instruction to drive the arm unit 5031, an instruction to change an image pickup condition (type of irradiation light, magnification, focal distance or the like) by the endoscope 5001, an instruction to drive the energy device 5021 or the like through the inputting apparatus 5047.

The type of the inputting apparatus 5047 is not limited and may be that of any one of various known inputting apparatus. As the inputting apparatus 5047, for example, a mouse, a keyboard, a touch panel, a switch, a foot switch 5057 and/or a lever or the like may be applied. Where a touch panel is used as the inputting apparatus 5047, it may be provided on the display face of the display apparatus 5041.

Otherwise, the inputting apparatus 5047 is a device to be mounted on a user such as, for example, a glasses type wearable device or a head mounted display (HMD), and various kinds of inputting are performed in response to a gesture or a line of sight of the user detected by any of the devices mentioned. Further, the inputting apparatus 5047 includes a camera which can detect a motion of a user, and various kinds of inputting are performed in response to a gesture or a line of sight of a user detected from a video imaged by the camera. Further, the inputting apparatus 5047 includes a microphone which can collect the voice of a user, and various kinds of inputting are performed by voice collected by the microphone. By configuring the inputting apparatus 5047 such that various kinds of information can be inputted in a contactless fashion in this manner, especially a user who belongs to a clean area (for example, the surgeon 5067) can operate an apparatus belonging to an unclean area in a contactless fashion. Further, since the user can operate an apparatus without releasing a possessed surgical tool from its hand, the convenience to the user is improved.

A treatment tool controlling apparatus 5049 controls driving of the energy device 5021 for cautery or incision of a tissue, sealing of a blood vessel or the like. A pneumoperitoneum apparatus 5051 feeds gas into a body cavity of the patient 5071 through the pneumoperitoneum tube 5019 to inflate the body cavity in order to secure the field of view of the endoscope 5001 and secure the working space for the surgeon. A recorder 5053 is an apparatus capable of recording various kinds of information relating to surgery. A printer 5055 is an apparatus capable of printing various kinds of information relating to surgery in various forms such as a text, an image or a graph.

In the following, especially a characteristic configuration of the endoscopic surgery system 5000 is described in more detail.

### (Supporting Arm Apparatus)

The supporting arm apparatus 5027 includes the base unit 5029 serving as a base, and the arm unit 5031 extending from the base unit 5029. In the example depicted, the arm unit 5031 includes the plurality of joint portions 5033a, 5033b and 5033c and the plurality of links 5035a and 5035b connected to each other by the joint portion 5033b. In FIG. 43, for simplified illustration, the configuration of the arm unit 5031 is depicted in a simplified form. Actually, the shape, number and arrangement of the joint portions 5033a to 5033c and the links 5035a and 5035b and the direction and so forth of axes of rotation of the joint portions 5033a to 5033c can be set suitably such that the arm unit 5031 has a desired degree of freedom. For example, the arm unit 5031 may preferably be configured such that it has a degree of freedom equal to or not less than 6 degrees of freedom. This makes it possible to move the endoscope 5001 freely within the movable range of the arm unit 5031. Consequently, it becomes possible to insert the lens barrel 5003 of the endoscope 5001 from a desired direction into a body cavity of the patient 5071.

An actuator is provided in each of the joint portions 5033a to 5033c, and the joint portions 5033a to 5033c are configured such that they are rotatable around predetermined axes of rotation thereof by driving of the respective actuators. The driving of the actuators is controlled by the arm controlling apparatus 5045 to control the rotational angle of each of the joint portions 5033a to 5033c thereby to control driving of the arm unit 5031. Consequently, control of the position and the posture of the endoscope 5001 can be implemented. Thereupon, the arm controlling apparatus 5045 can control driving of the arm unit 5031 by various known controlling methods such as force control or position control.

For example, if the surgeon 5067 suitably performs operation inputting through the inputting apparatus 5047 (including the foot switch 5057), then driving of the arm unit 5031 may be controlled suitably by the arm controlling apparatus 5045 in response to the operation input to control the position and the posture of the endoscope 5001. After the endoscope 5001 at the distal end of the arm unit 5031 is moved from an arbitrary position to a different arbitrary position by the control just described, the endoscope 5001 can be supported fixedly at the position after the movement. It is to be noted that the arm unit 5031 may be operated in a master-slave fashion. In this case, the arm unit 5031 may be remotely controlled by the user through the inputting apparatus 5047 which is placed at a place remote from the operating room.

Further, where force control is applied, the arm controlling apparatus 5045 may perform power-assisted control to drive the actuators of the joint portions 5033a to 5033c such that the arm unit 5031 may receive external force by the user and move smoothly following the external force. This makes it possible to move, when the user directly touches with and moves the arm unit 5031, the arm unit 5031 with comparatively weak force. Accordingly, it becomes possible for the user to move the endoscope 5001 more intuitively by a simpler and easier operation, and the convenience to the user can be improved.

Here, generally in endoscopic surgery, the endoscope 5001 is supported by a medical doctor called scopist. In contrast, where the supporting arm apparatus 5027 is used, the position of the endoscope 5001 can be fixed more certainly without hands, and therefore, an image of a surgical region can be obtained stably and surgery can be performed smoothly.

It is to be noted that the arm controlling apparatus 5045 may not necessarily be provided on the cart 5037. Further, the arm controlling apparatus 5045 may not necessarily be a single apparatus. For example, the arm controlling apparatus 5045 may be provided in each of the joint portions 5033a to 5033c of the arm unit 5031 of the supporting arm apparatus 5027 such that the plurality of arm controlling apparatus 5045 cooperate with each other to implement driving control of the arm unit 5031.

### (Light Source Apparatus)

The light source apparatus 5043 supplies irradiation light upon imaging of a surgical region to the endoscope 5001. The light source apparatus 5043 includes a white light source which includes, for example, an LED, a laser light source or a combination of them. In this case, where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 5043. Further, in this case, if laser beams from the respective RGB laser light sources are irradiated time-divisionally on an observation target and driving of the image pickup elements of the camera head 5005 is controlled in synchronism with the irradiation timings, then images individually corresponding to the R, G and B colors can be picked up time-divisionally. According to the method just described, a color image can be obtained even if a color filter is not provided for the image pickup element.

Further, driving of the light source apparatus 5043 may be controlled such that the intensity of light to be outputted is changed for each predetermined time. By controlling driving of the image pickup element of the camera head 5005 in synchronism with the timing of the change of the intensity of light to acquire images time-divisionally and synthesizing the images, an image of a high dynamic range free from underexposed blocked up shadows and overexposed highlights can be created.

Further, the light source apparatus 5043 may be configured to supply light of a predetermined wavelength band ready for special light observation. In special light observation, for example, by utilizing the wavelength dependency of absorption of light in a body tissue to irradiate light of a narrower wavelength band in comparison with irradiation light upon ordinary observation (namely, white light), narrow band light observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 5043 can be configured to supply such narrow-band light and/or excitation light suitable for special light observation as described above.

### (Camera Head and CCU)

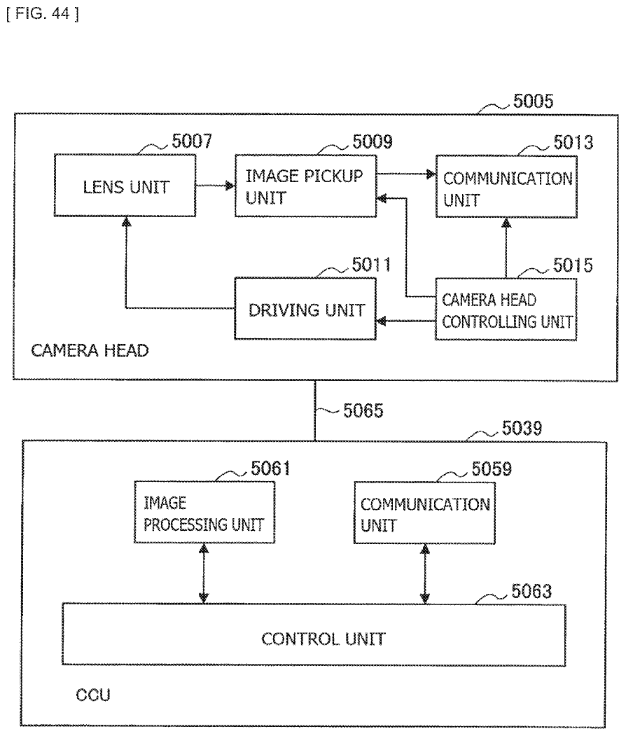

Functions of the camera head 5005 of the endoscope 5001 and the CCU 5039 are described in more detail with reference to FIG. 44. FIG. 44 is a block diagram depicting an example of a functional configuration of the camera head 5005 and the CCU 5039 depicted in FIG. 43.

Referring to FIG. 44, the camera head 5005 has, as functions thereof, a lens unit 5007, an image pickup unit 5009, a driving unit 5011, a communication unit 5013 and a camera head controlling unit 5015. Further, the CCU 5039 has, as functions thereof, a communication unit 5059, an image processing unit 5061 and a control unit 5063. The camera head 5005 and the CCU 5039 are connected to be bidirectionally communicable to each other by a transmission cable 5065.

First, a functional configuration of the camera head 5005 is described. The lens unit 5007 is an optical system provided at a connecting location of the camera head 5005 to the lens barrel 5003. Observation light taken in from a distal end of the lens barrel 5003 is introduced into the camera head 5005 and enters the lens unit 5007. The lens unit 5007 includes a combination of a plurality of lenses including a zoom lens and a focusing lens. The lens unit 5007 has optical properties adjusted such that the observation light is condensed on a light receiving face of the image pickup element of the image pickup unit 5009. Further, the zoom lens and the focusing lens are configured such that the positions thereof on their optical axis are movable for adjustment of the magnification and the focal point of a picked up image.

The image pickup unit 5009 includes an image pickup element and disposed at a succeeding stage to the lens unit 5007. Observation light having passed through the lens unit 5007 is condensed on the light receiving face of the image pickup element, and an image signal corresponding to the observation image is generated by photoelectric conversion of the image pickup element. The image signal generated by the image pickup unit 5009 is provided to the communication unit 5013.

As the image pickup element which is included by the image pickup unit 5009, an image sensor, for example, of the complementary metal oxide semiconductor (CMOS) type is used which has a Bayer array and is capable of picking up an image in color. It is to be noted that, as the image pickup element, an image pickup element may be used which is ready, for example, for imaging of an image of a high resolution equal to or not less than 4K. If an image of a surgical region is obtained in a high resolution, then the surgeon 5067 can comprehend a state of the surgical region in enhanced details and can proceed with the surgery more smoothly.

Further, the image pickup element which is included by the image pickup unit 5009 includes such that it has a pair of image pickup elements for acquiring image signals for the right eye and the left eye compatible with 3D display. Where 3D display is applied, the surgeon 5067 can comprehend the depth of a living body tissue in the surgical region more accurately. It is to be noted that, if the image pickup unit 5009 is configured as that of the multi-plate type, then a plurality of systems of lens units 5007 are provided corresponding to the individual image pickup elements of the image pickup unit 5009.

The image pickup unit 5009 may not necessarily be provided on the camera head 5005. For example, the image pickup unit 5009 may be provided just behind the objective lens in the inside of the lens barrel 5003.

The driving unit 5011 includes an actuator and moves the zoom lens and the focusing lens of the lens unit 5007 by a predetermined distance along the optical axis under the control of the camera head controlling unit 5015. Consequently, the magnification and the focal point of a picked up image by the image pickup unit 5009 can be adjusted suitably.

The communication unit 5013 includes a communication apparatus for transmitting and receiving various kinds of information to and from the CCU 5039. The communication unit 5013 transmits an image signal acquired from the image pickup unit 5009 as RAW data to the CCU 5039 through the transmission cable 5065. Thereupon, in order to display a picked up image of a surgical region in low latency, preferably the image signal is transmitted by optical communication. This is because, upon surgery, the surgeon 5067 performs surgery while observing the state of an affected area through a picked up image, it is demanded for a moving image of the surgical region to be displayed on the real time basis as far as possible in order to achieve surgery with a higher degree of safety and certainty. Where optical communication is applied, a photoelectric conversion module for converting an electric signal into an optical signal is provided in the communication unit 5013. After the image signal is converted into an optical signal by the photoelectric conversion module, it is transmitted to the CCU 5039 through the transmission cable 5065.

Further, the communication unit 5013 receives a control signal for controlling driving of the camera head 5005 from the CCU 5039. The control signal includes information relating to image pickup conditions such as, for example, information that a frame rate of a picked up image is designated, information that an exposure value upon image picking up is designated and/or information that a magnification and a focal point of a picked up image are designated. The communication unit 5013 provides the received control signal to the camera head controlling unit 5015. It is to be noted that also the control signal from the CCU 5039 may be transmitted by optical communication. In this case, a photoelectric conversion module for converting an optical signal into an electric signal is provided in the communication unit 5013. After the control signal is converted into an electric signal by the photoelectric conversion module, it is provided to the camera head controlling unit 5015.

It is to be noted that the image pickup conditions such as the frame rate, exposure value, magnification or focal point are set automatically by the control unit 5063 of the CCU 5039 on the basis of an acquired image signal. In other words, an auto exposure (AE) function, an auto focus (AF) function and an auto white balance (AWB) function are incorporated in the endoscope 5001.

The camera head controlling unit 5015 controls driving of the camera head 5005 on the basis of a control signal from the CCU 5039 received through the communication unit 5013. For example, the camera head controlling unit 5015 controls driving of the image pickup element of the image pickup unit 5009 on the basis of information that a frame rate of a picked up image is designated and/or information that an exposure value upon image picking up is designated. Further, for example, the camera head controlling unit 5015 controls the driving unit 5011 to suitably move the zoom lens and the focus lens of the lens unit 5007 on the basis of information that a magnification and a focal point of a picked up image are designated. The camera head controlling unit 5015 may further include a function for storing information for identifying the lens barrel 5003 and/or the camera head 5005.

It is to be noted that, by disposing the components such as the lens unit 5007 and the image pickup unit 5009 in a sealed structure having high airtightness and waterproof, the camera head 5005 can be provided with resistance to an autoclave sterilization process.

Now, a functional configuration of the CCU 5039 is described. The communication unit 5059 includes a communication apparatus for transmitting and receiving various kinds of information to and from the camera head 5005. The communication unit 5059 receives an image signal transmitted thereto from the camera head 5005 through the transmission cable 5065. Thereupon, the image signal may be transmitted preferably by optical communication as described above. In this case, for the compatibility with optical communication, the communication unit 5059 includes a photoelectric conversion module for converting an optical signal into an electric signal. The communication unit 5059 provides the image signal after conversion into an electric signal to the image processing unit 5061.

Further, the communication unit 5059 transmits, to the camera head 5005, a control signal for controlling driving of the camera head 5005. The control signal may also be transmitted by optical communication.

The image processing unit 5061 performs various image processes for an image signal in the form of RAW data transmitted thereto from the camera head 5005. The image processes include various known signal processes such as, for example, a development process, an image quality improving process (a bandwidth enhancement process, a super-resolution process, a noise reduction (NR) process and/or an image stabilization process) and/or an enlargement process (electronic zooming process). Further, the image processing unit 5061 performs a detection process for an image signal in order to perform AE, AF and AWB.

The image processing unit 5061 includes a processor such as a CPU or a GPU, and when the processor operates in accordance with a predetermined program, the image processes and the detection process described above can be performed. It is to be noted that, where the image processing unit 5061 includes a plurality of GPUs, the image processing unit 5061 suitably divides information relating to an image signal such that image processes are performed in parallel by the plurality of GPUs.

The control unit 5063 performs various kinds of control relating to image picking up of a surgical region by the endoscope 5001 and display of the picked up image. For example, the control unit 5063 generates a control signal for controlling driving of the camera head 5005. Thereupon, if image pickup conditions are inputted by the user, then the control unit 5063 generates a control signal on the basis of the input by the user. Alternatively, where the endoscope 5001 has an AE function, an AF function and an AWB function incorporated therein, the control unit 5063 suitably calculates an optimum exposure value, focal distance and white balance in response to a result of a detection process by the image processing unit 5061 and generates a control signal.

Further, the control unit 5063 controls the display apparatus 5041 to display an image of a surgical region on the basis of an image signal for which image processes have been performed by the image processing unit 5061. Thereupon, the control unit 5063 recognizes various objects in the surgical region image using various image recognition technologies. For example, the control unit 5063 can recognize a surgical tool such as forceps, a particular living body region, bleeding, mist when the energy device 5021 is used and so forth by detecting the shape, color and so forth of edges of the objects included in the surgical region image. The control unit 5063 causes, when it controls the display unit 5041 to display a surgical region image, various kinds of surgery supporting information to be displayed in an overlapping manner with an image of the surgical region using a result of the recognition. Where surgery supporting information is displayed in an overlapping manner and presented to the surgeon 5067, the surgeon 5067 can proceed with the surgery more safety and certainty.

The transmission cable 5065 which connects the camera head 5005 and the CCU 5039 to each other is an electric signal cable ready for communication of an electric signal, an optical fiber ready for optical communication or a composite cable ready for both of electrical and optical communication.

Here, while, in the example depicted, communication is performed by wired communication using the transmission cable 5065, the communication between the camera head 5005 and the CCU 5039 may be performed otherwise by wireless communication. Where the communication between the camera head 5005 and the CCU 5039 is performed by wireless communication, there is no necessity to lay the transmission cable 5065 in the operating room. Therefore, such a situation that movement of medical staff in the operating room is disturbed by the transmission cable 5065 can be eliminated.

An example of the endoscopic surgery system 5000 to which the technology according to an embodiment of the present disclosure can be applied has been described above. It is to be noted here that, although the endoscopic surgery system 5000 has been described as an example, the system to which the technology according to an embodiment of the present disclosure can be applied is not limited to the example. For example, the technology according to an embodiment of the present disclosure may be applied to a flexible endoscopic system for inspection or a microscopic surgery system.

The technology according to the present disclosure may be preferably applied to the camera head 5005 among the components described above. In particular, the imaging lens according to the present disclosure may be preferably applied to the lens unit 5007 of the camera head 5005.

### 6. Other Embodiments

The technology of the present disclosure is not limited to the description of the above-described embodiments and working examples, but may be modified and implemented in a variety of ways.

For example, the shapes and numerical values of respective portions illustrated in each of the above-described numerical working examples are each merely one embodying example to implement the present technology. Accordingly, the technical scope of the present technology should not be construed in a limiting fashion by those shapes and numerical values.

In addition, the configuration in which substantially six lenses are included has been described in the above-described embodiments and working examples, but a configuration in which a lens having substantially no refractive power is further added is adoptable.

In addition, for example, the present technology may have the following configurations.

According to the present technology having the following configurations, six lenses are included as a whole, and the configuration of each lens is optimized. It is thus possible to provide a high-performance imaging lens or imaging apparatus subjected to miniaturization and aperture enlargement.

[1]

An imaging lens including, in order from an object side toward an image plane side:

a first lens having positive refractive power near an optical axis;

a second lens having positive refractive power near the optical axis;

a third lens having negative refractive power near the optical axis;

a fourth lens whose lens surface on the image plane side has a concave shape toward the image plane side near the optical axis, the fourth lens having negative refractive power;

a fifth lens whose lens surface on the image plane side has a concave shape toward the image plane side near the optical axis, the fifth lens having positive refractive power; and

a sixth lens having negative refractive power near the optical axis.

[2]

The imaging lens according to [1], in which the following conditional expression is satisfied:

0.6<f12/f<1.0 (1)

where f12 represents composite focal length of the first lens and the second lens, and f represents focal length of an overall lens system.

[3]

The imaging lens according to [1] or [2], in which the following conditional expression is satisfied:

0.0<f3/f4<0.7 (2)

where f3 represents focal length of the third lens, and f4 represents focal length of the fourth lens.

[4]

The imaging lens according to any one of [1] to [3], in which the following conditional expression is satisfied:

f1/L1R1sag>10.0 (3)

where f1 represents focal length of the first lens, and L1R1sag represents a maximum value of a sag amount of a lens surface of the first lens on the object side at an effective diameter (inclination of the lens surface toward the image plane side is set as positive, and a unit is “mm”).

[5]

The imaging lens according to any one of [1] to [4], in which the following conditional expression is satisfied:

f2/L2R1sag>7.0 (4)

where f2 represents focal length of the second lens, and L2R1sag represents a maximum value of a sag amount of a lens surface of the second lens on the object side at an effective diameter (inclination of the lens surface toward the image plane side is set as positive, and a unit is “mm”).

[6]

The imaging lens according to any one of [1] to [5], in which the following conditional expression is satisfied:

2.65<(D(L1)+D(L12)+D(L2))/L1R1sag<55.0 (5)

where D(L1) represents central thickness of the first lens, D(L12) represents an air space between the first lens and the second lens, D(L2) represents central thickness of the second lens, and L1R1sag represents a maximum value of a sag amount of a lens surface of the first lens on the object side at an effective diameter (inclination of the lens surface toward the image plane side is set as positive, and a unit is “mm”).

[7]

The imaging lens according to any one of [1] to [6], in which the following conditional expressions are satisfied:

15.0<νd(L4)<35.0 (6A)

15.0<νd(L5)<35.0 (6B)

where νd(L4) represents an Abbe number of the fourth lens for a d line, and νd(L5) represents an Abbe number of the fifth lens for the d line.

[8]

The imaging lens according to any one of [1] to [7], in which the following conditional expression is satisfied:

0.35<D(L5)/(D(L56)+D(L6))<1.05 (7)

where D(L5) represents central thickness of the fifth lens, D(L56) represents an air space between the fifth lens and the sixth lens, and D(L6) represents central thickness of the sixth lens.

[9]

The imaging lens according to any one of [1] to [8], in which the following conditional expression is satisfied:

−11.5<f4/R(L4R2)<0.0 (8)

where f4 represents focal length of the fourth lens, and R(L4R2) represents a paraxial radius of curvature of a lens surface of the fourth lens on the image plane side.

[10]

The imaging lens according to any one of [1] to [9], in which the following conditional expression is satisfied:

0.0<f5/R(L5R2)<145.0 (9)

where f5 represents focal length of the fifth lens, and R(L5R2) represents a paraxial radius of curvature of a lens surface of the fifth lens on the image plane side.

[11]

The imaging lens according to any one of [1] to [10], in which the following conditional expression is satisfied:

2.3<(R(L6R1)+R(L6R2))/(R(L6R1)−R(L6R2))<9.1 (10)

where R(L6R1) represents a paraxial radius of curvature of a lens surface of the sixth lens on the object side, and R(L6R2) represents a paraxial radius of curvature of a lens surface of the sixth lens on the image plane side.

[12]

The imaging lens according to any one of [1] to [11], in which the following conditional expression is satisfied:

0.33<|R(L1R1)/f|<0.78 (11)

where R(L1R1) represents a paraxial radius of curvature of a lens surface of the first lens on the object side, and f represents focal length of an overall lens system.

[13]

The imaging lens according to any one of [1] to [12], in which an aperture stop is disposed between a lens surface of the first lens on the object side and a lens surface of the first lens on the image plane side or between the lens surface of the first lens on the image plane side and a lens surface of the second lens on the image plane side.

[14]

The imaging lens according to any one of [1] to [13], in which a lens surface of the fourth lens on the image plane side has an aspherical shape with an inflection point.

[15]

The imaging lens according to any one of [1] to [14], in which a lens surface of the fifth lens on the image plane side has an aspherical shape with an inflection point.

[16]

The imaging lens according to any one of [1] to [15], in which a lens surface of the sixth lens on the image plane side has an aspherical shape with an inflection point.

[17]

An imaging apparatus including:

an imaging lens; and

an imaging device that outputs an imaging signal corresponding to an optical image formed by the imaging lens,

the imaging lens including, in order from an object side toward an image plane side,
a first lens having positive refractive power near an optical axis,
a second lens having positive refractive power near the optical axis,
a third lens having negative refractive power near the optical axis,
a fourth lens whose lens surface on the image plane side has a concave shape toward the image plane side near the optical axis, the fourth lens having negative refractive power,
a fifth lens whose lens surface on the image plane side has a concave shape toward the image plane side near the optical axis, the fifth lens having positive refractive power, and
a sixth lens having negative refractive power near the optical axis.
   [18]

The imaging lens according to any one of [1] to [16], further including a lens that has substantially no refractive power.

[19]

The imaging apparatus according to [17], in which the imaging lens further includes a lens that has substantially no refractive power.

This application claims the benefit of Japanese Priority Patent Application JP2017-253638 filed with Japan Patent Office on Dec. 28, 2017 and Japanese Priority Patent Application JP2018-175584 filed with Japan Patent Office on Sep. 20, 2018, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An imaging lens comprising, in order from an object side toward an image plane side:
a first lens having positive refractive power near an optical axis;
a second lens having positive refractive power near the optical axis;
a third lens having negative refractive power near the optical axis;
a fourth lens whose lens surface on the image plane side has a concave shape toward the image plane side near the optical axis, the fourth lens having negative refractive power;
a fifth lens whose lens surface on the image plane side has a concave shape toward the image plane side near the optical axis, the fifth lens having positive refractive power; and
a sixth lens having negative refractive power near the optical axis.

2. The imaging lens according to claim 1, wherein the following conditional expression is satisfied:
0.6<f12/f<1.0 (1)
where f12 represents composite focal length of the first lens and the second lens, and f represents focal length of an overall lens system.

3. The imaging lens according to claim 1, wherein the following conditional expression is satisfied:
0.0<f3/f4<0.7 (2)
where f3 represents focal length of the third lens, and f4 represents focal length of the fourth lens.

4. The imaging lens according to claim 1, wherein the following conditional expression is satisfied:
f1/L1R1sag>10.0 (3)
where f1 represents focal length of the first lens, and L1R1sag represents a maximum value of a sag amount of a lens surface of the first lens on the object side at an effective diameter (inclination of the lens surface toward the image plane side is set as positive, and a unit is “mm”).

5. The imaging lens according to claim 1, wherein the following conditional expression is satisfied:
f2/L2R1sag>7.0 (4)
where f2 represents focal length of the second lens, and L2R1sag represents a maximum value of a sag amount of a lens surface of the second lens on the object side at an effective diameter (inclination of the lens surface toward the image plane side is set as positive, and a unit is “mm”).

6. The imaging lens according to claim 1, wherein the following conditional expression is satisfied:
2.65<(D(L1)+D(L12)+D(L2))/L1R1sag<55.0 (5)
where D(L1) represents central thickness of the first lens, D(L12) represents an air space between the first lens and the second lens, D(L2) represents central thickness of the second lens, and L1R1sag represents a maximum value of a sag amount of a lens surface of the first lens on the object side at an effective diameter (inclination of the lens surface toward the image plane side is set as positive, and a unit is “mm”).

7. The imaging lens according to claim 1, wherein the following conditional expressions are satisfied:
15.0<νd(L4)<35.0 (6A)
15.0<νd(L5)<35.0 (6B)
where νd(L4) represents an Abbe number of the fourth lens for a d line, and νd(L5) represents an Abbe number of the fifth lens for the d line.

8. The imaging lens according to claim 1, wherein the following conditional expression is satisfied:
0.35<D(L5)/(D(L56)+D(L6))<1.05 (7)
where D(L5) represents central thickness of the fifth lens, D(L56) represents an air space between the fifth lens and the sixth lens, and D(L6) represents central thickness of the sixth lens.

9. The imaging lens according to claim 1, wherein the following conditional expression is satisfied:
−11.5<f4/R(L4R2)<0.0 (8)
where f4 represents focal length of the fourth lens, and R(L4R2) represents a paraxial radius of curvature of a lens surface of the fourth lens on the image plane side.

10. The imaging lens according to claim 1, wherein the following conditional expression is satisfied:
0.0<f5/R(L5R2)<145.0 (9)
where f5 represents focal length of the fifth lens, and R(L5R2) represents a paraxial radius of curvature of a lens surface of the fifth lens on the image plane side.

11. The imaging lens according to claim 1, wherein the following conditional expression is satisfied:
2.3<(R(L6R1)+R(L6R2))/(R(L6R1)−R(L6R2))<9.1 (10)
where R(L6R1) represents a paraxial radius of curvature of a lens surface of the sixth lens on the object side, and R(L6R2) represents a paraxial radius of curvature of a lens surface of the sixth lens on the image plane side.

12. The imaging lens according to claim 1, wherein the following conditional expression is satisfied:
0.33<|R(L1R1)/f|<0.78 (11)
where R(L1R1) represents a paraxial radius of curvature of a lens surface of the first lens on the object side, and f represents focal length of an overall lens system.

13. The imaging lens according to claim 1, wherein an aperture stop is disposed between a lens surface of the first lens on the object side and a lens surface of the first lens on the image plane side or between the lens surface of the first lens on the image plane side and a lens surface of the second lens on the image plane side.

14. The imaging lens according to claim 1, wherein a lens surface of the fourth lens on the image plane side has an aspherical shape with an inflection point.

15. The imaging lens according to claim 1, wherein a lens surface of the fifth lens on the image plane side has an aspherical shape with an inflection point.

16. The imaging lens according to claim 1, wherein a lens surface of the sixth lens on the image plane side has an aspherical shape with an inflection point.

17. An imaging apparatus comprising:
an imaging lens; and
an imaging device that outputs an imaging signal corresponding to an optical image formed by the imaging lens,
the imaging lens including, in order from an object side toward an image plane side,
a first lens having positive refractive power near an optical axis,
a second lens having positive refractive power near the optical axis,
a third lens having negative refractive power near the optical axis,
a fourth lens whose lens surface on the image plane side has a concave shape toward the image plane side near the optical axis, the fourth lens having negative refractive power,
a fifth lens whose lens surface on the image plane side has a concave shape toward the image plane side near the optical axis, the fifth lens having positive refractive power, and
a sixth lens having negative refractive power near the optical axis.
